(19) United States
(12) Patent Application Publication
(10) Pub. No.: US 2021/0102642 A1
(43) Pub. Date: Apr. 8, 2021

(54) LIFTING AND SECURING DEVICES

(71) Applicant: MILWAUKEE ELECTRIC TOOL CORPORATION, Brookfield, WI (US)

(72) Inventors: Isabel M. Lloyd, West Allis, WI (US); Caroline Fox, Milwaukee, WI (US); Logan M. Hietpas, Glendale, WI (US); John S. Scott, Brookfield, WI (US); Joseph R. McIntyre, Milwaukee, WI (US); Matthew N. Thurin, Wauwatosa, WI (US); Jonathan L. Lambert, Milwaukee, WI (US); Julia L. Savich, Shorewood, WI (US); James Wekwert, Wauwatosa, WI (US)

(21) Appl. No.: 17/020,271

(22) Filed: Sep. 14, 2020

Related U.S. Application Data
(60) Provisional application No. 62/937,591, filed on Nov. 19, 2019.
(60) Provisional application No. 62/899,721, filed on Sep. 12, 2019.
(60) Provisional application No. 62/899,720, filed on Sep. 12, 2019.

(51) Int. Cl. F16L 1/06; F16L 1/024

(52) U.S. Cl. CPC F16L 1/06; F16L 1/0246

(57) ABSTRACT

A lifting and securing device configured to support material and aid in moving the material to a desired height and location.

### CROSS-REFERENCE TO RELATED APPLICATIONS

This application claims priority to co-pending U.S. Provisional Patent Application Nos. 62/899,720 and 62/899,721, filed on Sep. 12, 2019, and, U.S. Provisional Patent Application No. 62/937,591, filed on Nov. 19, 2019, the entire contents of which are incorporated herein by reference.

### BACKGROUND

The present disclosure relates to lifting and securing devices, and more particularly to lifting and securing devices that may be used to support material (e.g., pipes, weights, etc.) and aid in moving the material to a desired height and location. While many of the lifting and securing devices described below are used for pipes (e.g., plastic, metal, aluminum, etc.), it should be appreciated that the devices may be used to lift or secure any material.

### BRIEF DESCRIPTION OF THE DRAWINGS

FIGS. 1A-1D illustrate a control cable meant to provide material control by introducing a downward tension force on the material being lifted.

FIGS. 2A-2M illustrate several embodiments of a double-sided tape measure device used to measure the length of a load.

FIGS. 3A-3G illustrate a hopper device configured to attach to a lifting device for providing a method for feeding a lift material up to an installer at an elevated height.

FIGS. 4A-4F illustrate several different examples of materials that can be used in certain embodiments of lifting cables and chains.

FIGS. 5A-5C illustrate a magnetic switch that can be selectively used as a lifter, allowing the user to engage a load without needing to lift the load off the ground.

FIGS. 6A-6D illustrate a manual guiding dog catcher pole.

FIGS. 7A-7D illustrate a manual guiding snake catcher pole.

FIGS. 8A-8D illustrate a manual guiding magnet pole.

FIGS. 9A-9H illustrate a remote hoist lift.

FIGS. 10A-10C illustrate a removeable tension control device.

FIGS. 11A-11J illustrate several embodiments of a retractable ground tension device used to counter-tension from the ground in order to control a material/load being lifted.

FIGS. 12A-12H illustrate several embodiments of rope framework configured to serve as a guide to prevent rotation of a load/material being lifted.

FIGS. 13A-13C illustrate a safety lighting zone device to be used in conjunction with a lift device.

FIGS. 14A-14H illustrate a winch control system.

FIGS. 15A-15M illustrate several embodiments of centering blocks.

FIGS. 16A-16C illustrate a locking c-clamp to be used to secure a load/material ready to be lifted.

FIGS. 17A-17B illustrate a powered spring clamp to be used to secure a load/material ready to be lifted.

FIGS. 18A-18C illustrate a cam lock to be placed over a load in order to tighten around the diameter of the load.

FIGS. 19A-19C illustrate a magnetic strap for adjusting a strap length around a material/load.

FIGS. 20A-20E illustrate an over-center clamp device configured to clamp around the sides of a load.

FIGS. 21A-21D illustrate several embodiments of sling improvements.

FIGS. 22A-22F illustrate a 3-piece handle system secured by magnets or clasps that is configured to be rotatable around a load/material.

FIGS. 23A-23E illustrate a slotted expansion device.

FIGS. 24A-24E illustrate a spring-expandable lifting mechanism.

FIGS. 25A-25E illustrate a thru cable system.

FIGS. 26A-26D illustrate a quick lock device for securing a load.

FIGS. 27A-27D illustrate a scissor slab clamp configured to secure a load.

FIGS. 28A-28K illustrate several embodiments of a lift assist device for keeping a load in a vertical orientation while it is being lifted.

FIGS. 29A-29E illustrate an articulating arm allowing a user to maneuver a material by pushing/pulling the material to a desired location while a majority of the material's weight is being supported by the arm.

FIGS. 30A-30G illustrate several embodiments of hinging forks configured to articulate up and down, allowing the horizontal plane footprint of the forks to be reduced significantly when tilted harshly.

FIGS. 31A-31E illustrate a micro-adjustment platform configured to help with positioning/placement of parts related to the installation process on a platform or fork based lifter.

FIGS. 32A-32C illustrate a two turntable configured to allow users to rotate a material/load while the load is still fully supported.

FIGS. 33A-33D illustrate a remote-control turntable for use with a platform or fork based lifter.

FIGS. 34A-34H illustrate several embodiments of a platform roller configured to facilitate the transport of lift materials.

FIGS. 35A-35E illustrate a conveyor roller.

FIGS. 36A-36D illustrate a roller ball.

FIGS. 37A-37E illustrate a tilt and turn device for use with a platform or fork based lifter.

FIGS. 38A-38E illustrate a two-ball-joint platform for use with a platform or fork based lifter.

FIGS. 39A-39K illustrate several embodiments of a dual boom pivot system.

FIGS. 40A-40F illustrate several embodiments of pivoting forks for use with a lift system, allowing a user to pivot a plurality of forks to articulate a material/load without having to physically bear the load themselves.

FIGS. 41A-41G illustrate a 2-joint single hoist jib.

FIGS. 42A-42K illustrate several embodiments of a 3-point dual hoist rotating jib system.

FIGS. 43A-43D illustrate a 3-joint single hoist rotating jib.

FIGS. 44A-44H illustrate a collapsible overhead track conveyor device.

FIGS. 45A-45G illustrate a dual-axis slide extension device.

FIGS. 46A-46F illustrate a fixed length boom extension device.

FIGS. 47A-47J illustrate several embodiments of an overhead track conveyor system.

FIGS. 48A-48F illustrate a single-axis slide extension system.

FIGS. 49A-49F illustrate a telescopic boom extension apparatus.

FIGS. 50A-50F illustrate a duct-a-bout device.

FIGS. 51A-51G illustrate a threaded rod lifter system.

FIGS. 52A-52D illustrate an end-to-end alignment device.

FIGS. 53A-53E illustrate a rail jack device.

FIGS. 54A-54C illustrate a lift device.

FIGS. 55A-55D illustrate an inflatable shoulder shim device configured to be worn by a user.

FIGS. 56A-56C illustrate an assist lever device.

FIGS. 57A-57C illustrate a vertical guiding device configured to attach to an already installed lift material.

FIGS. 58A-58E illustrate a powered lift hoist system.

FIGS. 59A-59D illustrate a zero-gravity device.

FIGS. 60A-60E illustrate a 2-strap centering system.

FIGS. 61A-61D illustrate a wishbone strap device.

FIGS. 62A-62D illustrate a portable single, synchronized jack system.

FIGS. 63A-63B illustrate a rotating trolley for use with a remote hoist system.

FIGS. 64A-64B illustrate an extendable boom system to be used with a powered roustabout.

FIGS. 65A-65C illustrate a tilt/turn system utilizing a powered duct jack.

FIGS. 66A-66B illustrate a tensioning system utilizing a winch control system.

FIGS. 67A-67B illustrate a coordinated winch system utilizing a winch control system.

FIGS. 68A-68F illustrate a set of slings.

FIGS. 69A-69E illustrate a belt syncher.

FIGS. 70A-70F illustrate a belt choker.

FIGS. 71A-71E illustrate a cam lock choker device.

FIGS. 72A-72D illustrate a multi-loop sling.

FIGS. 73A-73E illustrate a mobile application utilizing a mobile device to determine optimal lifting location(s) on a material/load being lifted.

FIGS. 74A-74E illustrate a trigger clamp and leveler device.

FIGS. 75A-75D illustrate a gravity clamp device.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

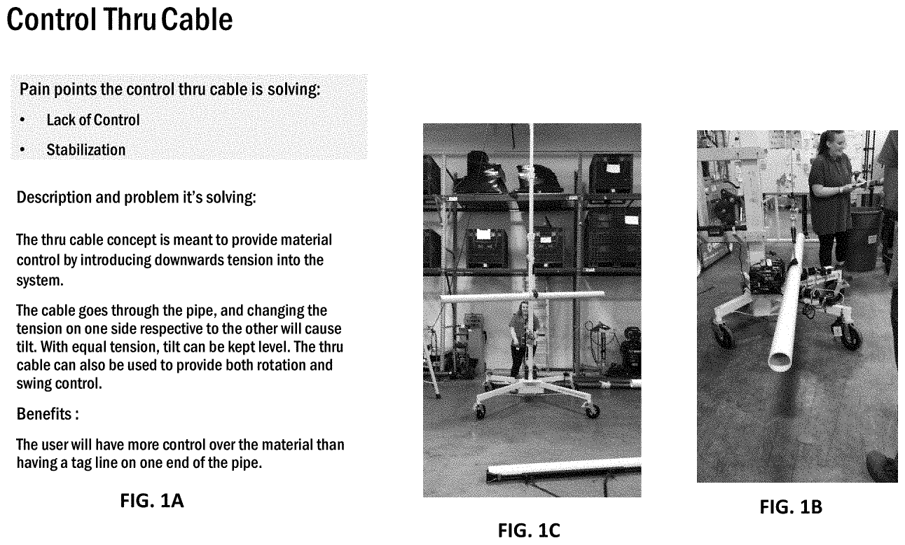

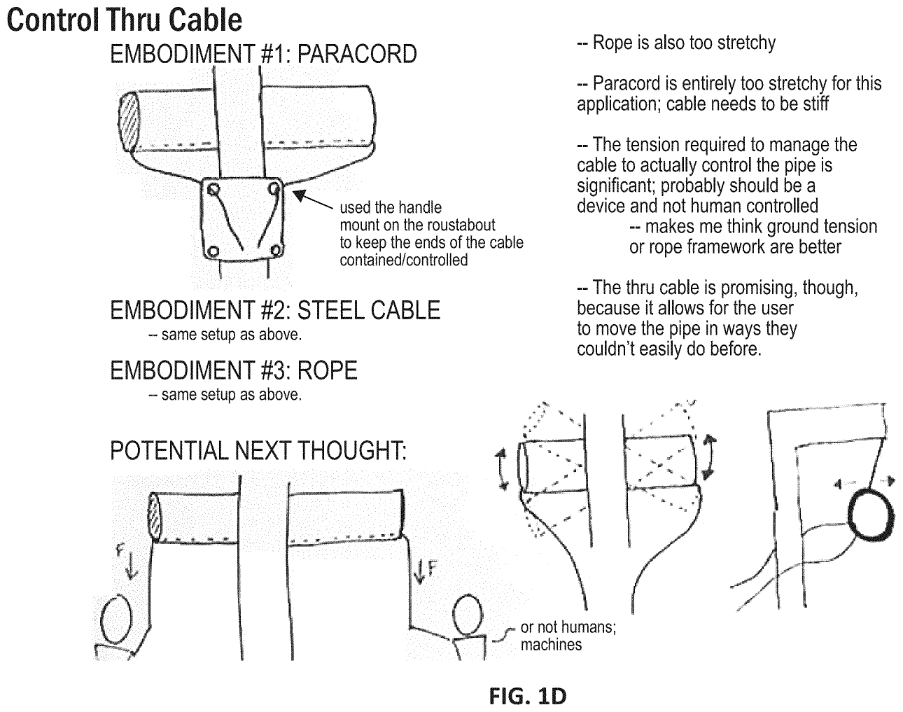

FIGS. 1A-1D illustrate a control cable meant to provide material control by introducing a downward tension force on the material being lifted. The control cable is threaded through the material being lifted and applies a downward tension force on the material to provide both rotation, tilt, and swing control.

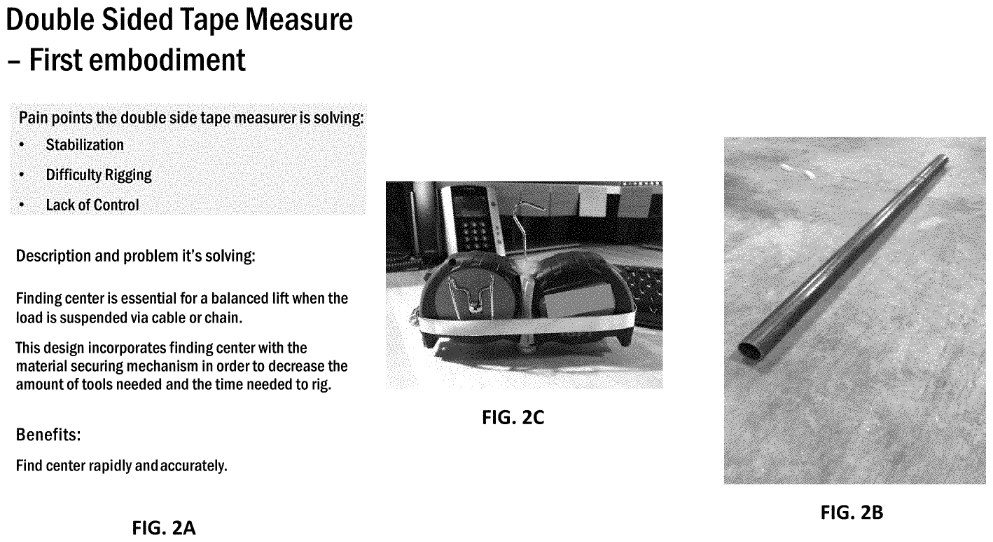

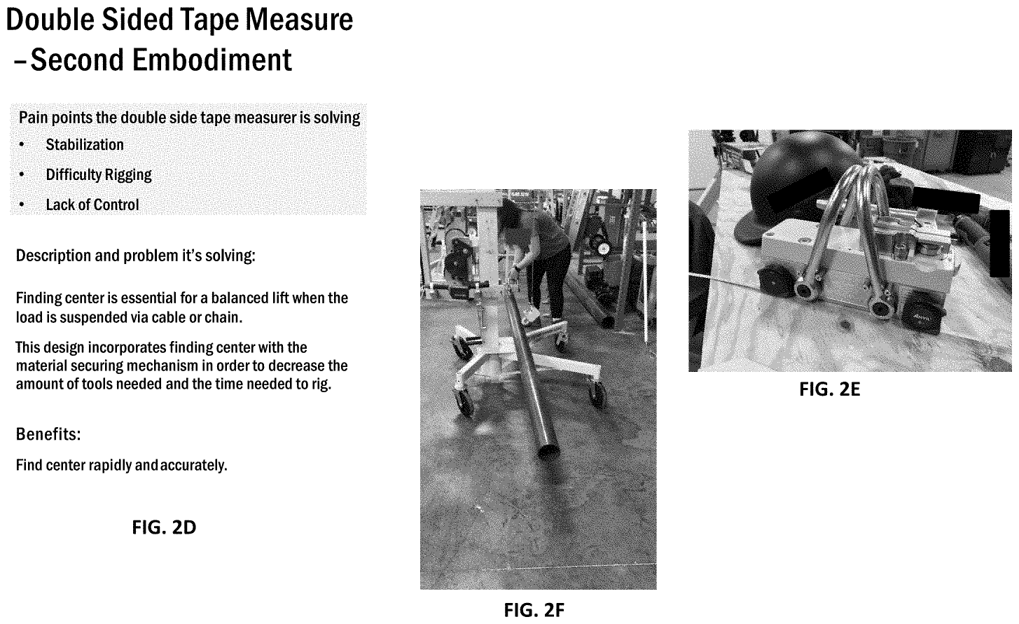

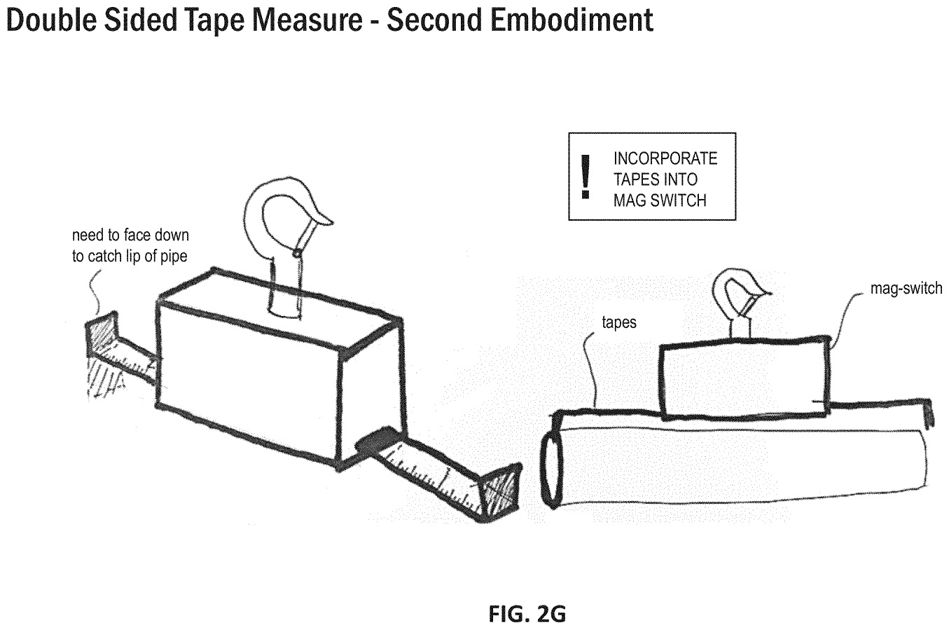

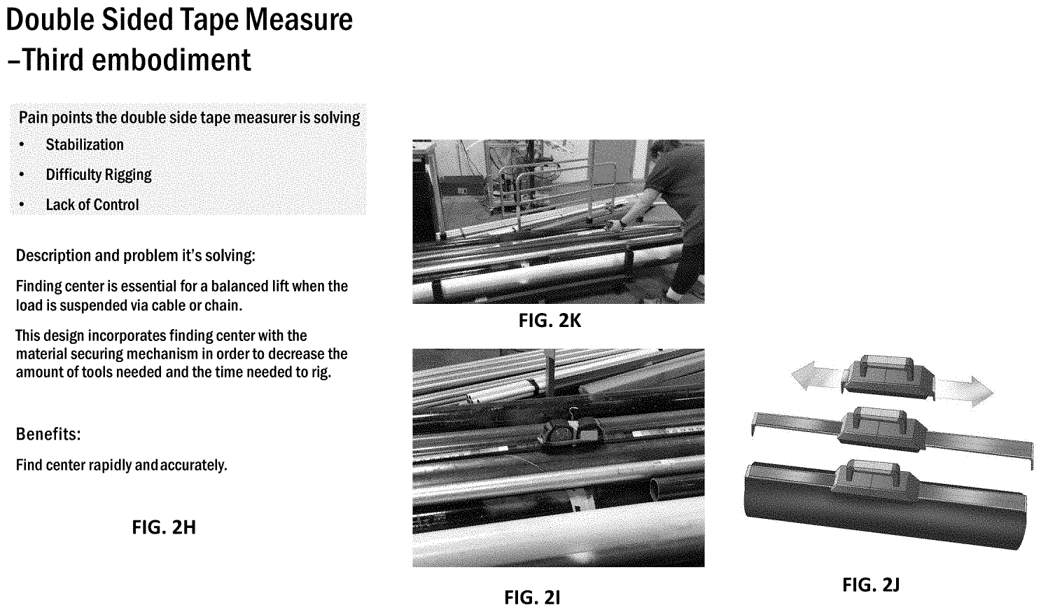

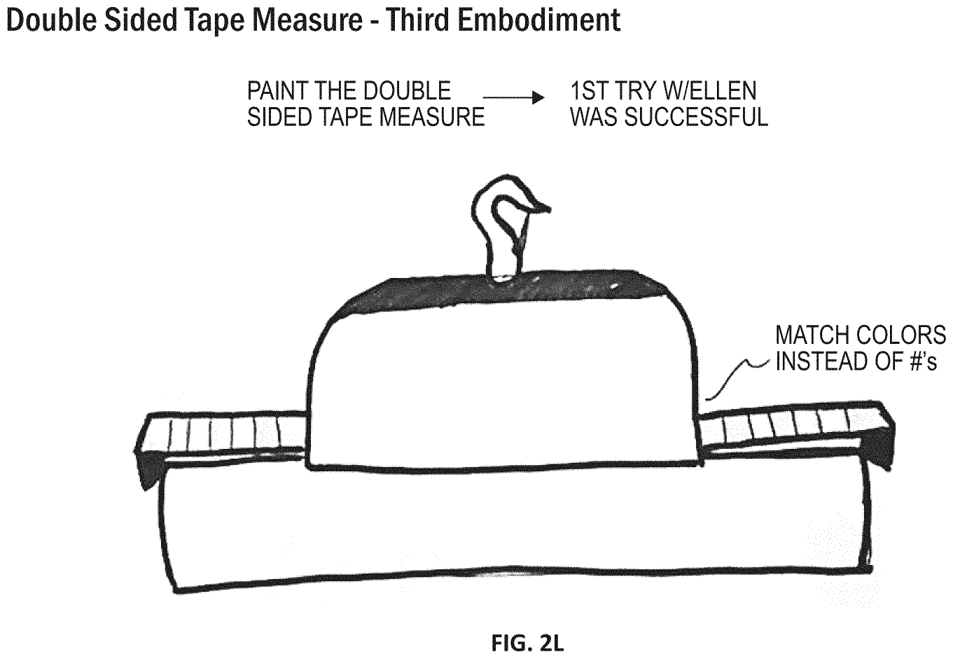

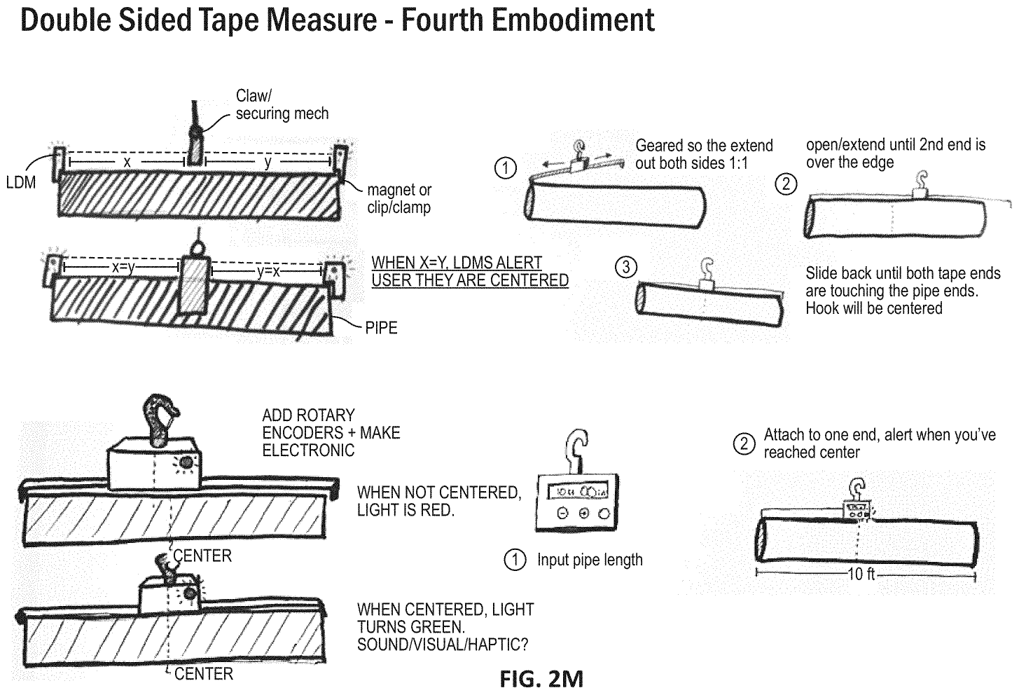

FIGS. 2A-2M illustrate several embodiments of a double-sided tape measure device used to measure the length of a load. The double sided tape measure may include an under hood light and a two strap centering system. Finding the center of a material being lifted is essential for a balanced lift when the load is suspended via cable or chain. In one embodiment, each side of the double sided tape measure includes colors that correspond to different lengths. As a result, the user may match the colors of each tape measure to ensure a centered position. In some embodiments, the ends of each tape measure may include a magnet or clip to secure the ends of the tape measure to the material. The tape measure may further include an encoder that alerts the user (e.g., via visual, sound, haptic, etc.) that the tape measure is in a center position. In another embodiment, the tape measure may be spring-expandable and allow the user to place one hook into the end of a pipe and stretch over the pipe to place a second hook on the other end. The tape measure may include a sleeve that sides along rigging to find and easily adjust the center. In some embodiments, the device may include an auto-center with a 1:1 expansion rate.

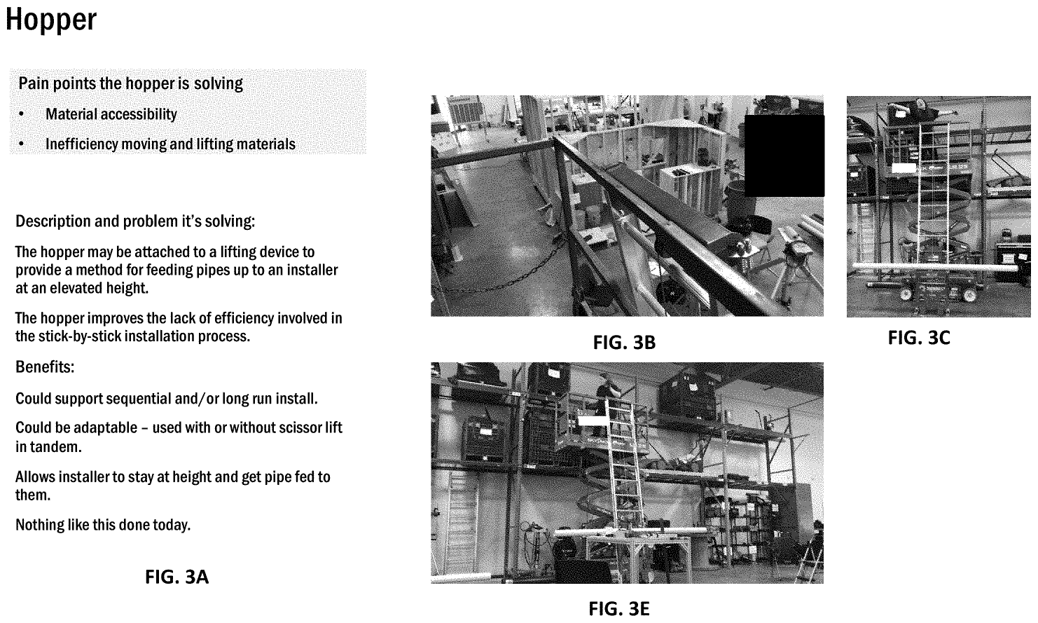

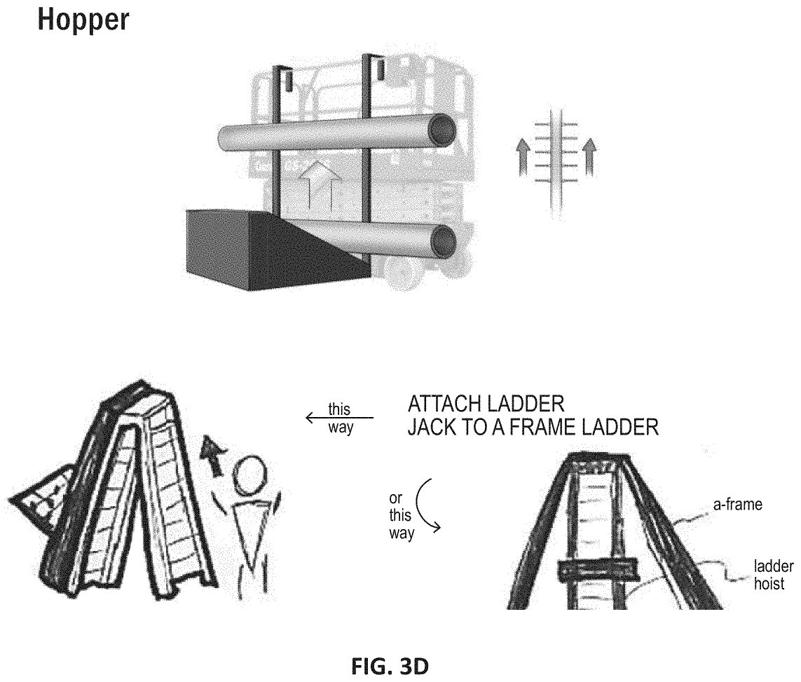

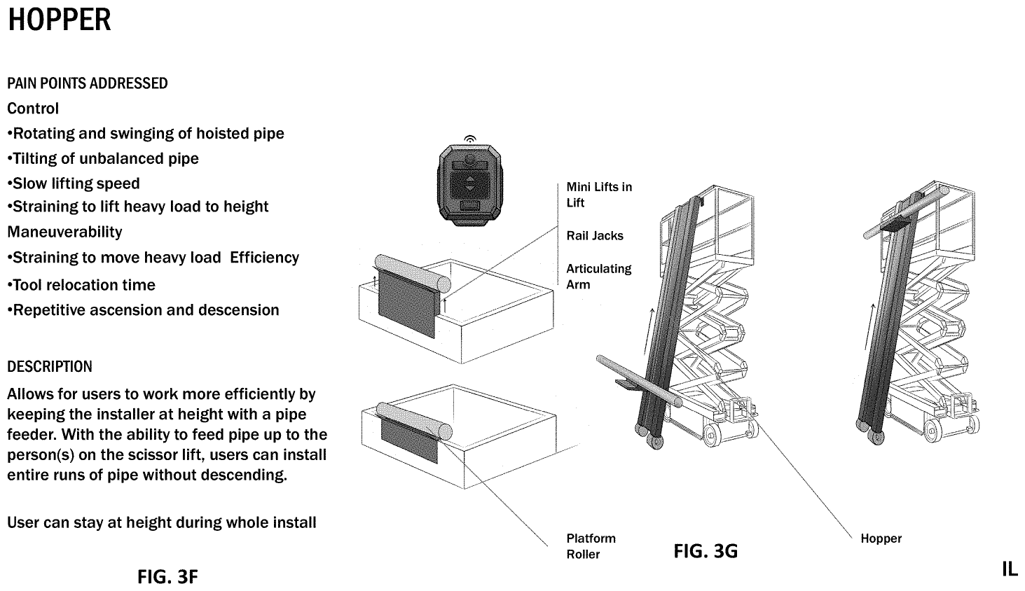

FIGS. 3A-3G illustrate a hopper device configured to attach to a lifting device for providing a method for feeding a lift material up to an installer at an elevated height. The hopper is advantageous because it improves the lack of efficiency involved in the “stick-by-stick” installation process. Additionally, the hopper can be adaptable to be used with or without a scissor lift in tandem. The hopper may be positioned relative to a work space to elevate pipe from a lower surface (e.g., the ground) to an elevated surface (e.g., a cab of a scissor lift) or vice versa. The hopper includes a carrier that may be controlled by the user (e.g., wirelessly, wired control, etc.). The carrier may repetitively ascend and descend to allow the user to remain at an elevated workspace. In one embodiment, the hopper may include a carrier portion that is movably along an elongated body of the hopper. The carrier moves along the elongated body of the hopper to supply pipes to the user's elevated workspace. The user's workspace may be a scissor lift cab. In some embodiments, any combination of scissor jacks, mini lifts, articulating arms, or platform rollers may be positioned within or formed on the user's workspace to assist the user during movement of the pipe. For example, scissor jacks may be mounted on front or back rails of a scissor lift, a mini lift may be positioned within the lift cab, an articulating arm may be mounted on the scissor lift rail or to framing, and/or platform rollers may be formed on the rails of the scissor lift or positioned within the user's workspace. As a result, the user may maneuver the pipe (e.g., by pushing/pulling the pipe), while the bulk of its weight is being supported by one or more of the scissor jacks, the mini lift, the articulating arms, or the platform rollers.

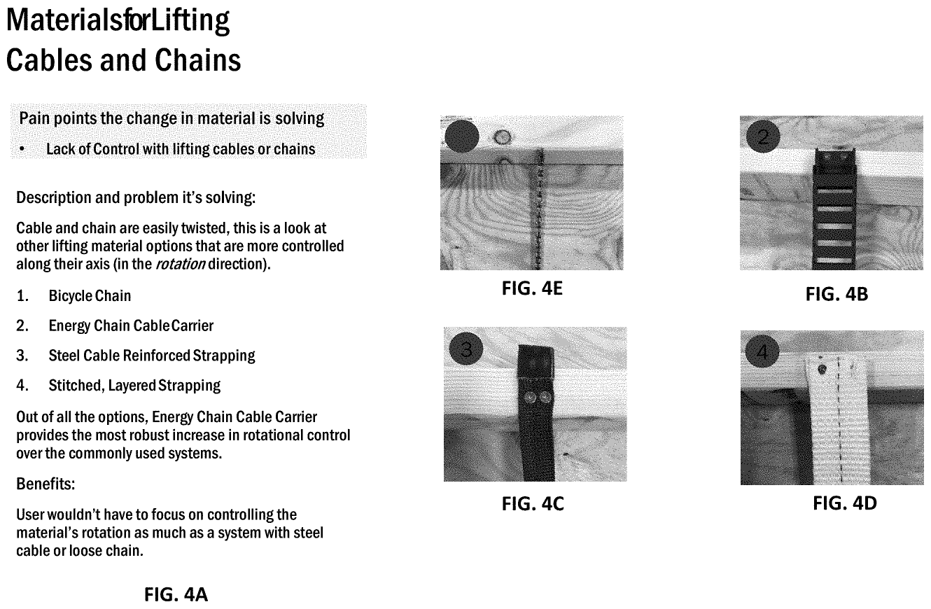

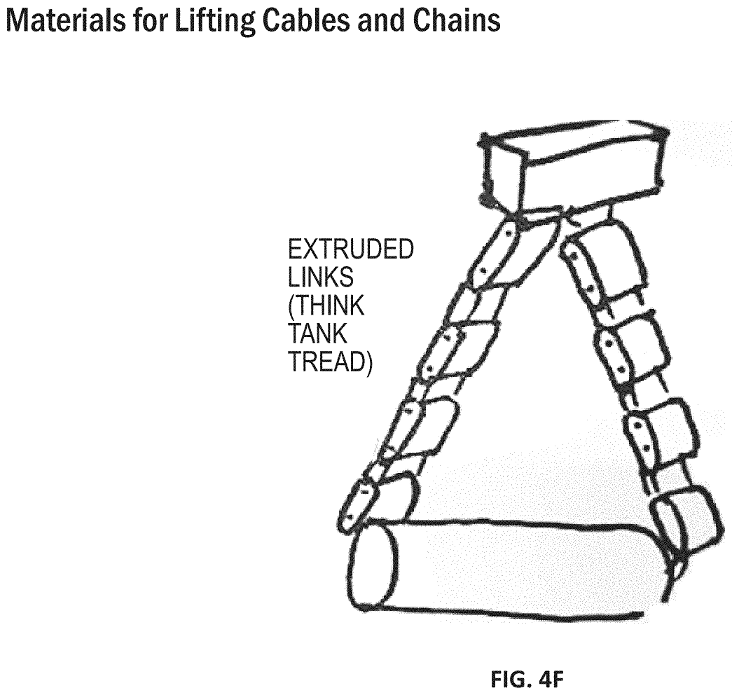

FIGS. 4A-4F illustrate several different examples of materials that can be used in certain embodiments of lifting cables and chains. These materials include a Bicycle chain (1), Energy chain cable carrier (2), Steel cable reinforced strapping (3), and stitched, layered strapping (4).

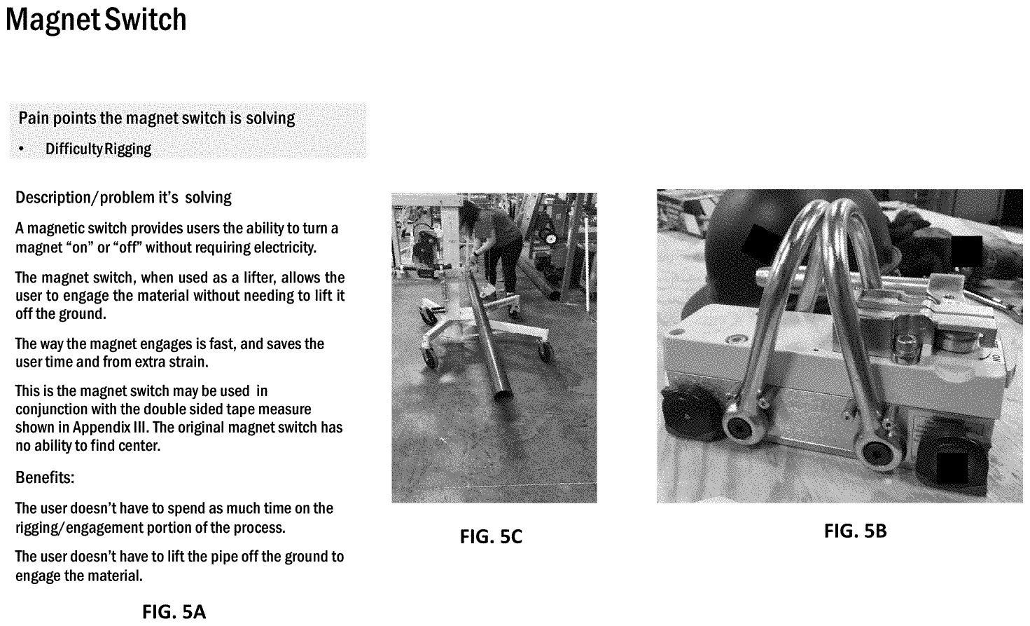

FIGS. 5A-5C illustrate a magnetic switch that can be selectively used as a lifter, allowing the user to engage a load without needing to lift the load off the ground.

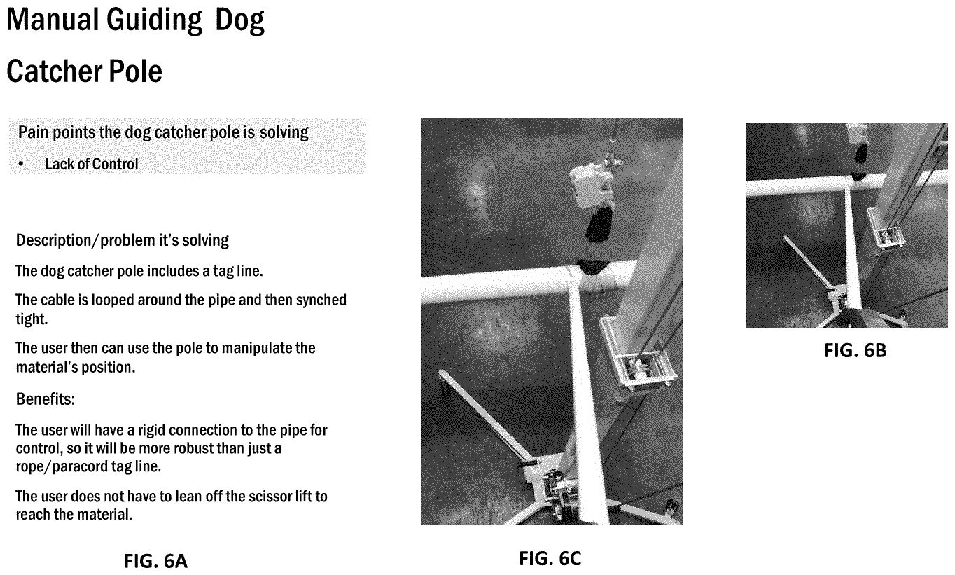

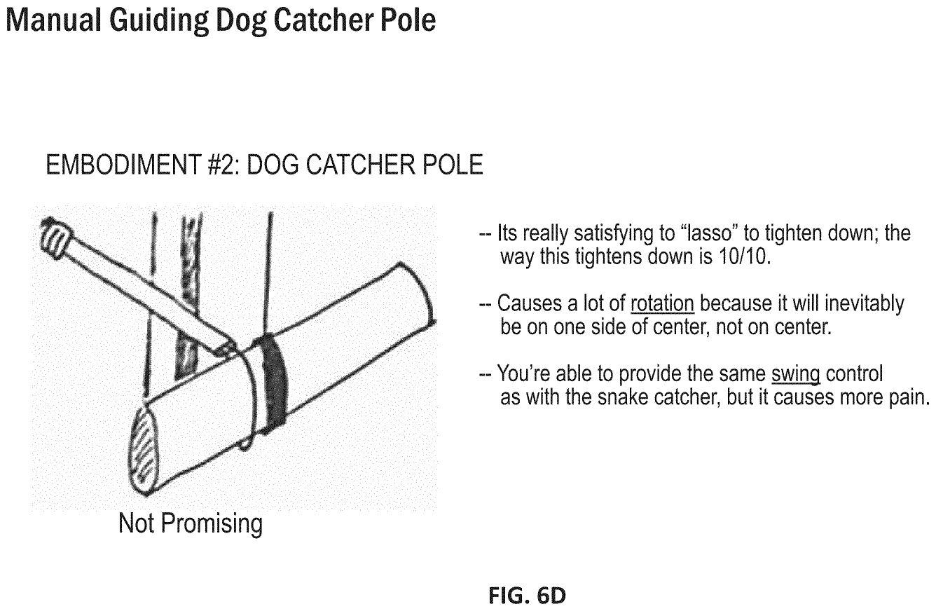

FIGS. 6A-6D illustrate a manual guiding dog catcher pole including a tagline that can be looped around a load and the synched down tight around the load. This provides a user with the control to manipulate the load's position.

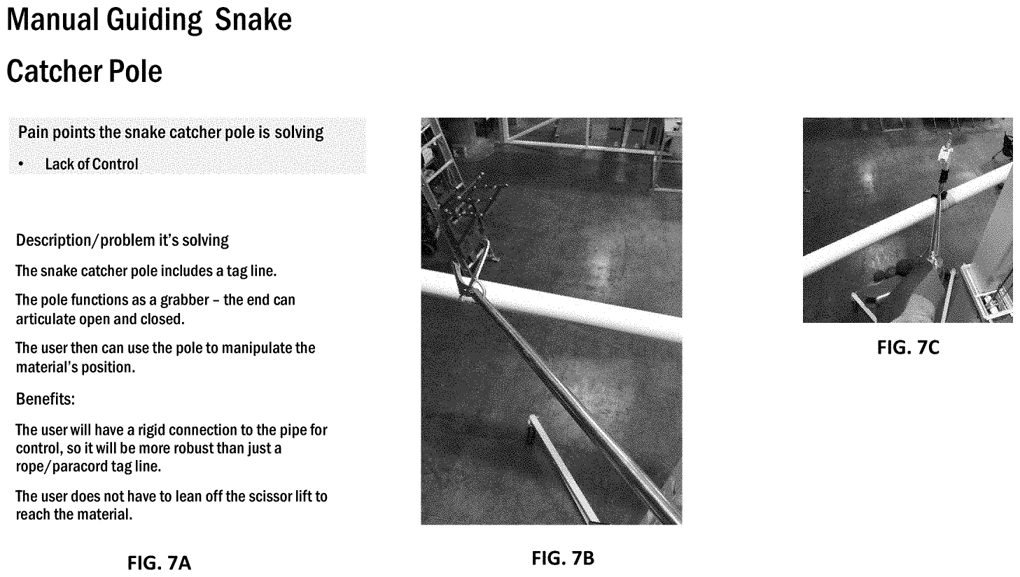

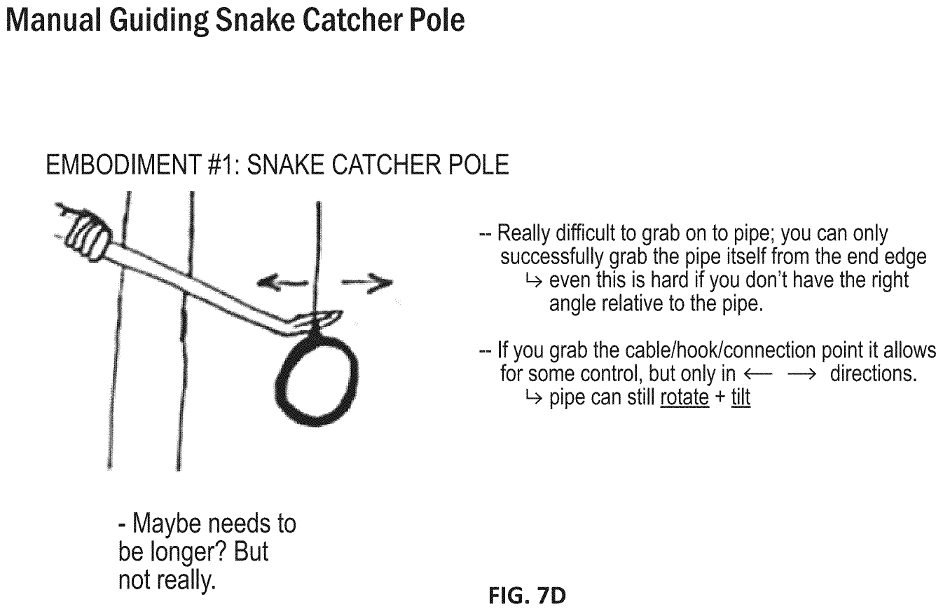

FIGS. 7A-7D illustrate a manual guiding snake catcher pole including a tagline and an end portion that can articulate open and closed to function as a grabber. The snake catcher pole can be used to manipulate a load's position via a rigid connection.

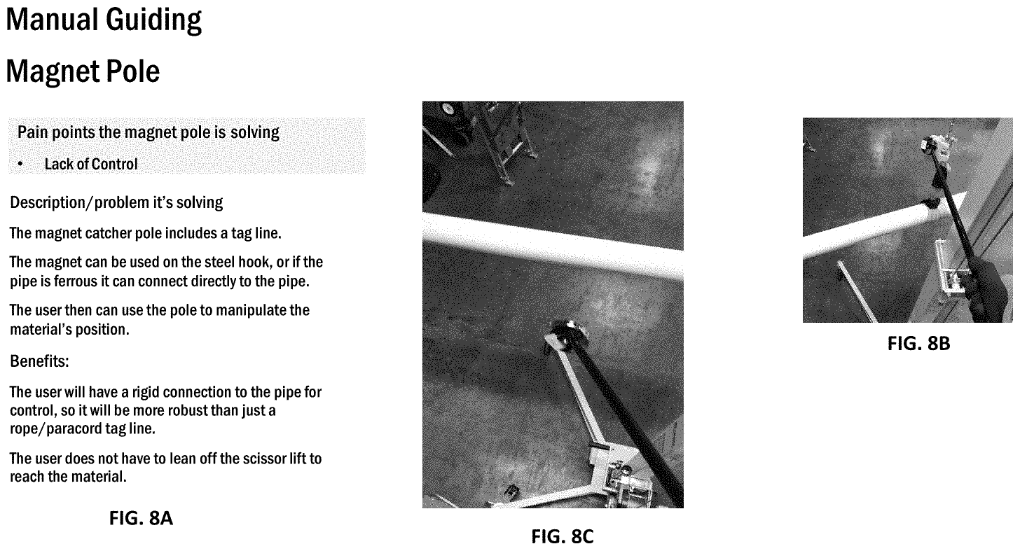

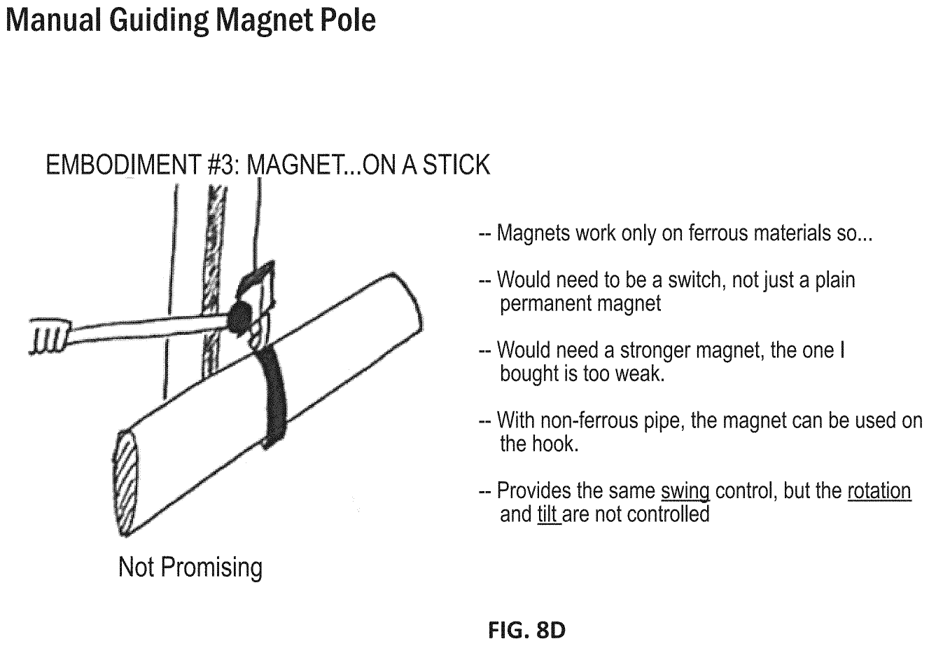

FIGS. 8A-8D illustrate a manual guiding magnet pole including a tagline and an end having a steel hook with a magnet. The magnet can be configured to magnetically attract ferrous materials (e.g., a pipe), allowing the user to manipulate the material's position using the magnet.

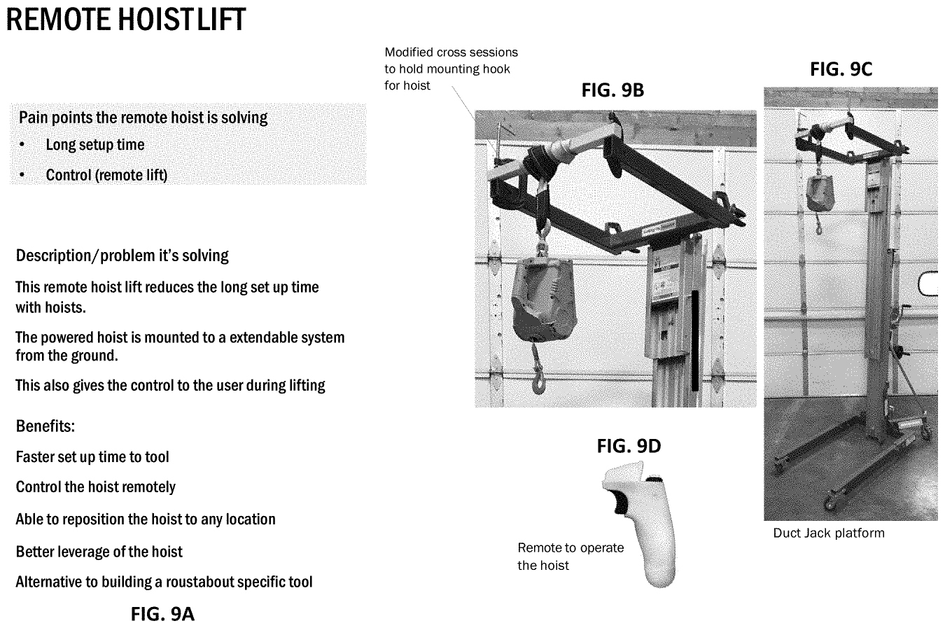

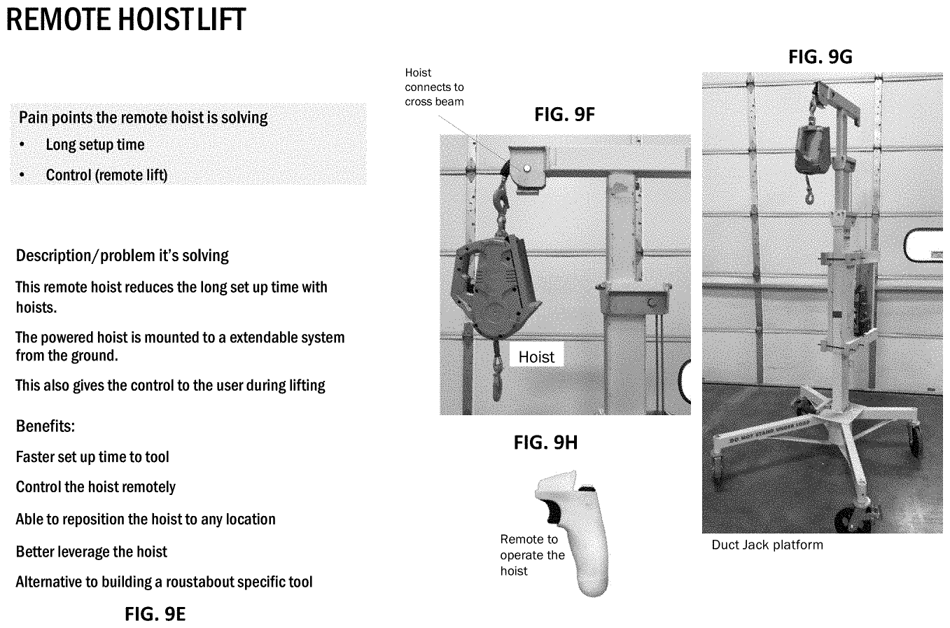

FIGS. 9A-9H illustrate a remote hoist lift including an extendable ground hoist having a powered hoist mounted on the ground hoist that can selectively perform lifts in response to actuation from a remote. The remote hoist may include a cable and a securing device (e.g., a hook, a securing device as described in Paragraph 28 below, etc.) that is adjustable to secure a desired material such as a pipe to the securing device. The remote hoist allows the user to control the position and height the pipe is elevated to from a remote location. The remote hoist may be used with a rotating trolley that includes a boom having a trolley, an overhead conveyor, and a 3-joint dual hoist rotating jib. The rotating trolley is capable of rotating 360 degrees around a mast axis and the trolley may move along the boom. As a result, the pipe may be elevated and translated to a desired position. In another embodiment, the remote hoist may be used with a duct jack platform having a base with wheels so the platform is movable within a desired area. The platform includes a vertical support post and a mounting portion that extends transversely from the support post. The mounting portion includes a mounting post that extends from a distal end of the mounting portion to support the remote hoist. In yet another embodiment, the remote hoist may be used with a platform that includes a vertical support post and a cross beam that extends transversely from the vertical support post. The remote hoist is connected to a distal end of the cross beam. In yet another embodiment, the remote hoist may be used with a platform that includes a vertical support post and an overhead track conveyor that extends transversely to the support beam. The remote hoist may be attached to a trolley that is operably coupled to the track conveyor. As a result, the hoist may smoothly roll along the track conveyor so the pipe supported by the remote hoist may translate in an outward direction from the support beam along the track conveyor. In yet another embodiment, the remote hoist may be used with a three-joint rotating jib with a tee. The rotating jib includes a vertical support post and three swivel joints that allow for rotation about the vertical support post, and a mounting portion. Two independent remote hoists are attached to the mounting portion to control a lifting operation of the pipe. The independent remote hoists allow for tilting maneuvers of the pipe during the lifting operation.

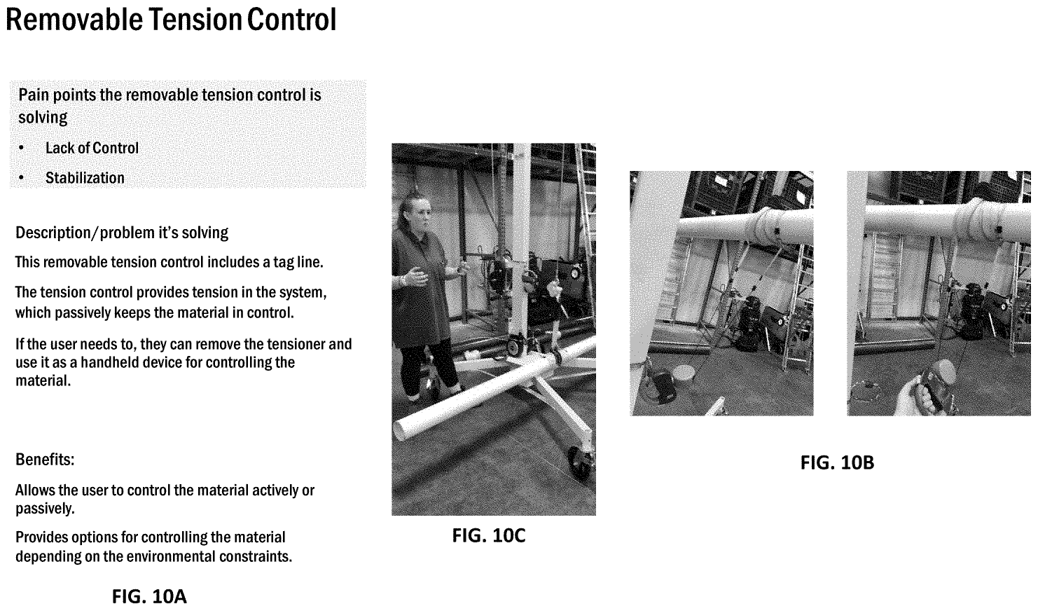

FIGS. 10A-10C illustrate a removeable tension control device including a tagline to help provide tension on a load being lifted. The tension control device is configured to always apply tension to the system to passively keep the load in control. When a user wishes to actively control the load, the user can remove the tensioner and use it as a handheld device for manually controlling the material.

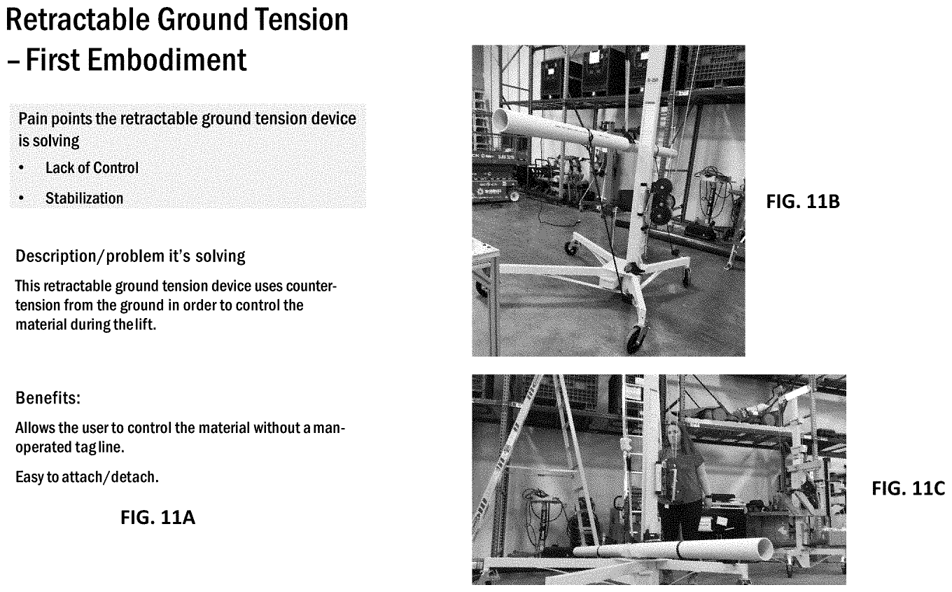

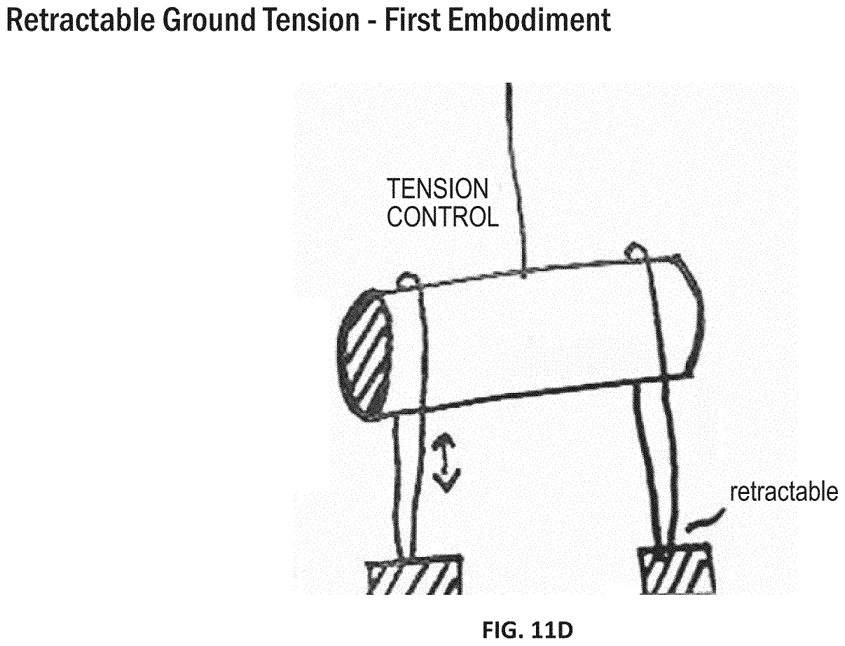

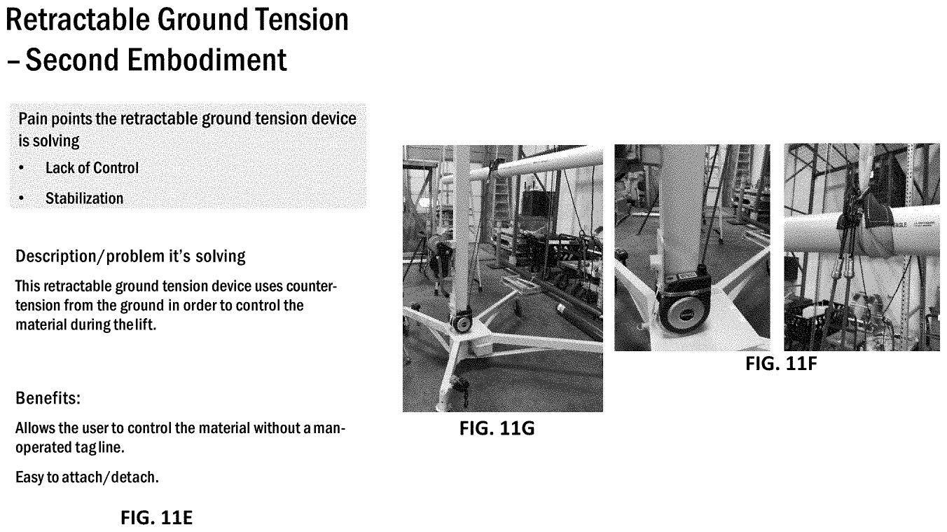

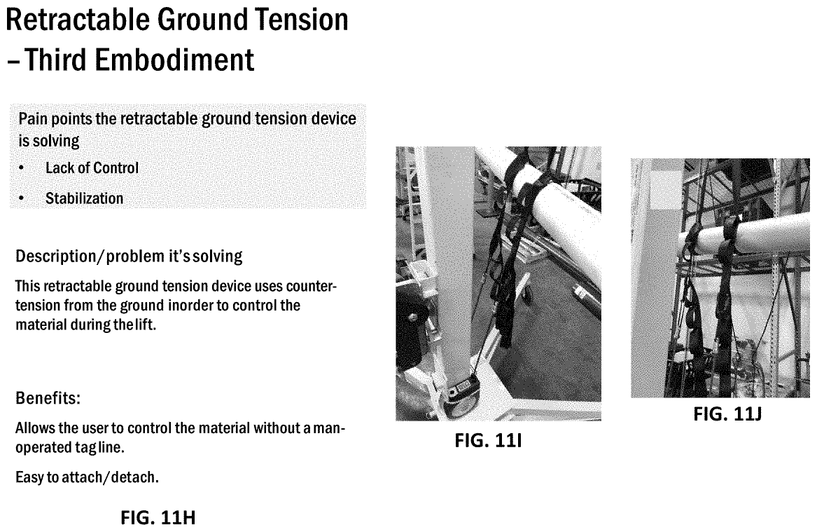

FIGS. 11A-11J illustrate several embodiments of a retractable ground tension device used to counter-tension from the ground in order to control a material/load being lifted. The ground tension device allows the user to control the material without a man-operated tagline.

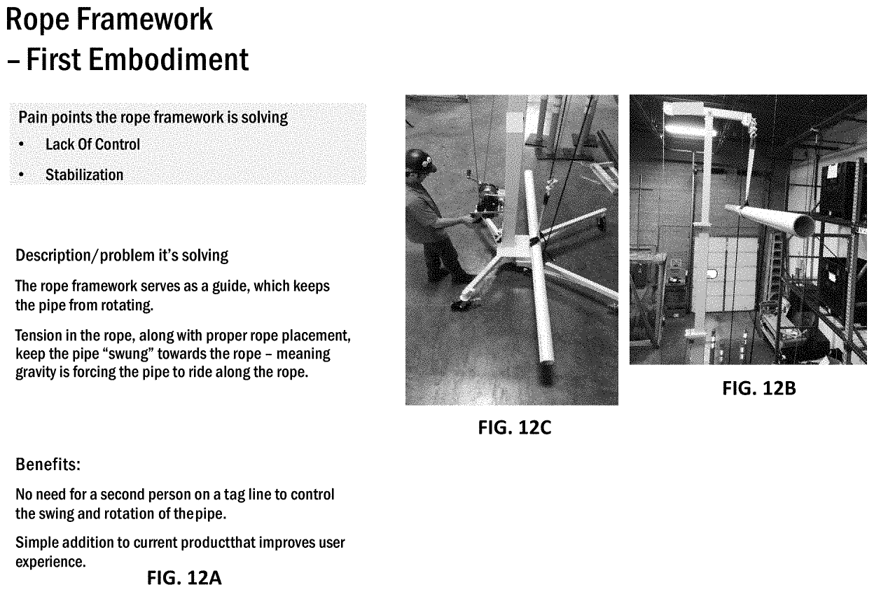

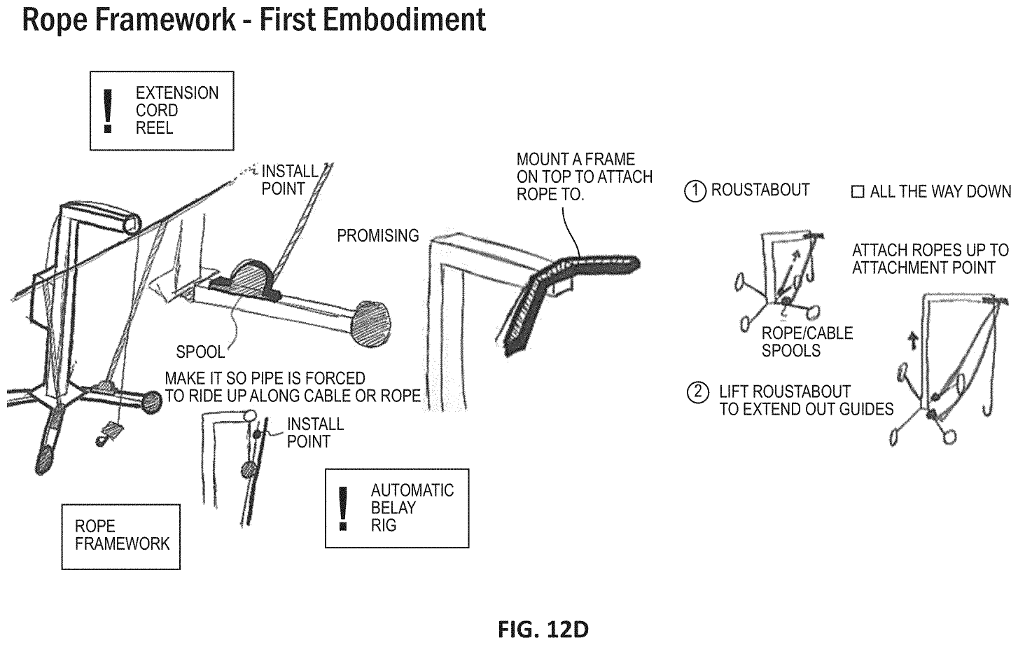

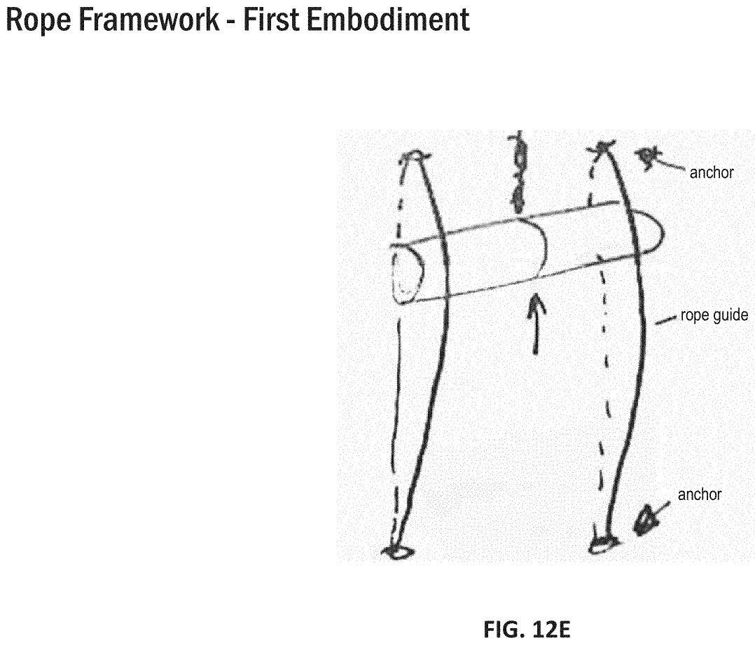

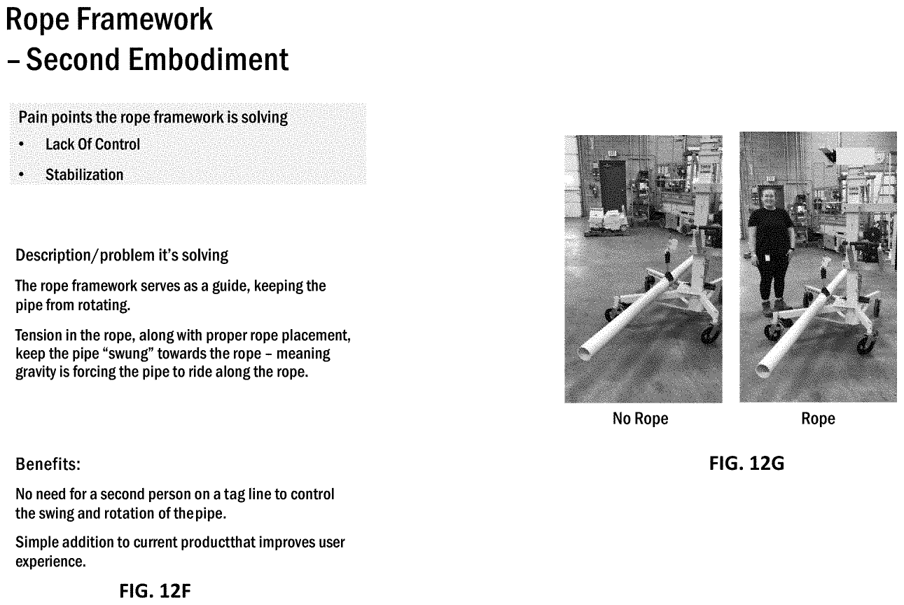

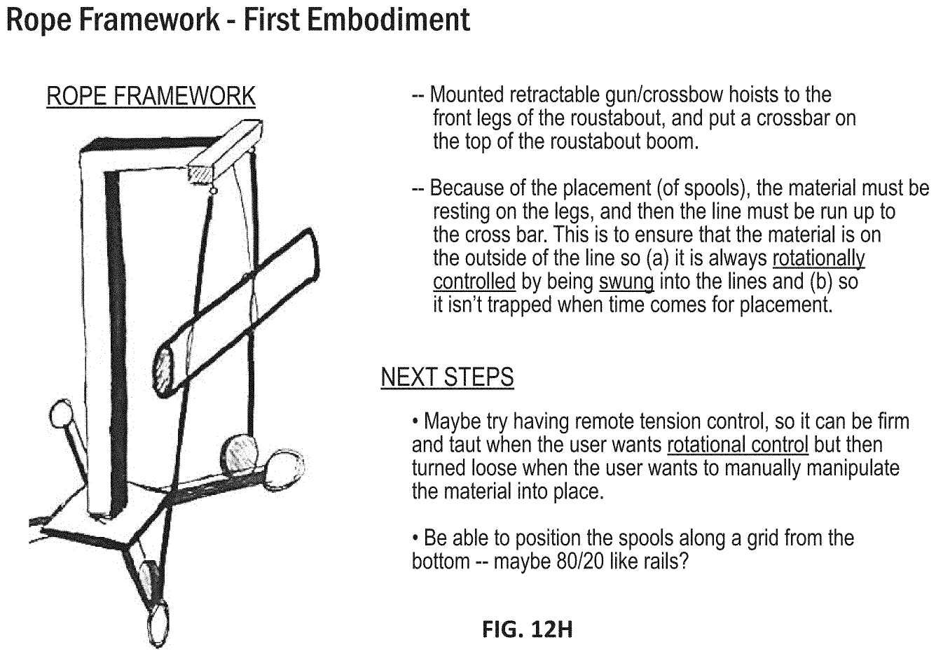

FIGS. 12A-12H illustrate several embodiments of rope framework configured to serve as a guide to prevent rotation of a load/material being lifted. Tension in the rope framework, along with proper framework placement, forces the load to ride along the rope.

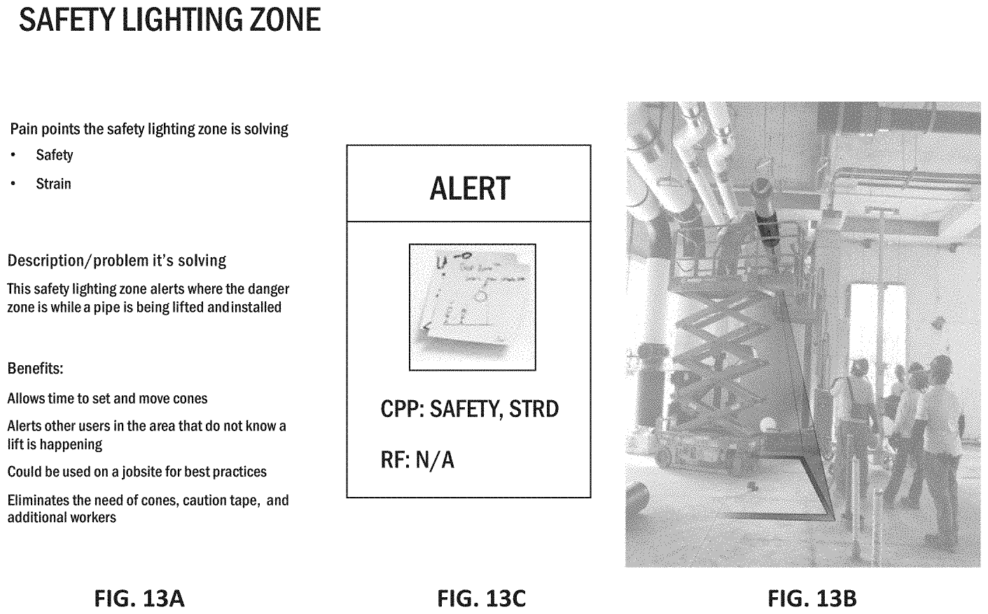

FIGS. 13A-13C illustrate a safety lighting zone device to be used in conjunction with a lift device. The lighting zone device illuminates a safety perimeter on the ground alerting others of a danger zone within the perimeter while a material is being lifted and installed.

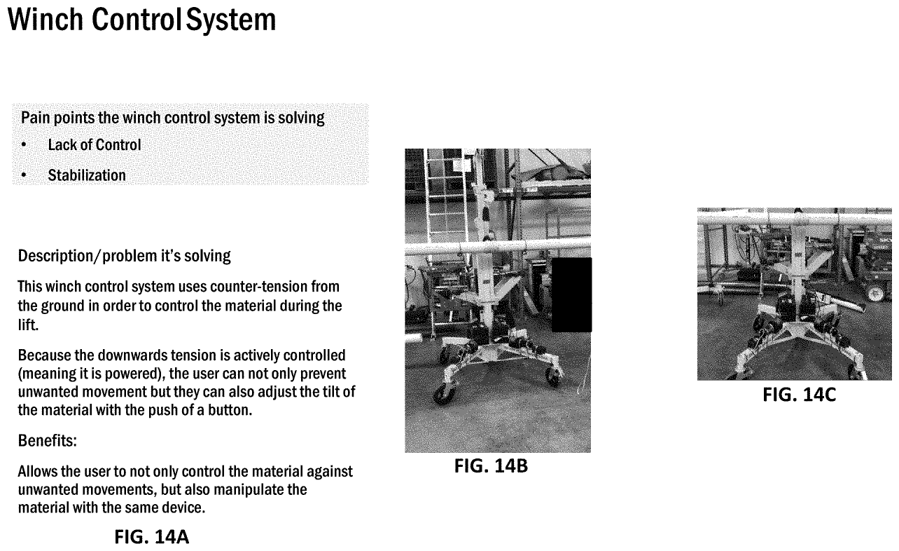

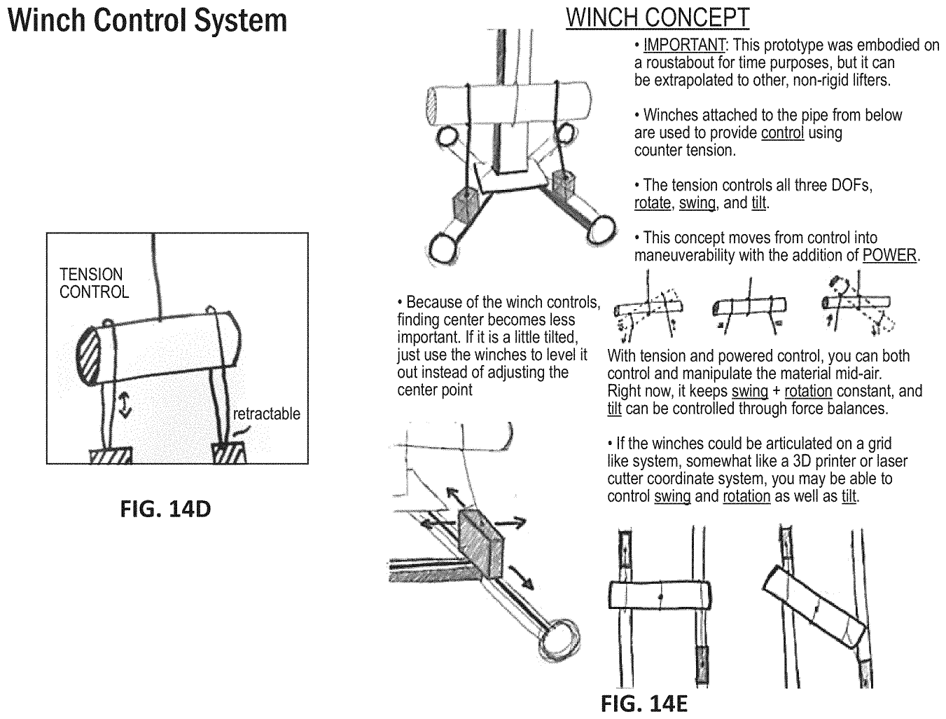

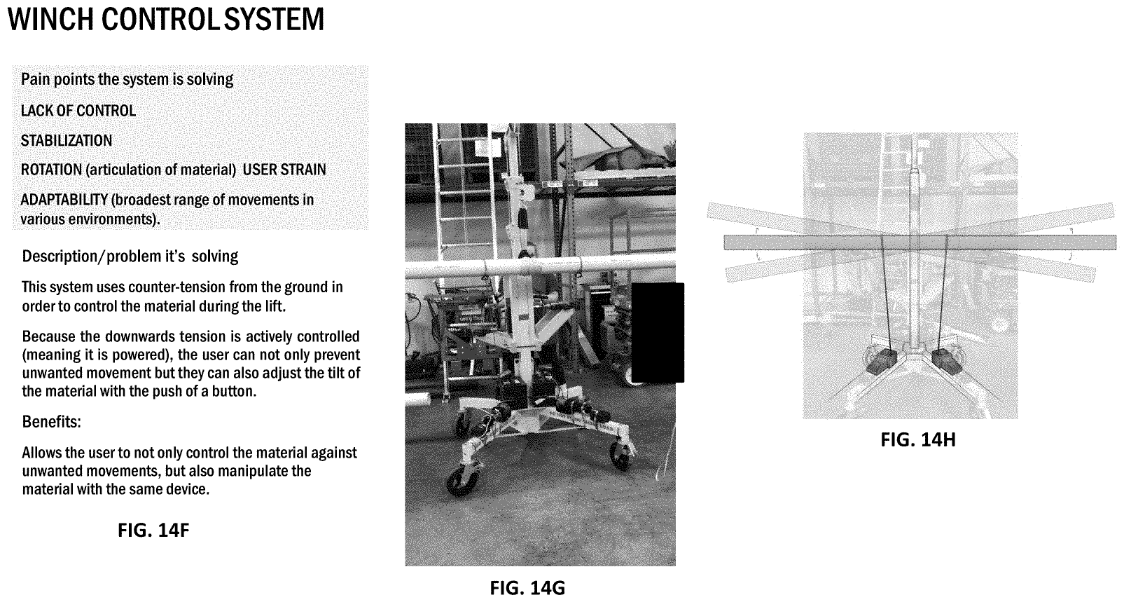

FIGS. 14A-14H illustrate a winch control system used to counter-tension from the ground in order to control a load/material during a lift. Since the downward tension is actively controlled (powered), the user can not only prevent unwanted movement of the load, but also adjust the tilt of the load with the control system. The winch control system may include a plurality of hoist system that communicate with each other to provide a controlled pipe lift. The hoist may be coupled to different locations on the pipe to rotate, swing, or otherwise control the pipe during operation.

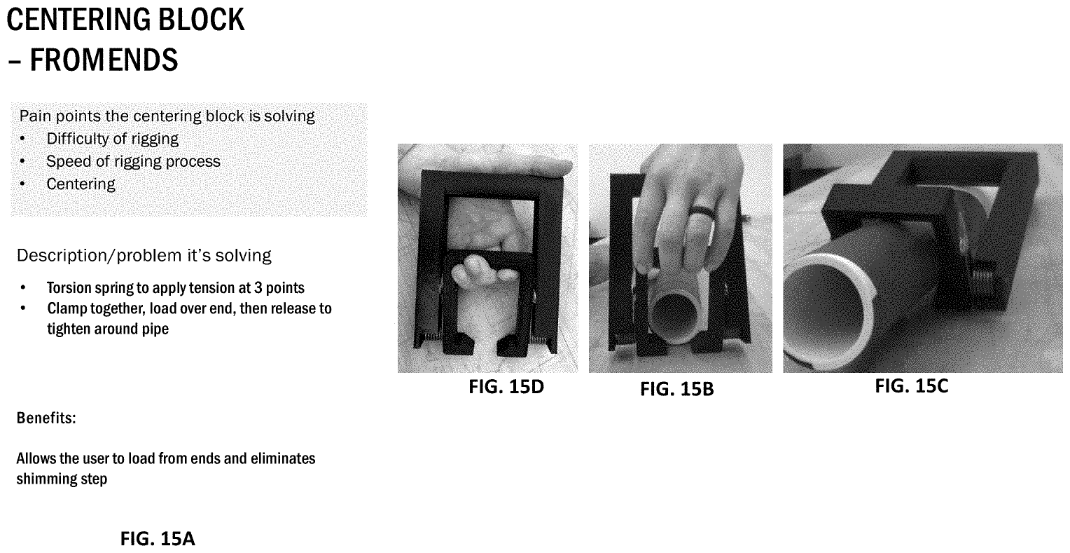

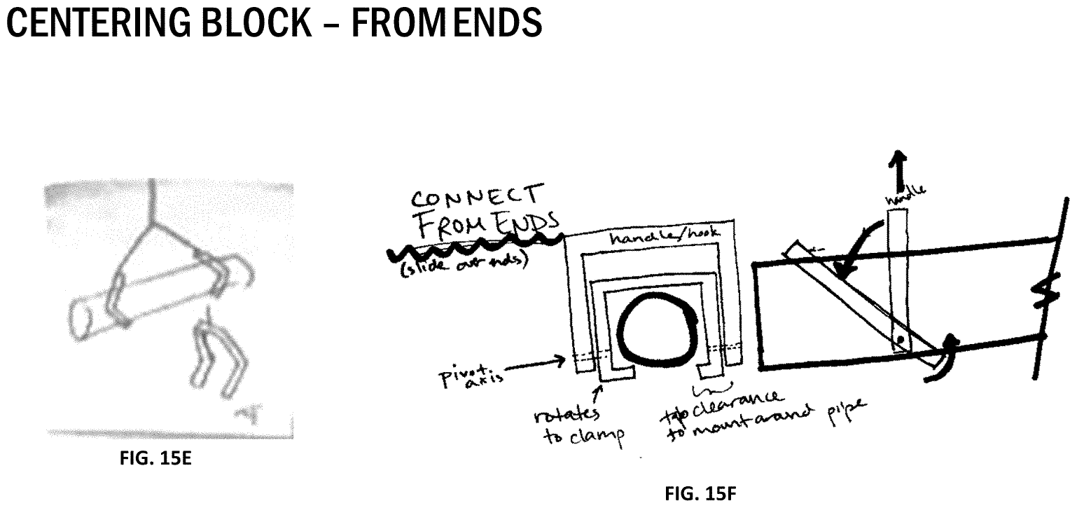

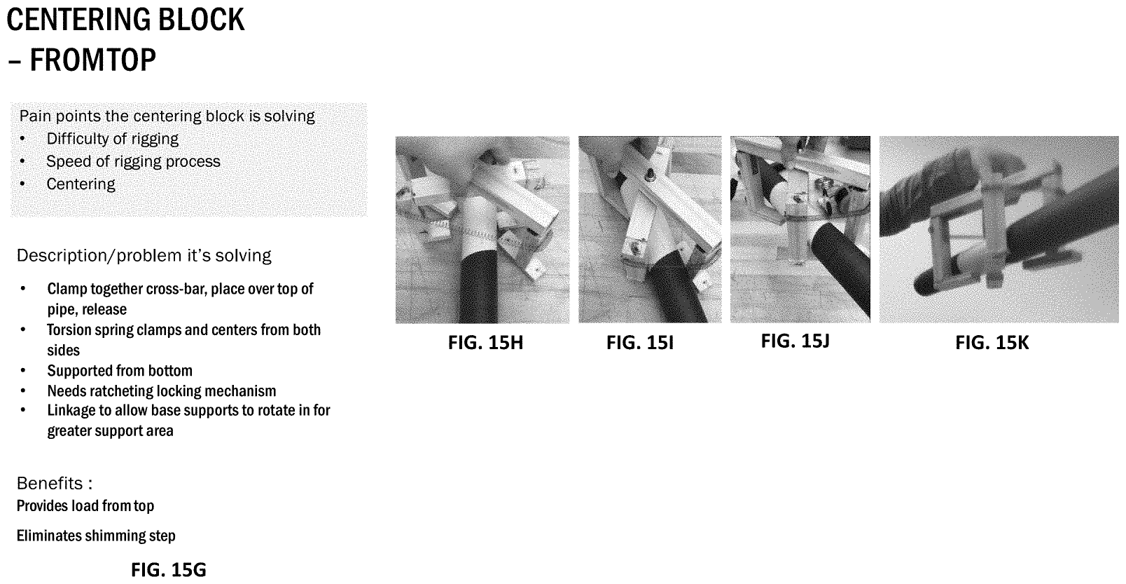

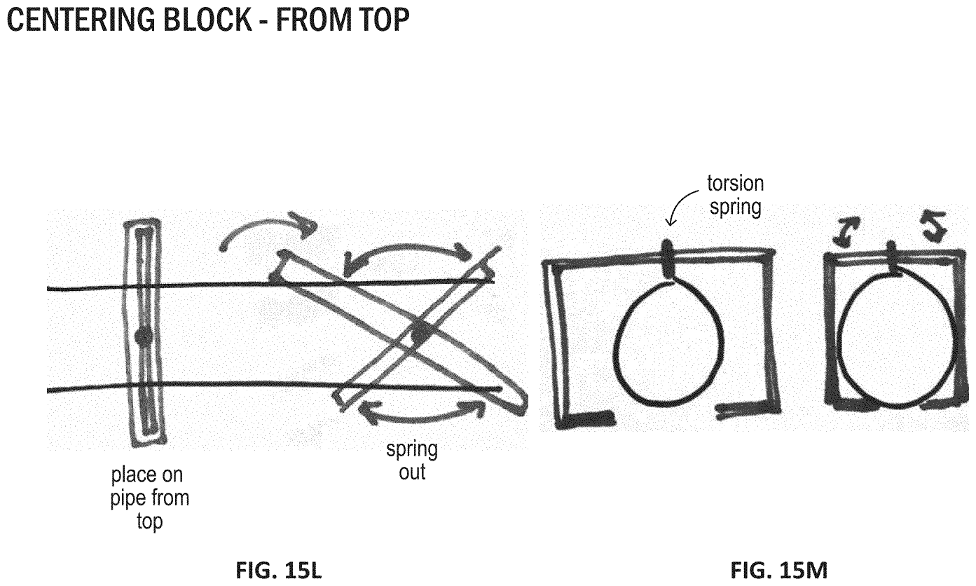

FIGS. 15A-15M illustrate several embodiments of centering blocks configured to tighten around/engage a load, allowing the user to load material from its ends, eliminating the shimming step. In some embodiments of the centering blocks, the centering blocks can include a torsion spring to apply tension at three points. In other embodiments of the centering blocks, the blocks can include a clamp together crossbar to be placed over the load, a ratcheting locking mechanism, a bottom support, and a linkage to allow the bottom support to rotate for a greater support area.

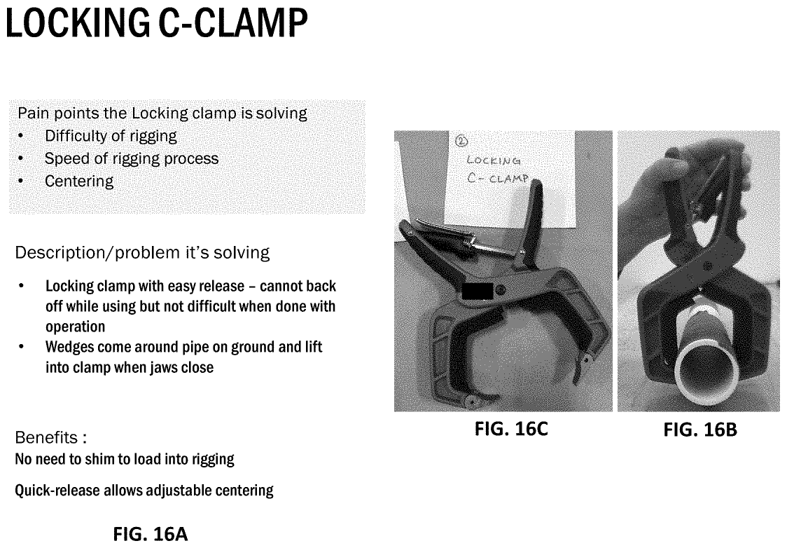

FIGS. 16A-16C illustrate a locking c-clamp to be used to secure a load/material ready to be lifted.

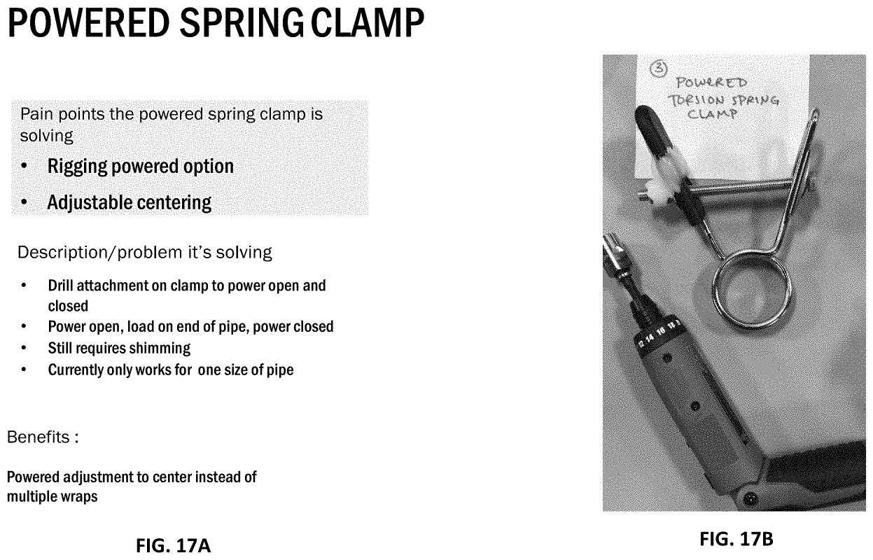

FIGS. 17A-17B illustrate a powered spring clamp to be used to secure a load/material ready to be lifted. The spring clamp can be adjustable for various load sizes and can be “powered” open or closed using a drill.

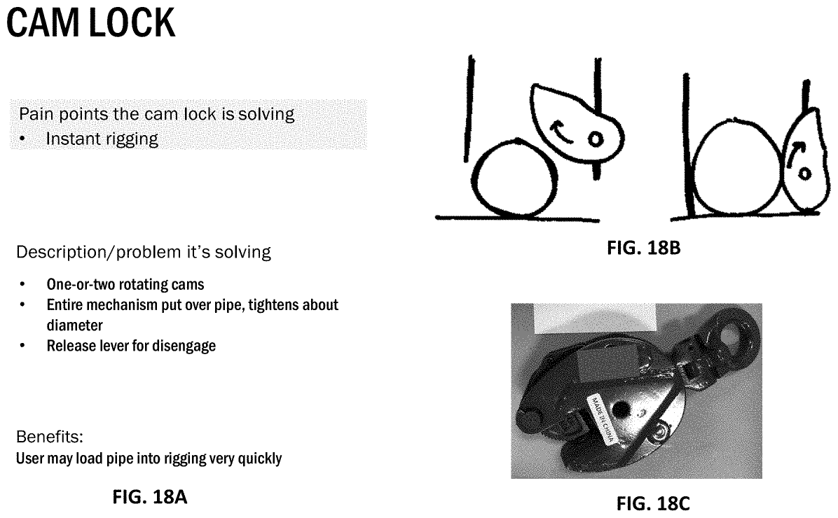

FIGS. 18A-18C illustrate a cam lock to be placed over a load in order to tighten around the diameter of the load. The cam lock can include a release lever to disengage the lock from the load.

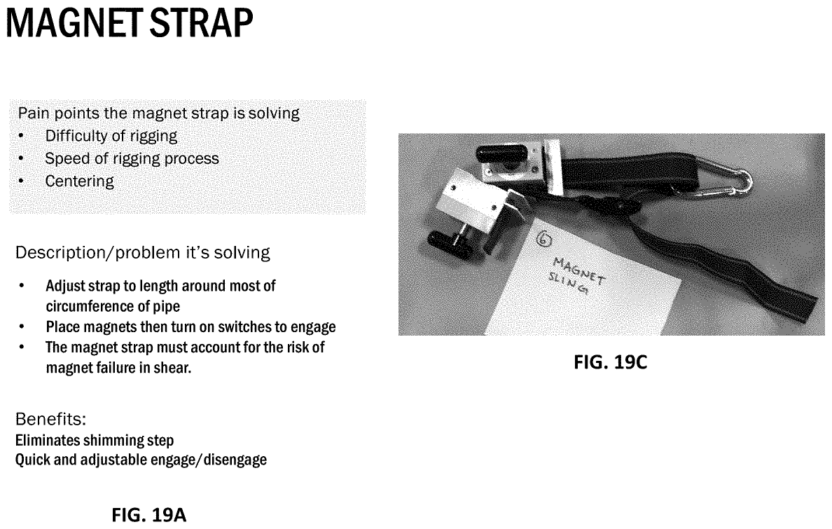

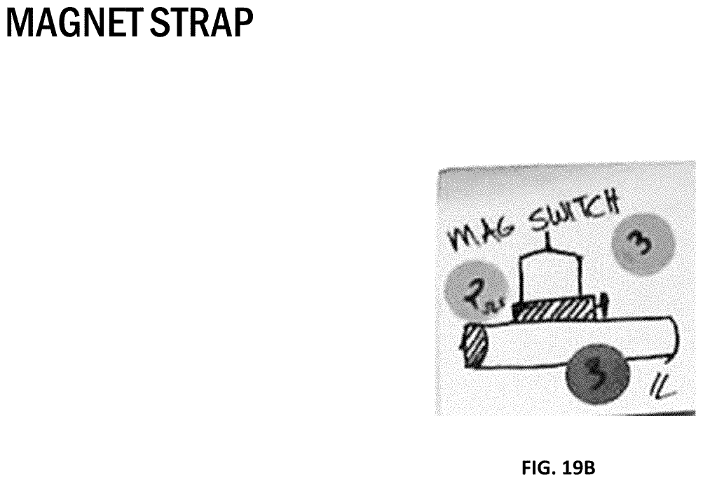

FIGS. 19A-19C illustrate a magnetic strap for adjusting a strap length around a material/load. The magnetic strap includes a strap having magnets positioned at each end. A user surrounds the load using the strap and places the magnets on the load to sufficiently tighten the strap around the load, and turns on respective switches on each of the magnets to engage the magnets, thereby fastening the strap around the load.

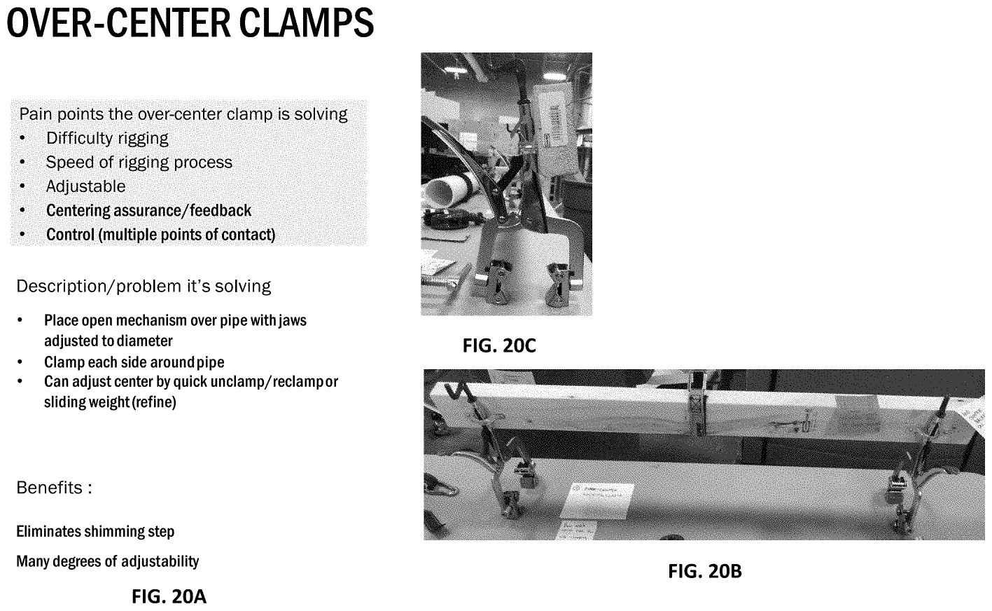

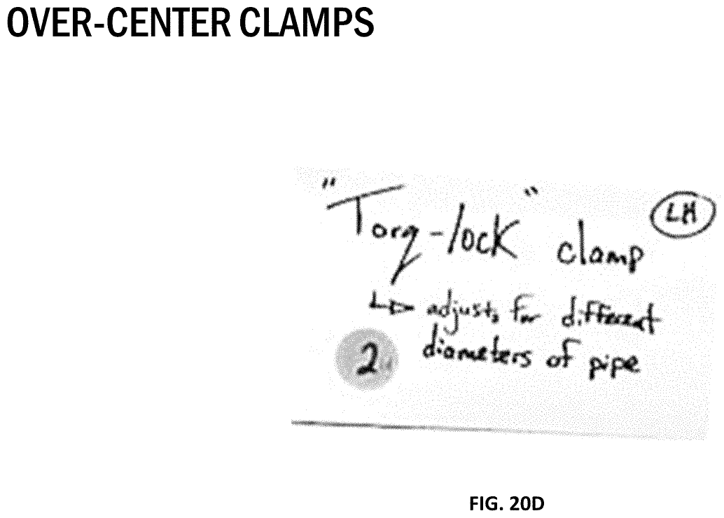

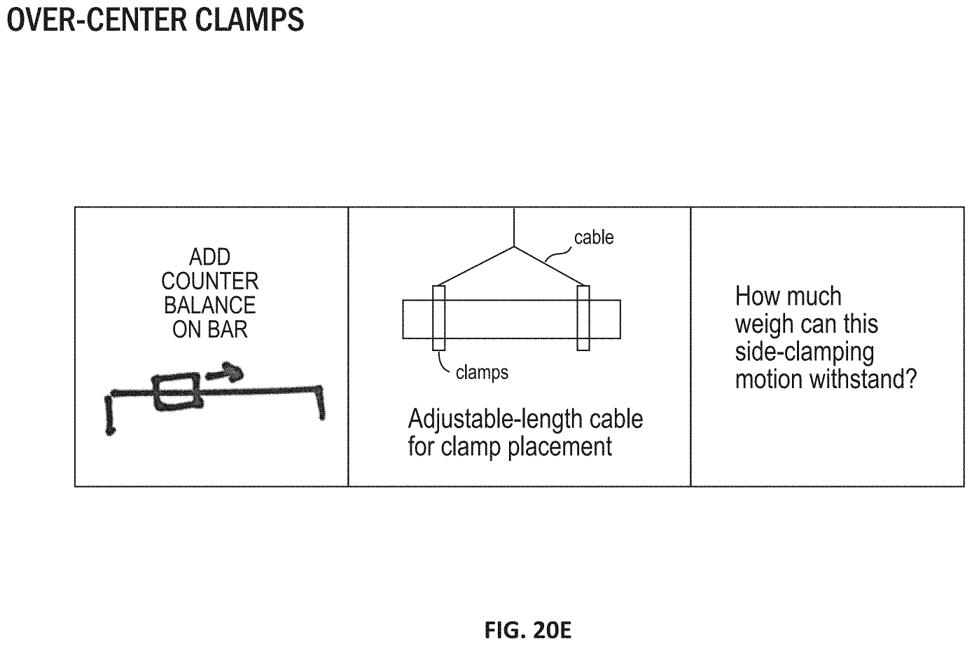

FIGS. 20A-20E illustrate an over-center clamp device configured to clamp around the sides of a load. A user can adjust the center of the lift by quickly unclamping/re-clamping the device around the load.

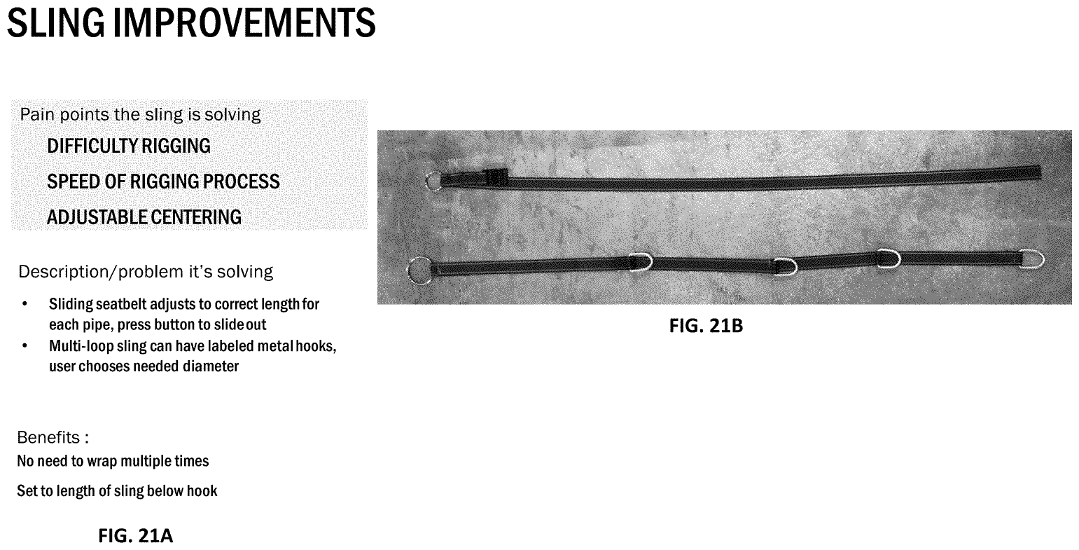

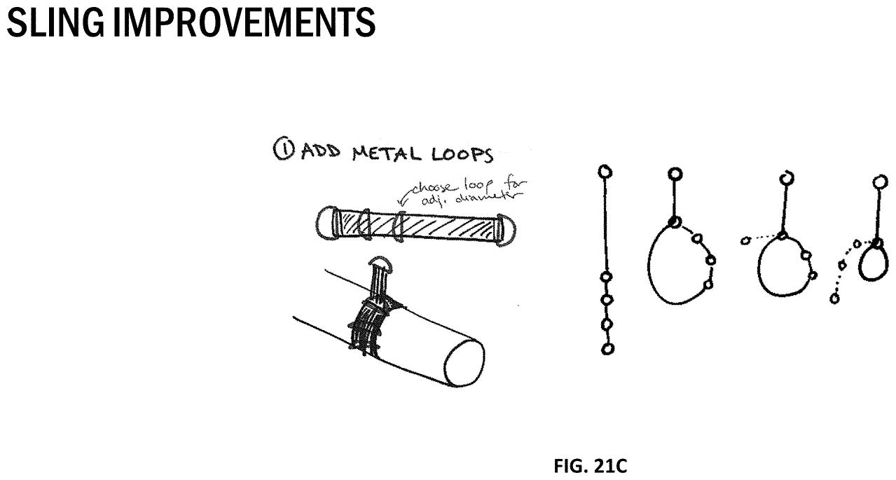

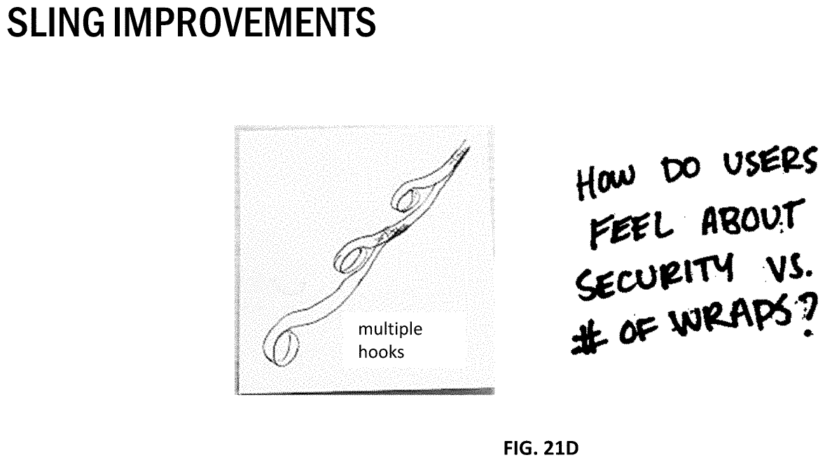

FIGS. 21A-21D illustrate several embodiments of sling improvements including sliding seatbelts to adjust for the correct length around a load, and multi-looped slings having labeled metal hooks according to a pre-set diameter.

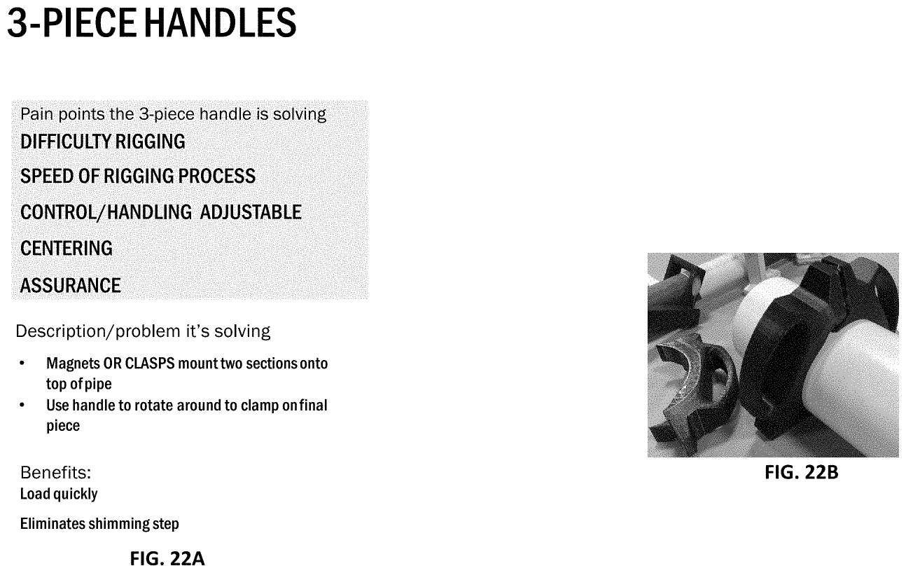

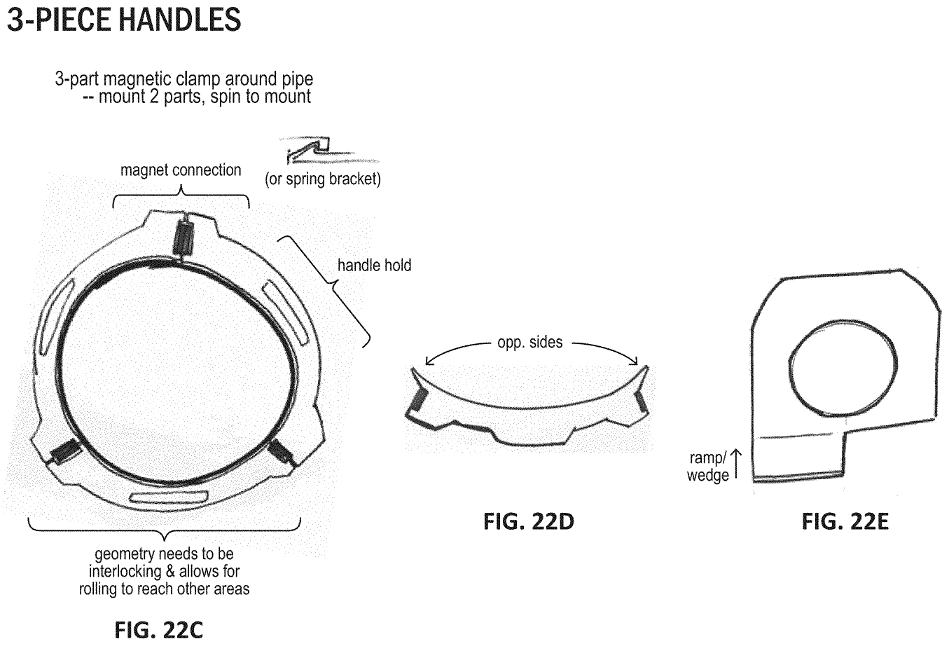

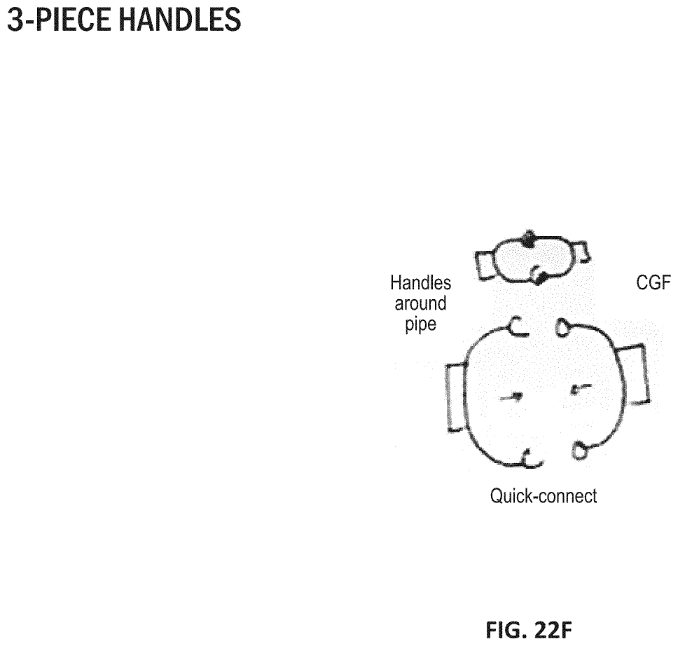

FIGS. 22A-22F illustrate a 3-piece handle system secured by magnets or clasps that is configured to be rotatable around a load/material.

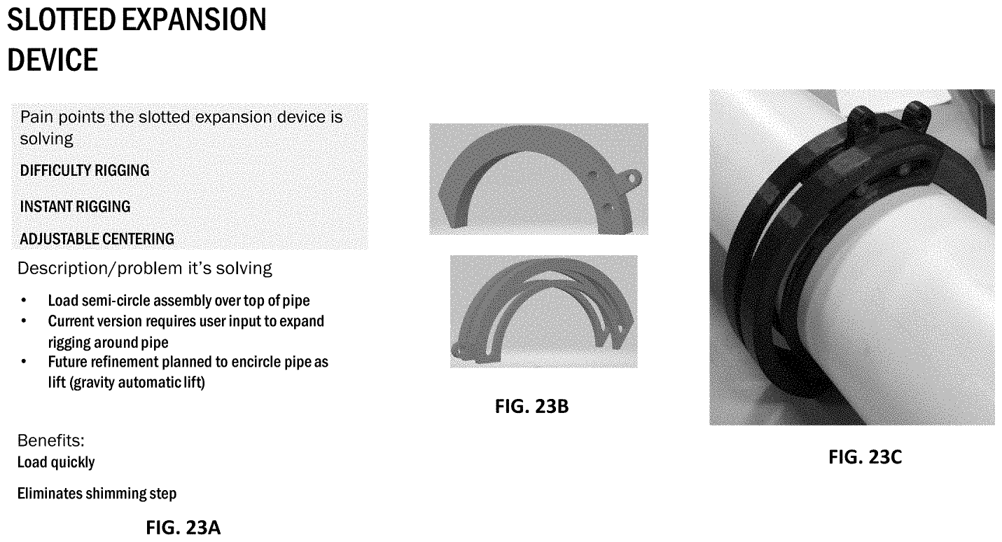

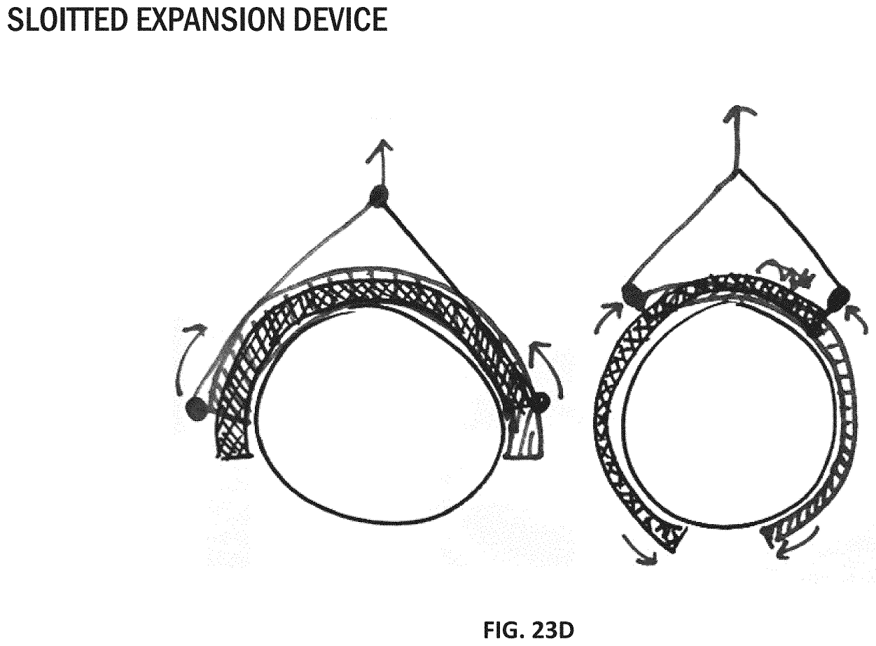

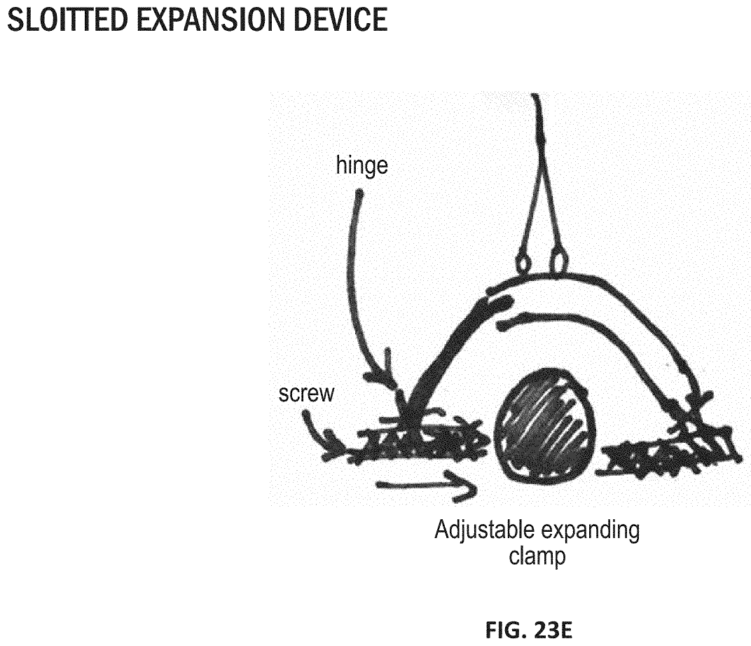

FIGS. 23A-23E illustrate a slotted expansion device including an extendable semi-circle clamp assembly configured to extend around a load/material, a hinge, and a slot allowing the clamp to expand around the load via the slot.

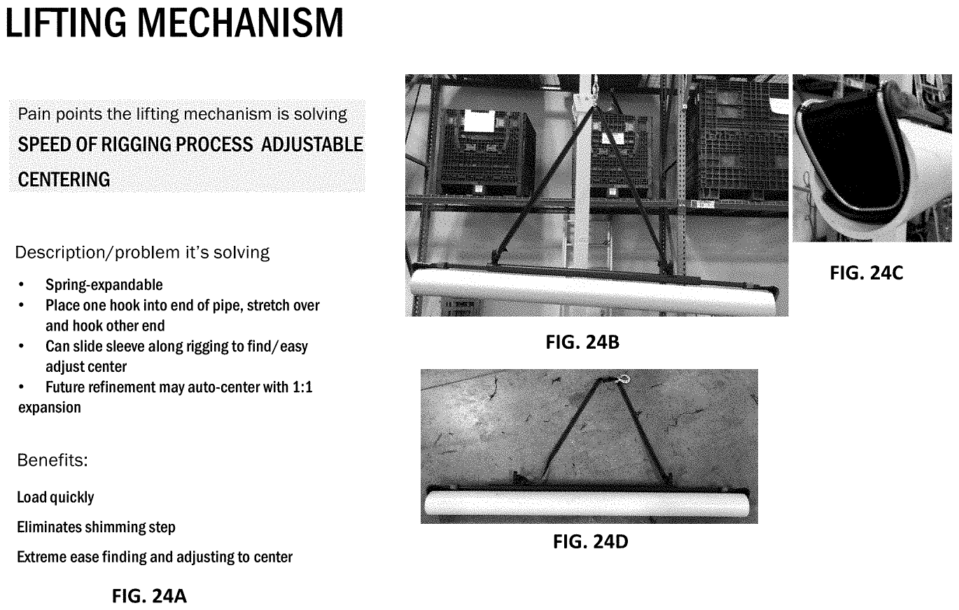

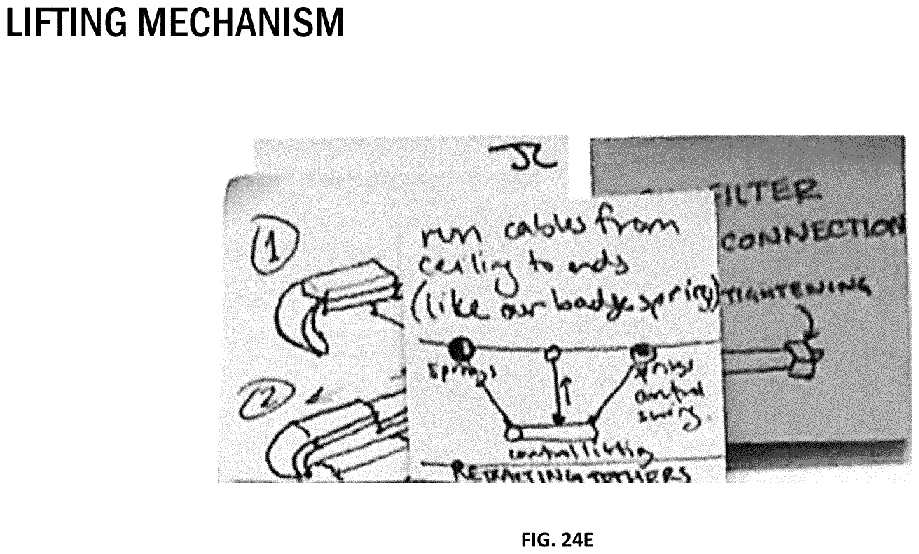

FIGS. 24A-24E illustrate a spring-expandable lifting mechanism including a spring having a hook on each end. To secure a load, a user places one hook into an end of the load and stretches the other hook to other end of the load to secure to opposite end of the load.

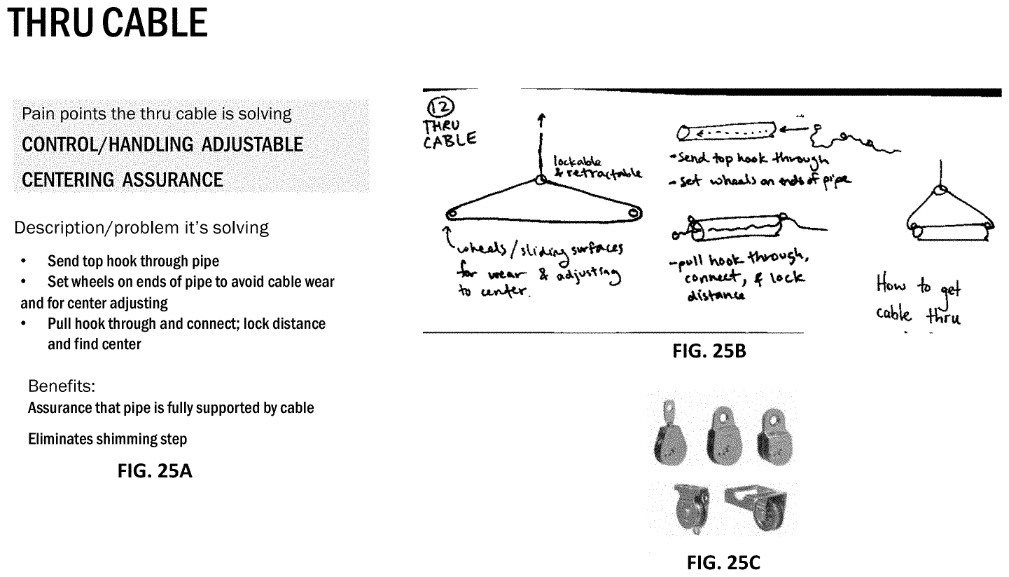

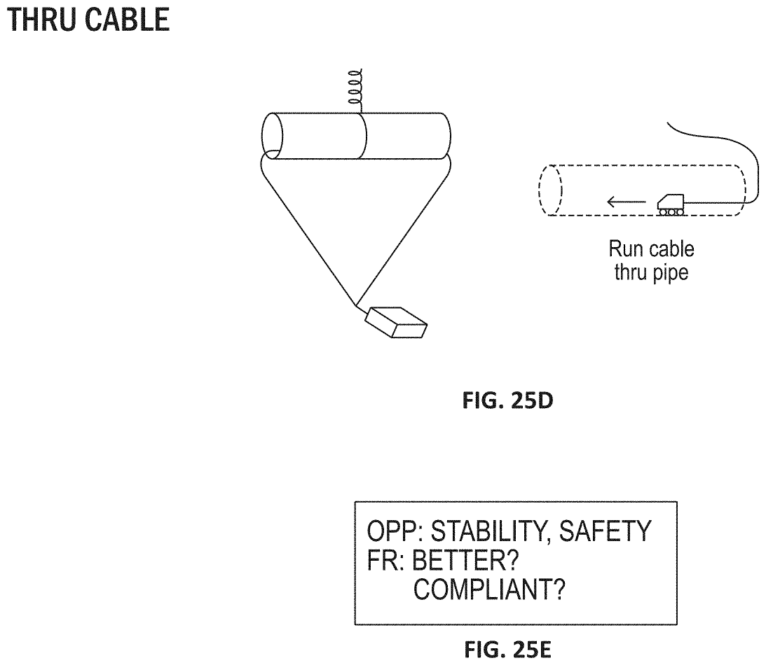

FIGS. 25A-25E illustrate a thru cable system including a cable having a plurality of wheels/pulleys for the cable to pass through. A user passes the cable system through one end of a load and locks the other end of the cable together. The user can adjust the tension of the cable by synching the cable via the wheels/pulleys.

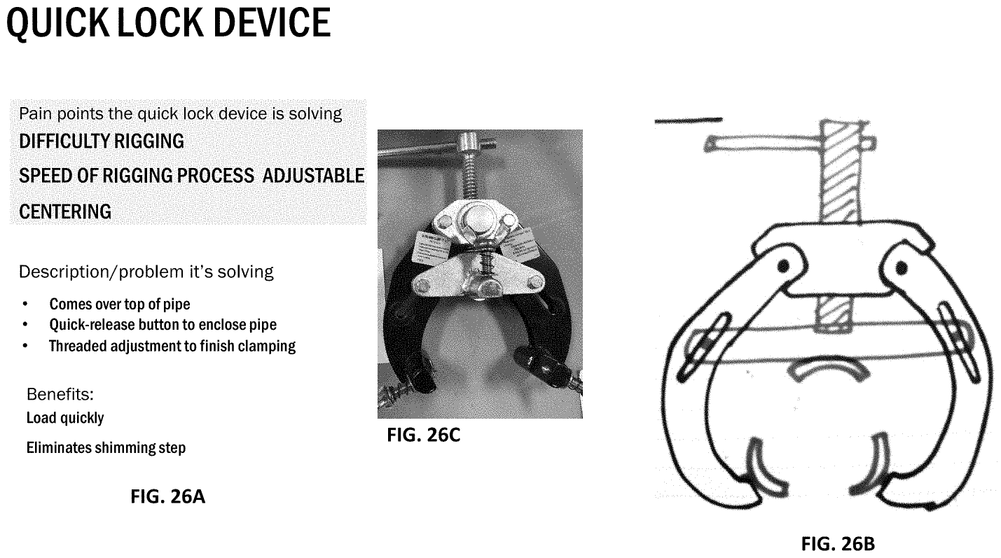

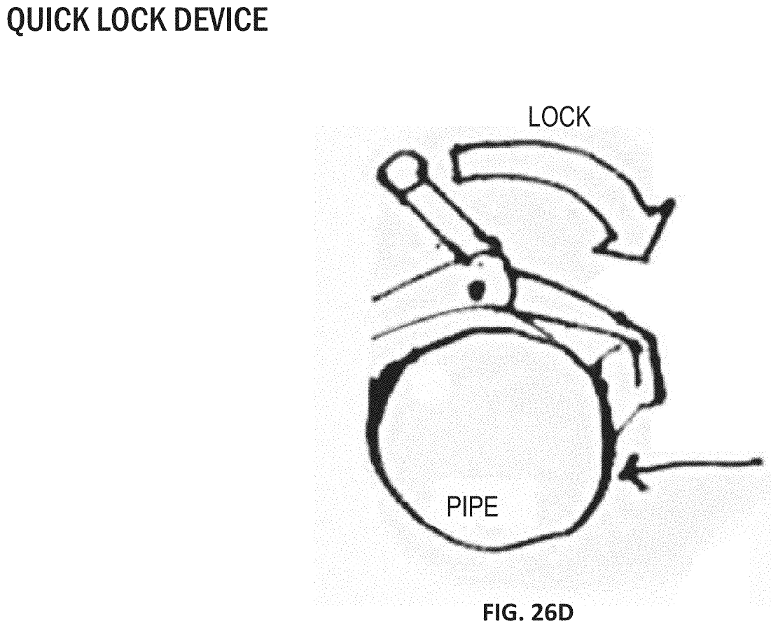

FIGS. 26A-26D illustrate a quick lock device for securing a load including a quick-release button to selectively enclose the load, and a threaded adjustment mechanism to finish clamping the load.

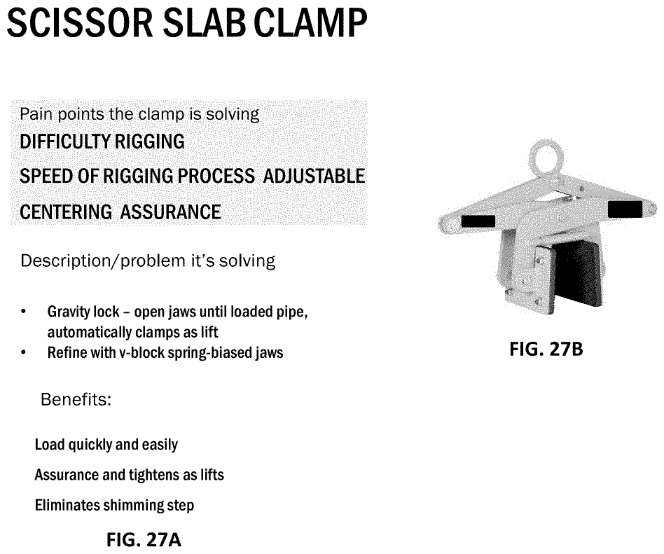

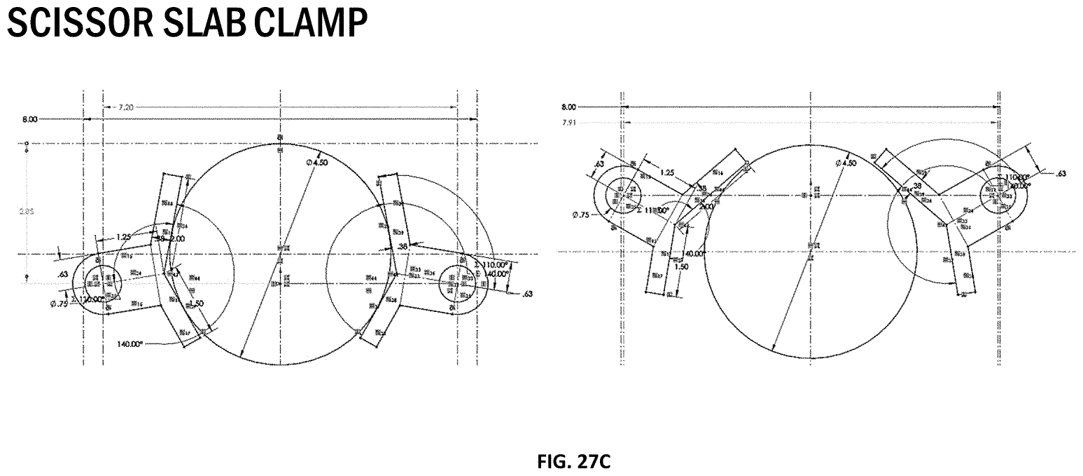

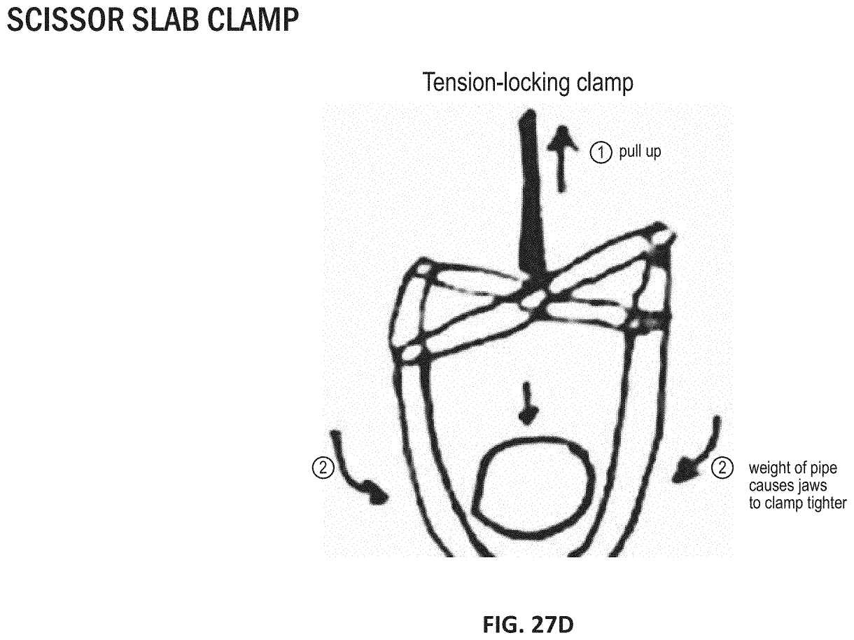

FIGS. 27A-27D illustrate a scissor slab clamp configured to secure a load including a gravity lock. The gravity lock is configured to keep jaws open until a load is inserted within the jaws, which automatically clamps the lock as lift occurs. In some embodiments, the lock can include a v-block spring-biased set of jaws.

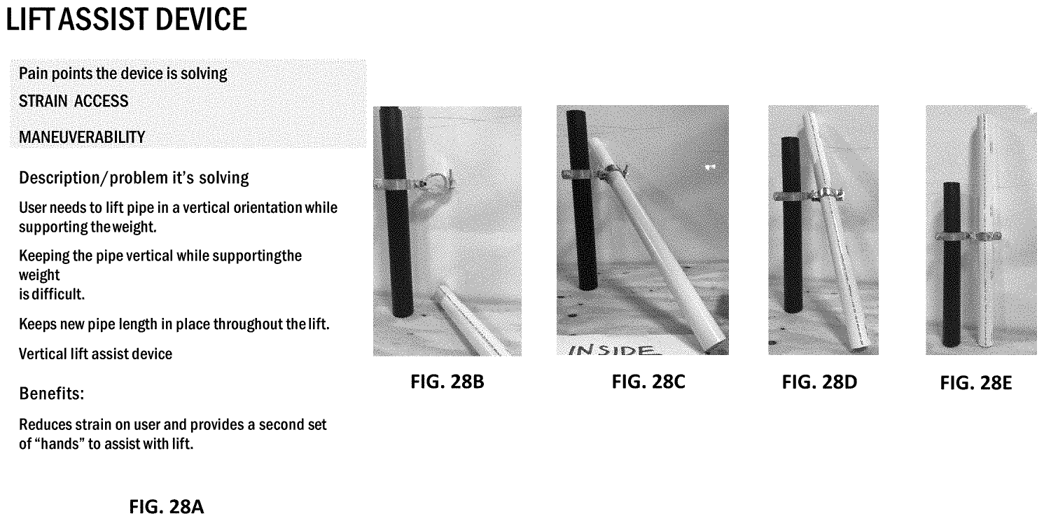

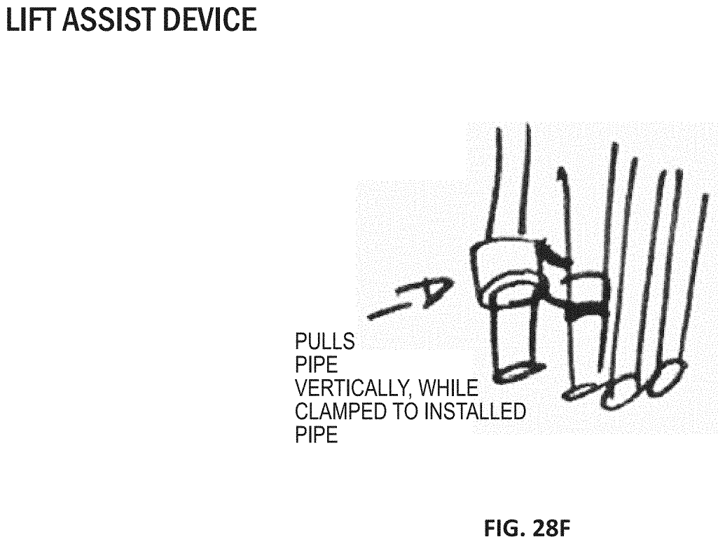

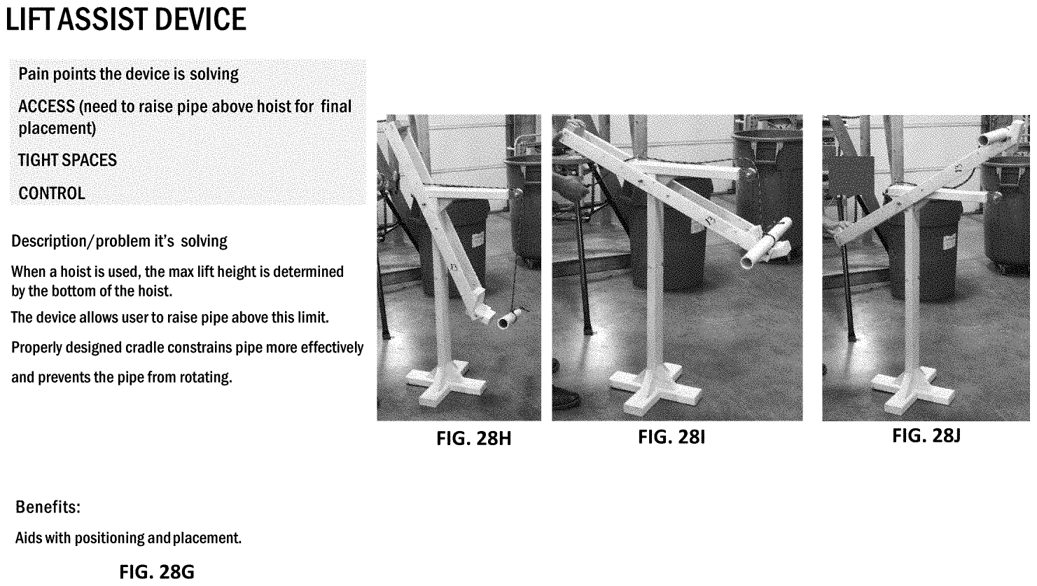

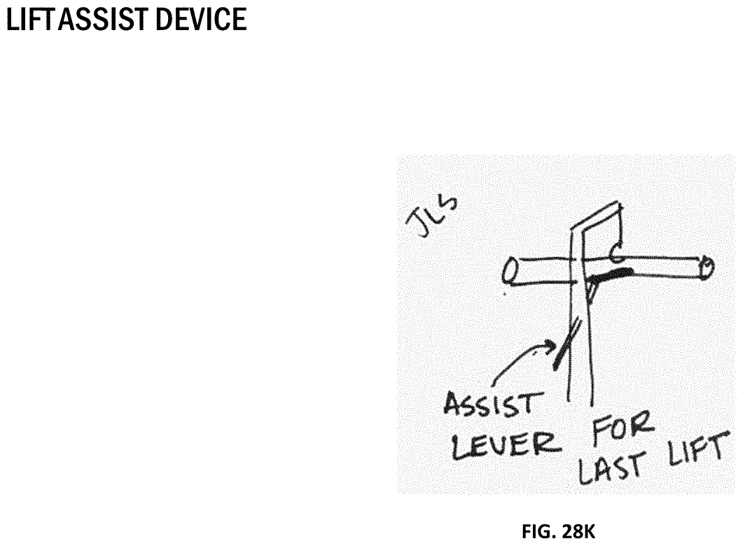

FIGS. 28A-28K illustrate several embodiments of a lift assist device for keeping a load in a vertical orientation while it is being lifted. In other embodiments, a hoist can be used, and the lift assist device allows a user to raise a load above the bottom lift limit of the hoist.

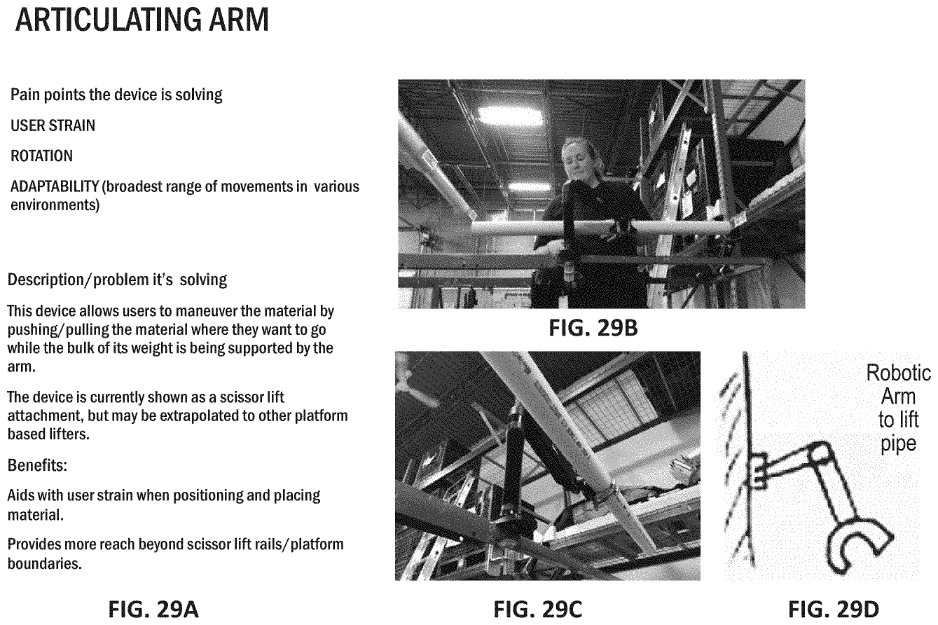

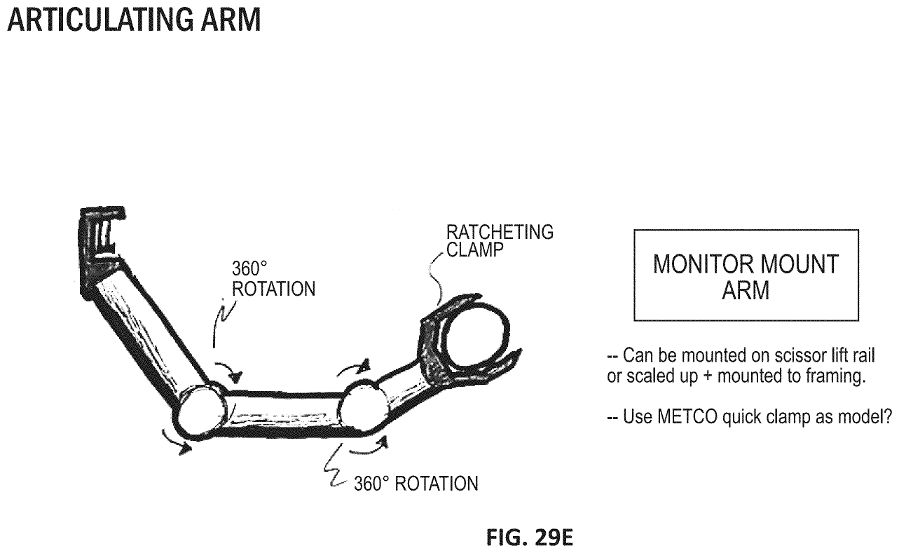

FIGS. 29A-29E illustrate an articulating arm allowing a user to maneuver a material by pushing/pulling the material to a desired location while a majority of the material's weight is being supported by the arm. In some embodiments, the articulating arm can be used with a scissor lift.

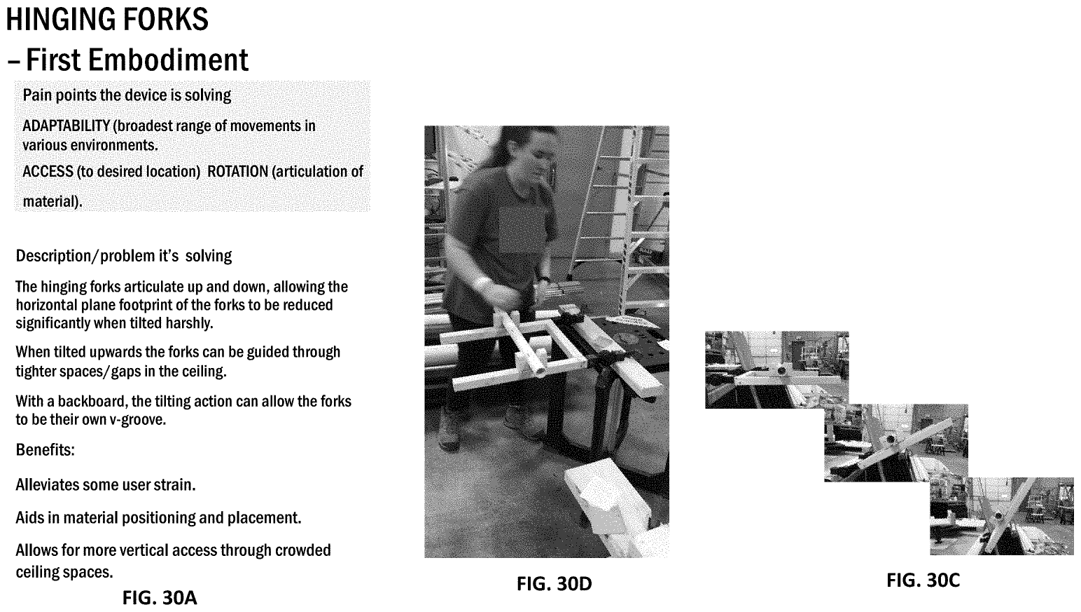

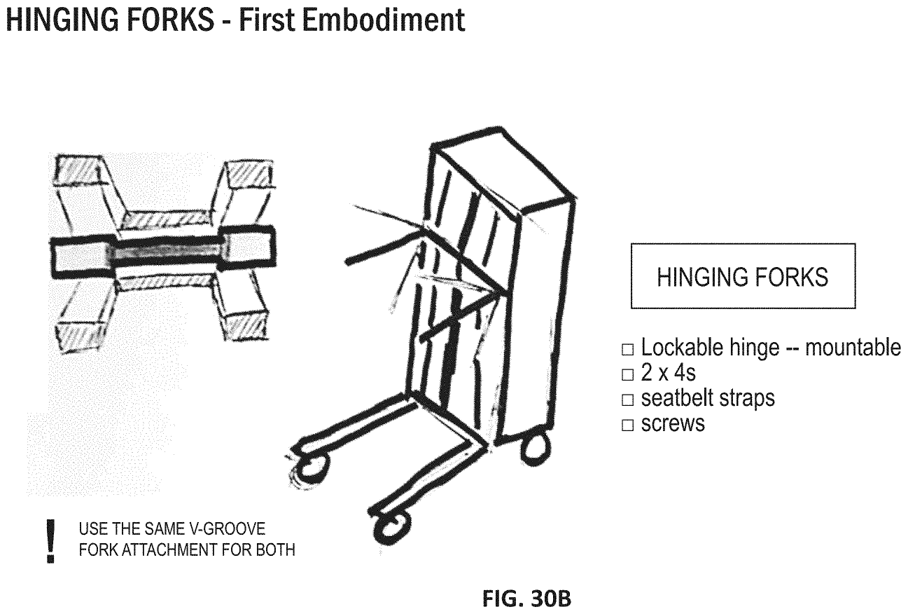

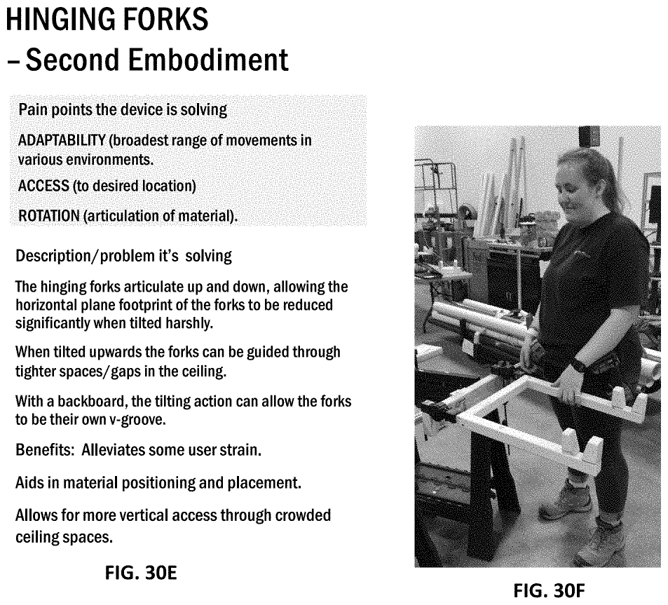

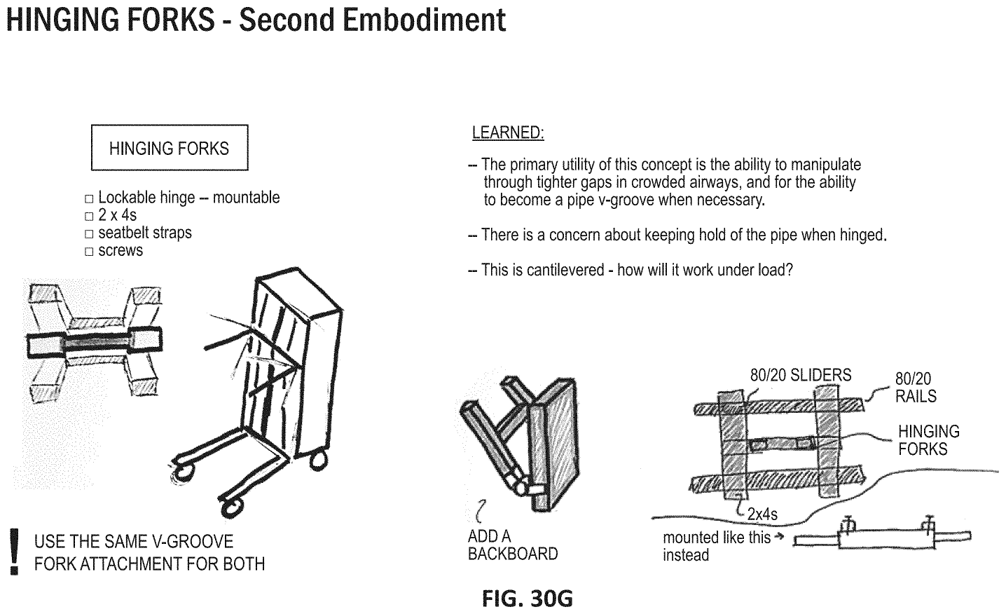

FIGS. 30A-30G illustrate several embodiments of hinging forks configured to articulate up and down, allowing the horizontal plane footprint of the forks to be reduced significantly when tilted harshly. When the forks are tilted upwards, the forks can be guided through tighter spaces/gaps in the ceiling. In some embodiments, the forks include a backboard, allowing the forks to be their own v-groove.

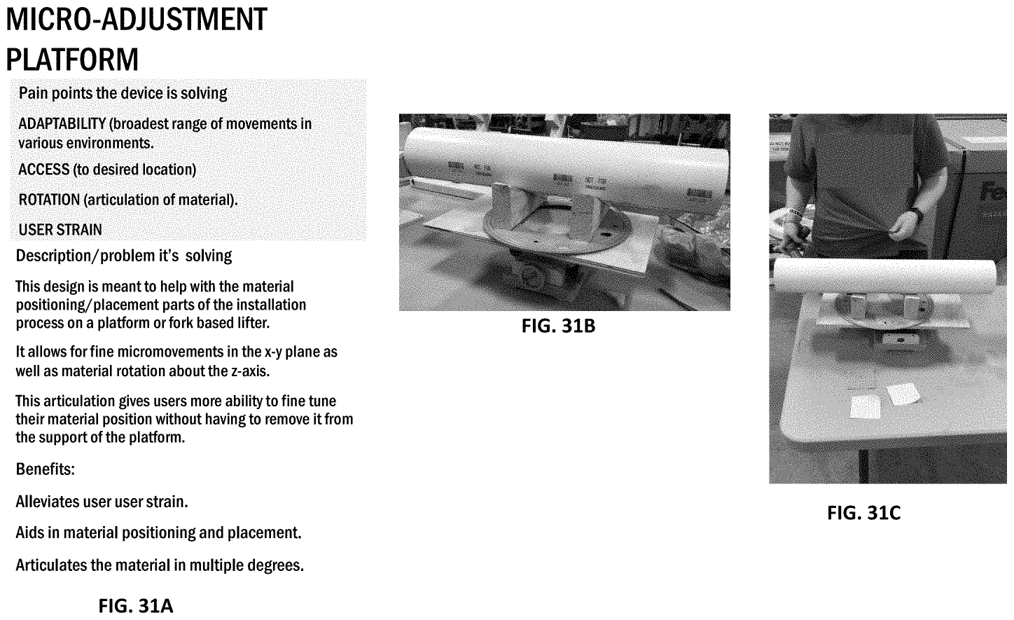

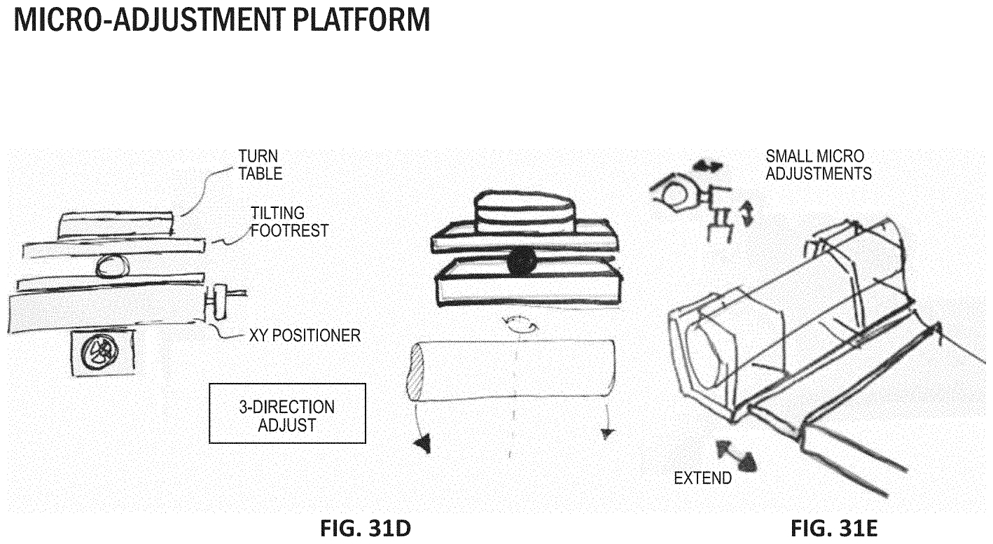

FIGS. 31A-31E illustrate a micro-adjustment platform configured to help with positioning/placement of parts related to the installation process on a platform or fork based lifter. The micro-adjustment platform allows for fine micro-movements in the x-y plane, and material rotation in the z-axis.

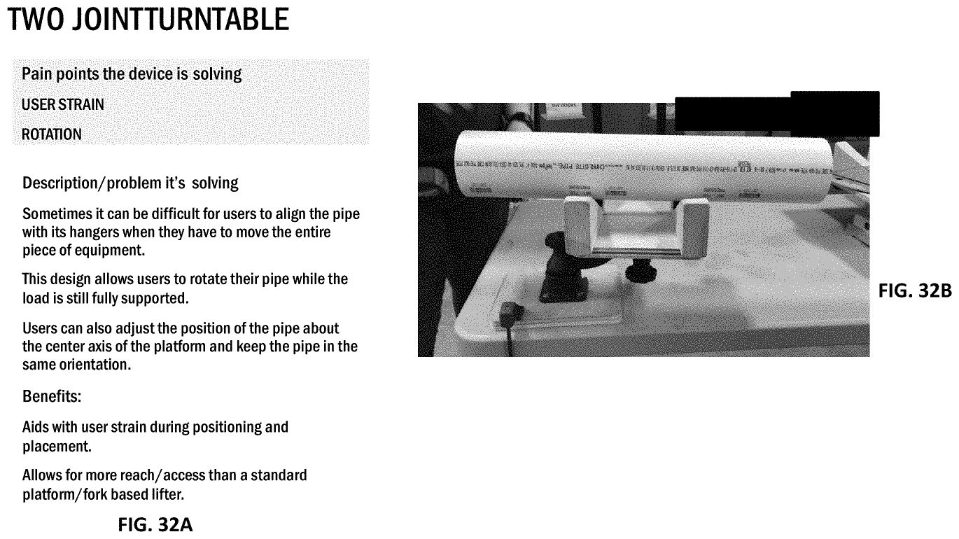

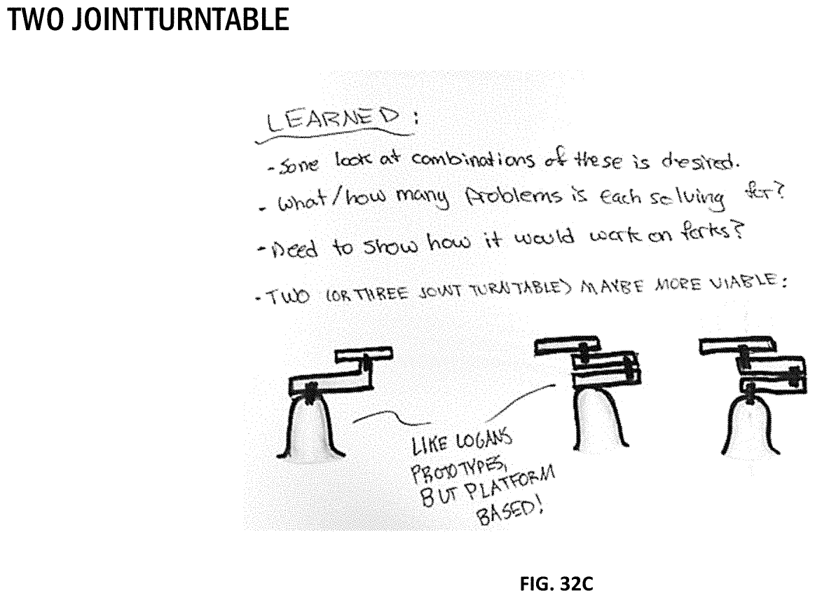

FIGS. 32A-32C illustrate a two turntable configured to allow users to rotate a material/load while the load is still fully supported. Additionally, the turntable allows users to also adjust the position of the load about the center axis of the platform while keeping the load in the same orientation.

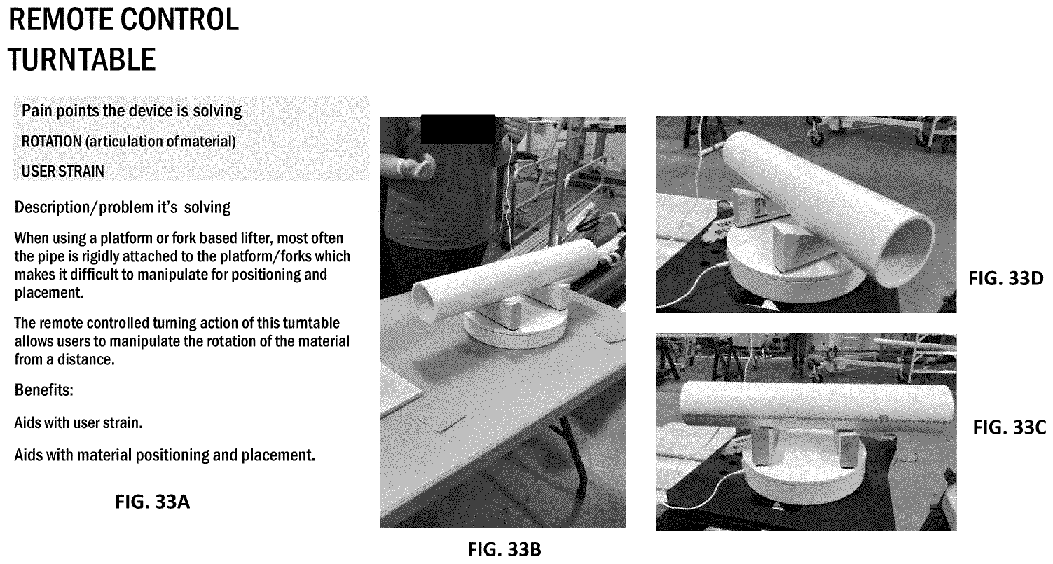

FIGS. 33A-33D illustrate a remote-control turntable for use with a platform or fork based lifter. The turntable allows a user to manipulate the rotation of a material/load from a distance.

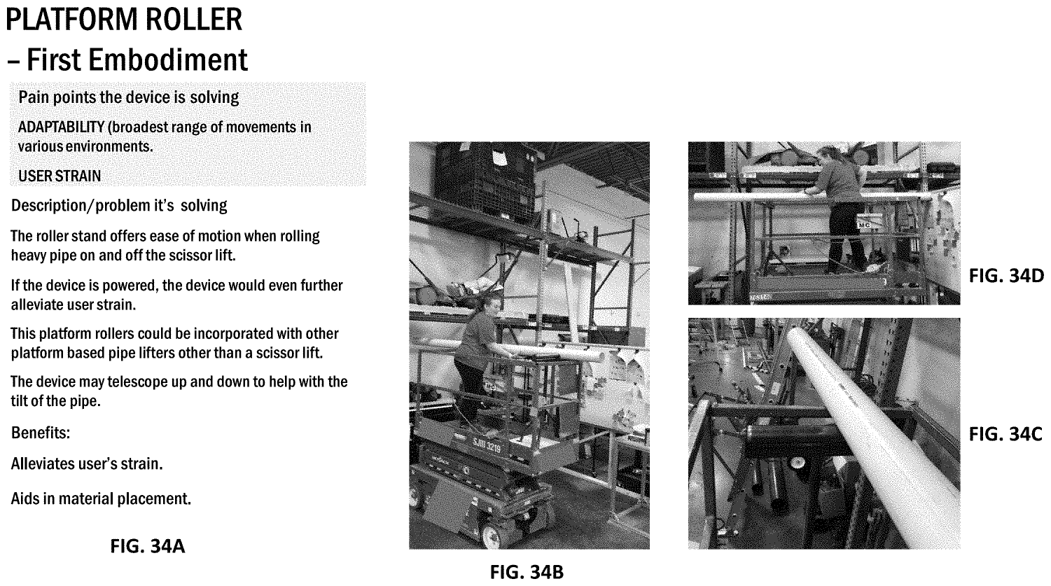

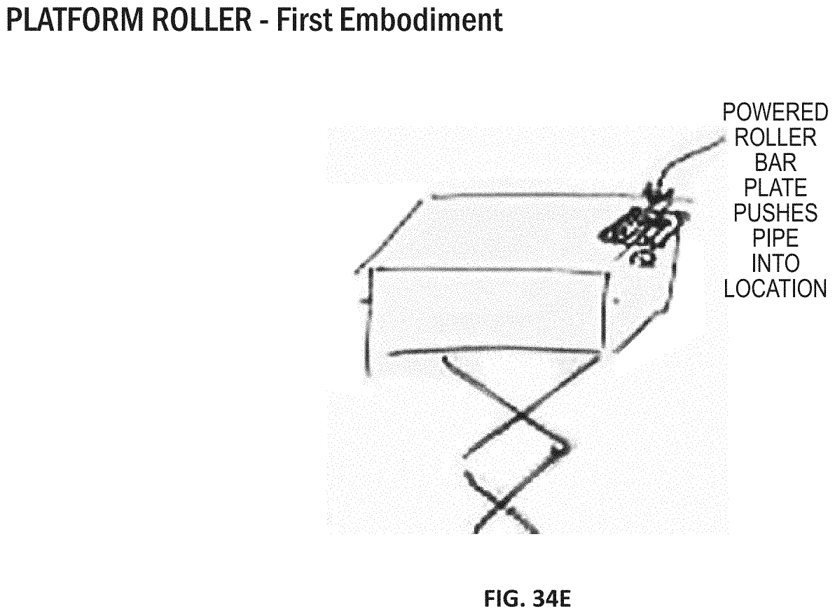

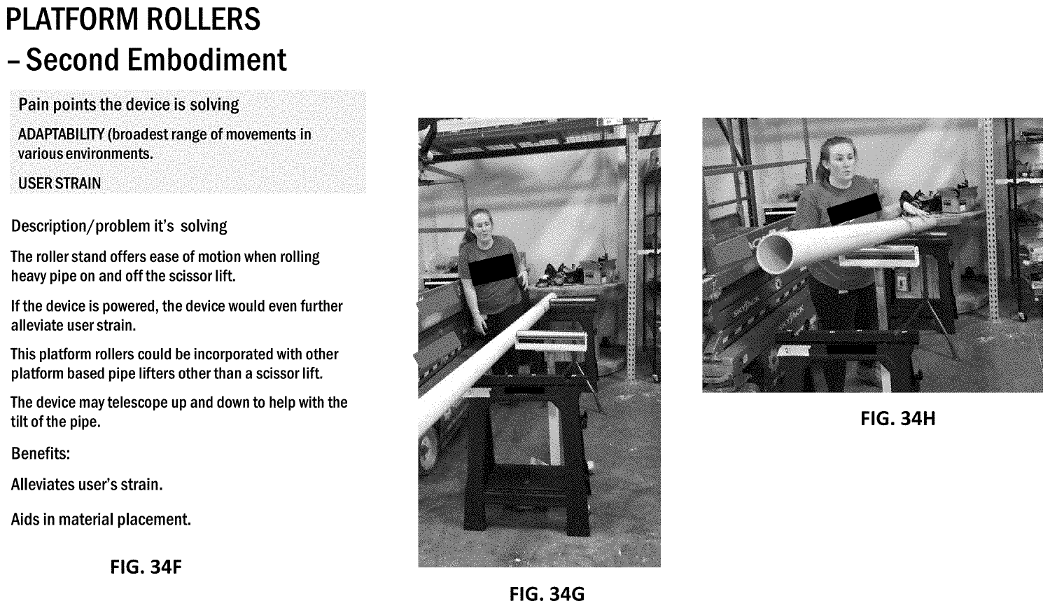

FIGS. 34A-34H illustrate several embodiments of a platform roller configured to facilitate the transport of lift materials. In some embodiments, the roller can be used with a scissor lift. In other embodiments, the roller can telescope up and down to help with the tilt of the lift materials.

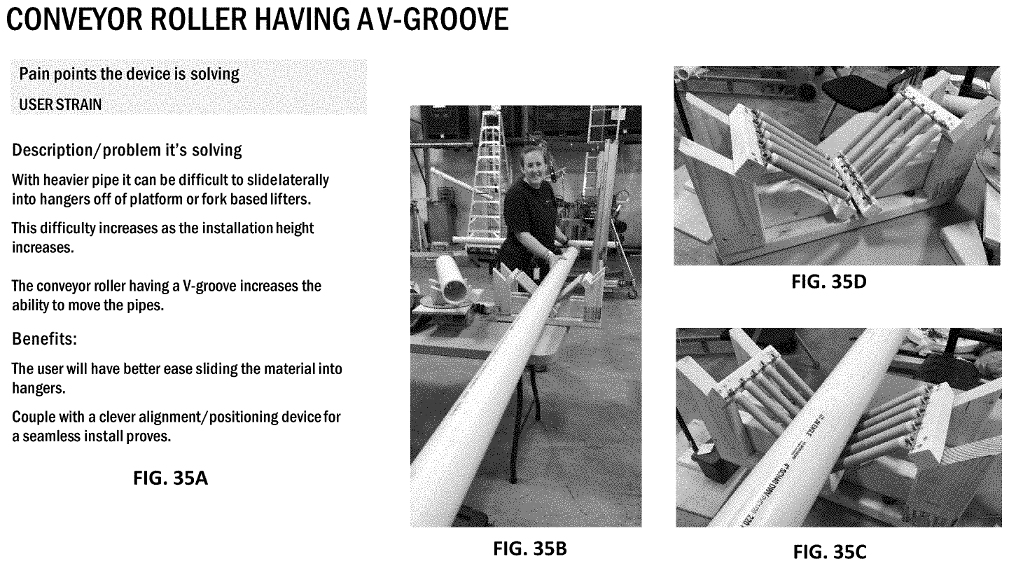

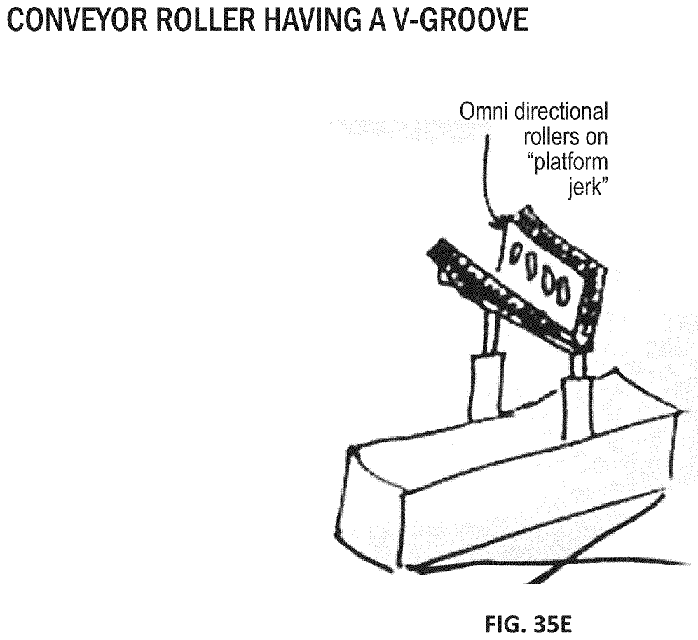

FIGS. 35A-35E illustrate a conveyor roller including a v-groove configured to facilitate the mobility of lift materials.

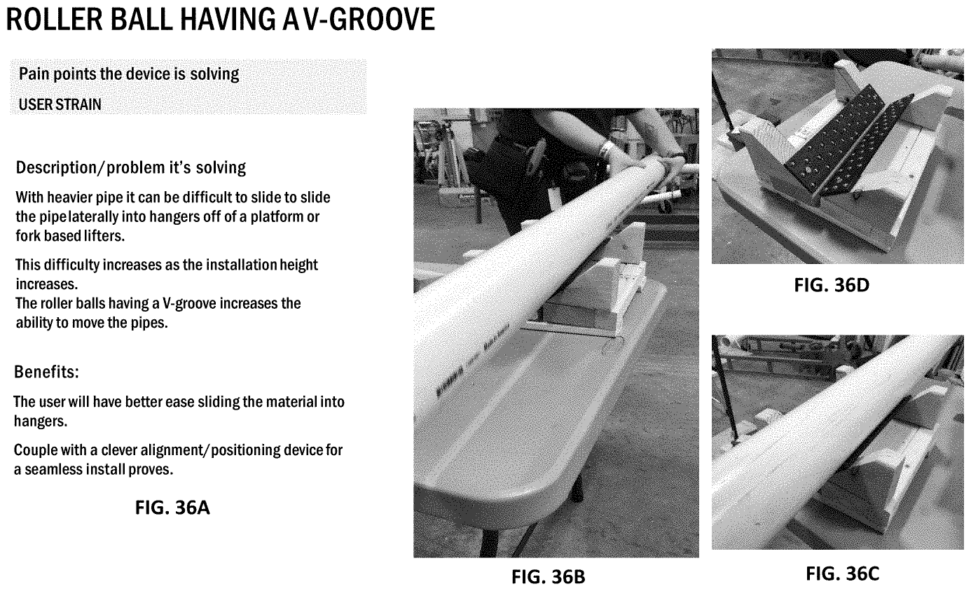

FIGS. 36A-36D illustrate a roller ball including a v-groove configured to facilitate the mobility of lift materials, in particular, heavier lift materials.

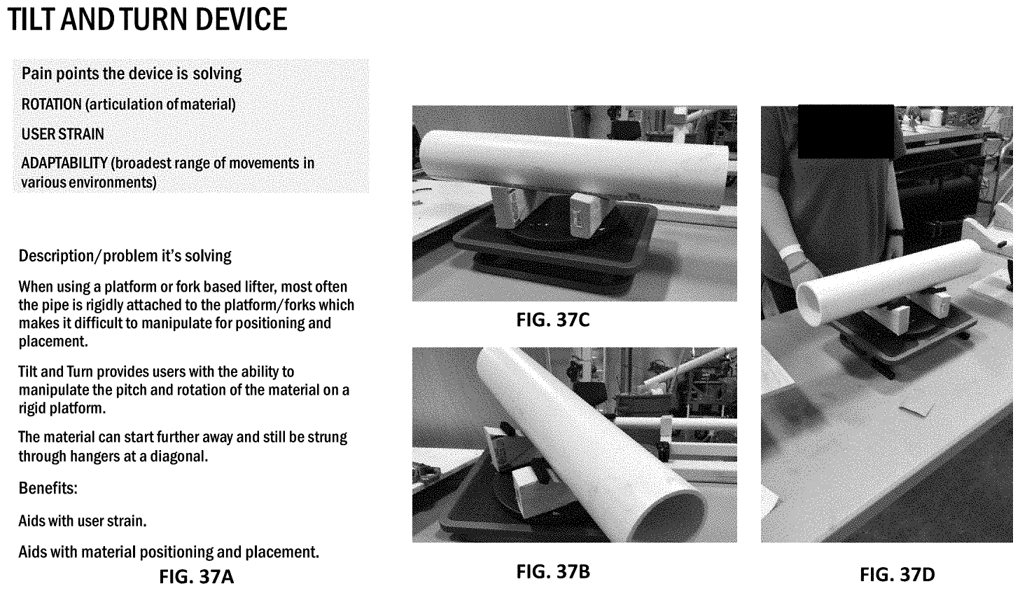

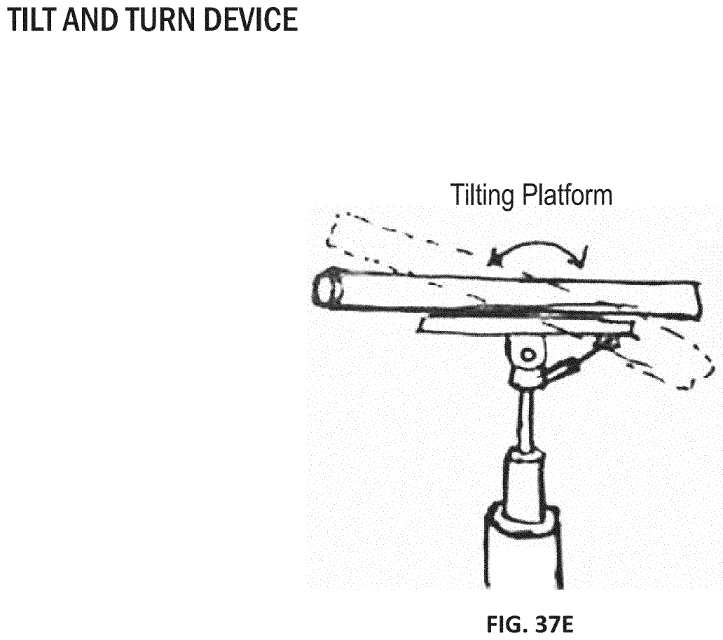

FIGS. 37A-37E illustrate a tilt and turn device for use with a platform or fork based lifter. The tilt and turn device allows users to manipulate the pitch and rotation of lift materials on a rigid platform.

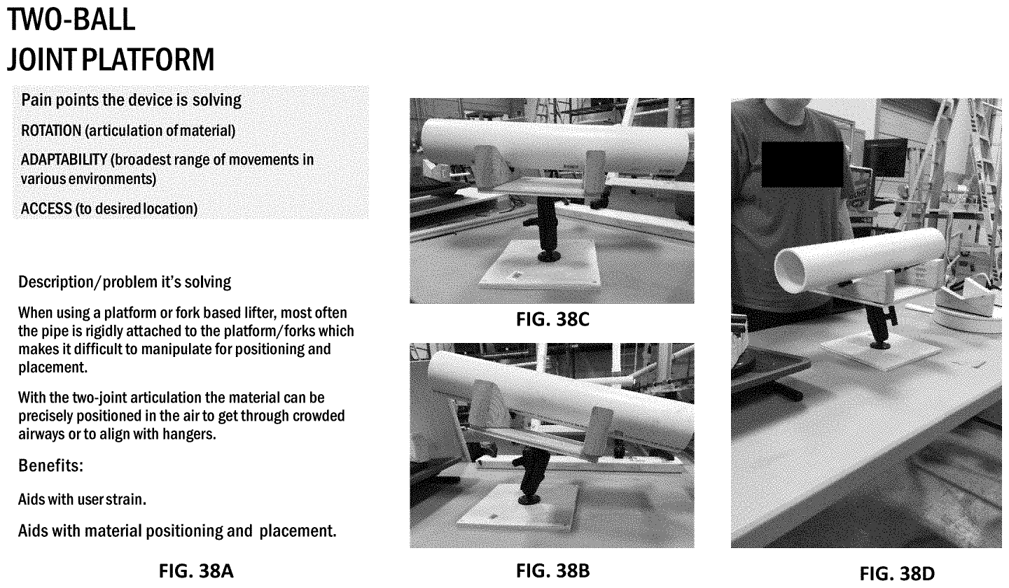

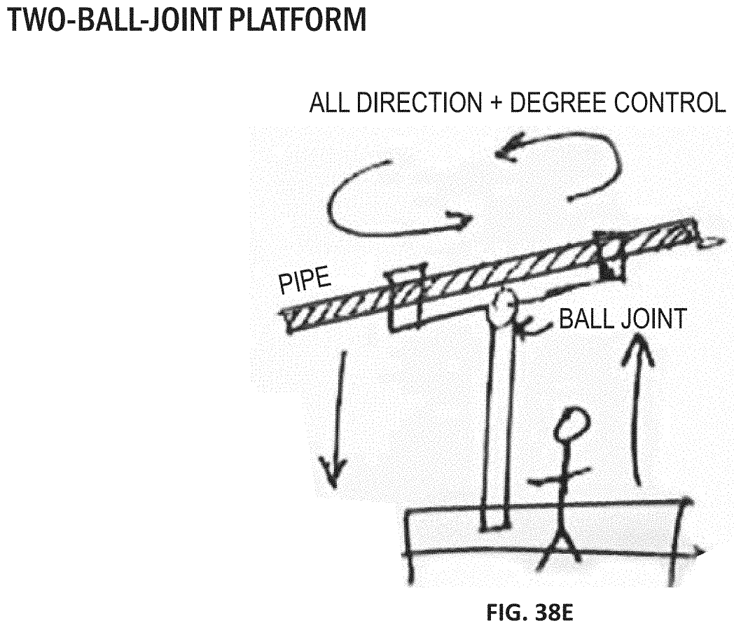

FIGS. 38A-38E illustrate a two-ball-joint platform for use with a platform or fork based lifter. The two-ball-joint platform allows for two-joint articulation of a lift material to precisely position the lift material in the air to navigate through crowded airways or to align with hangers.

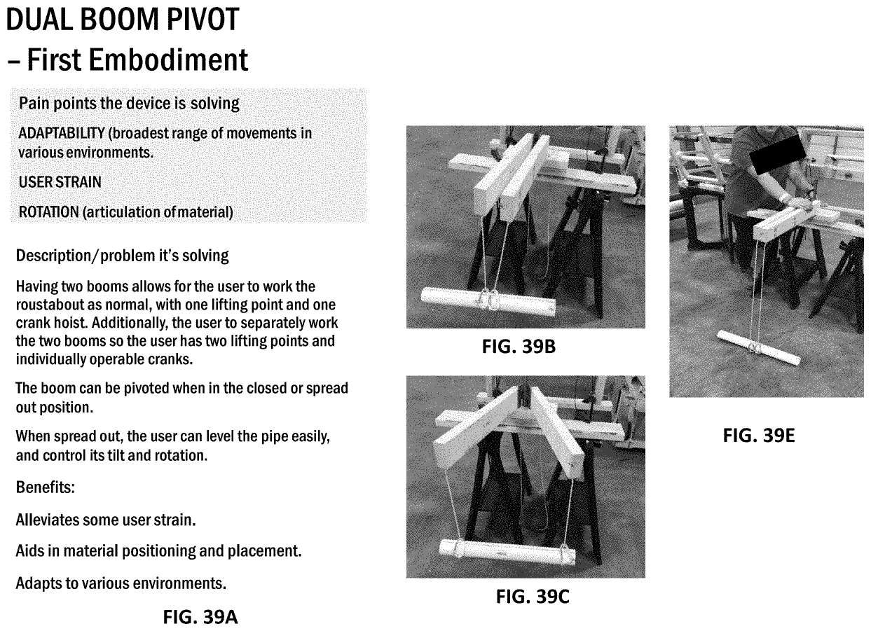

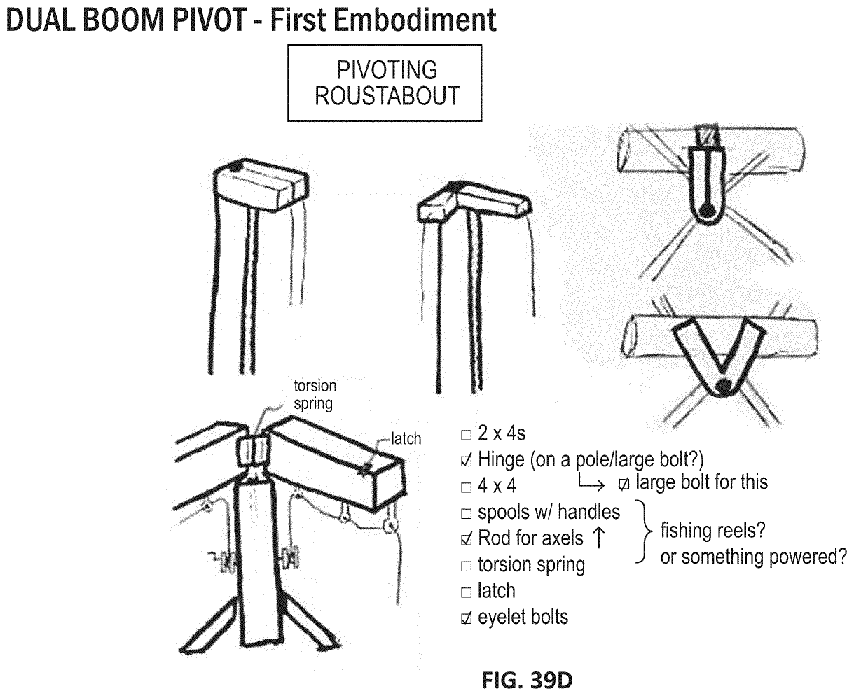

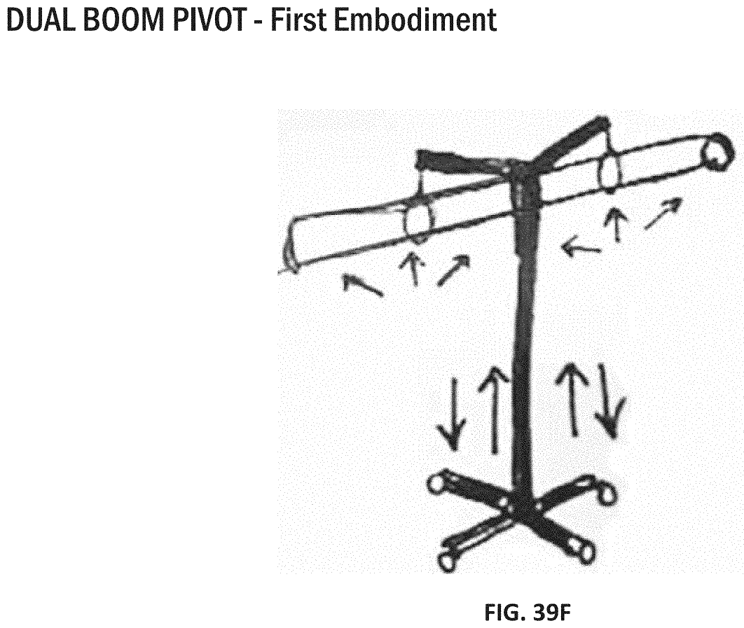

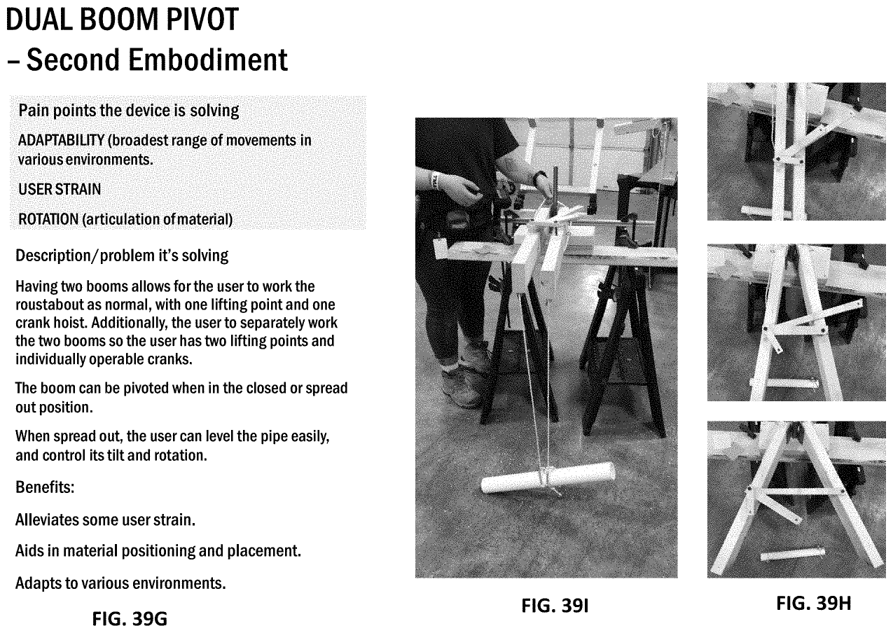

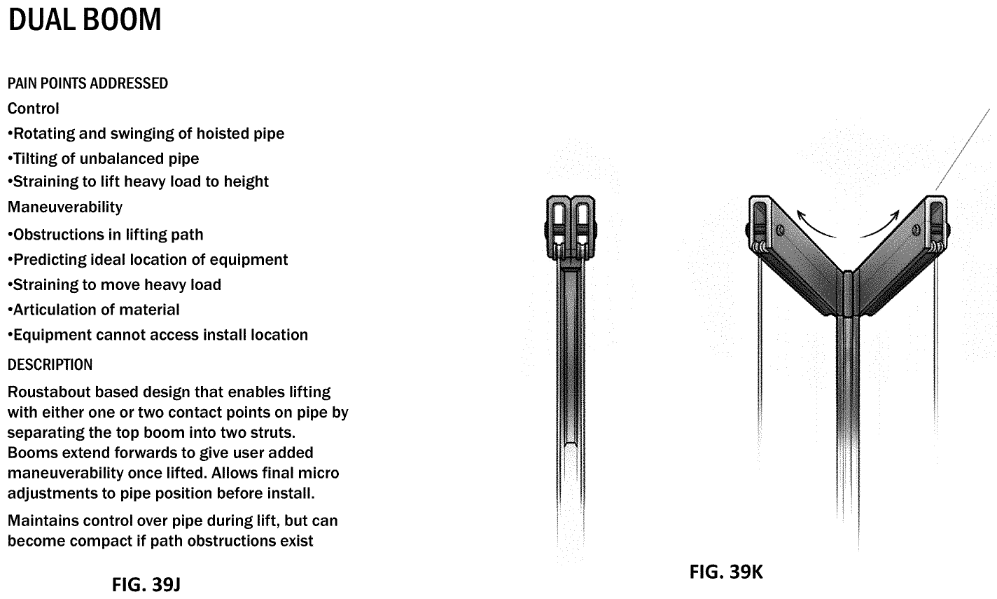

FIGS. 39A-39K illustrate several embodiments of a dual boom pivot system including two booms, a first boom acting as one lifting point, and another boom acting as a crank hoist. In some embodiments, the user can utilize both booms as either two lifts, or two cranks. In other embodiments, the boom system can be pivoted between an open and closed position. The dual boom includes a first boom and a second boom coupled to a vertical support beam of a roustabout device. The first and second boom may pivot relative to the vertical support. As a result, the dual boom enables lifting with either one contact point on the pipe (e.g., when the first and second booms are together) or two contact points on the pipe (e.g., when the first and second boom are separated).

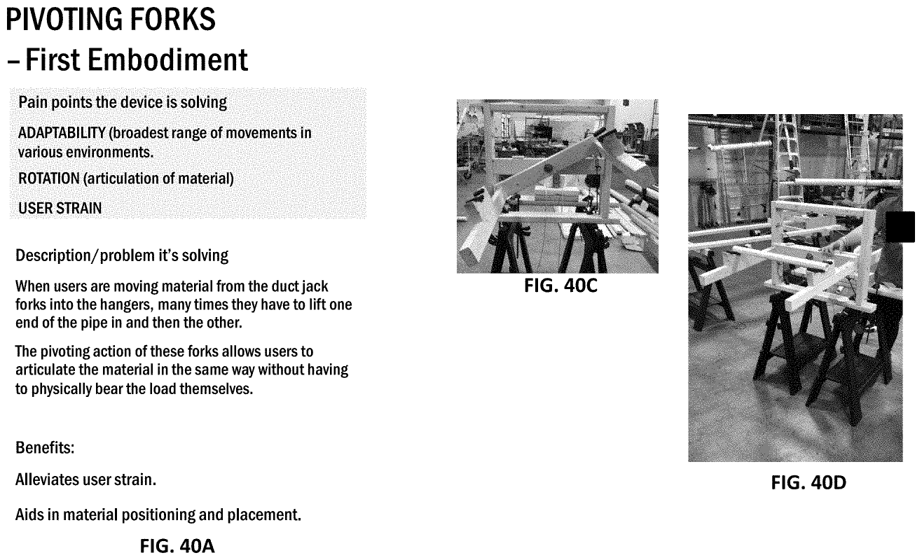

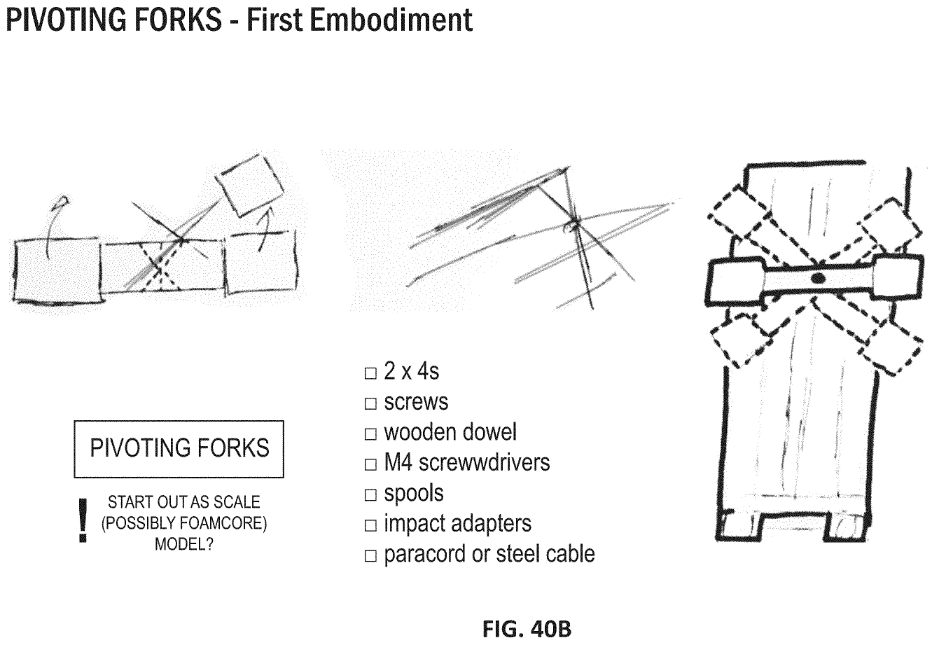

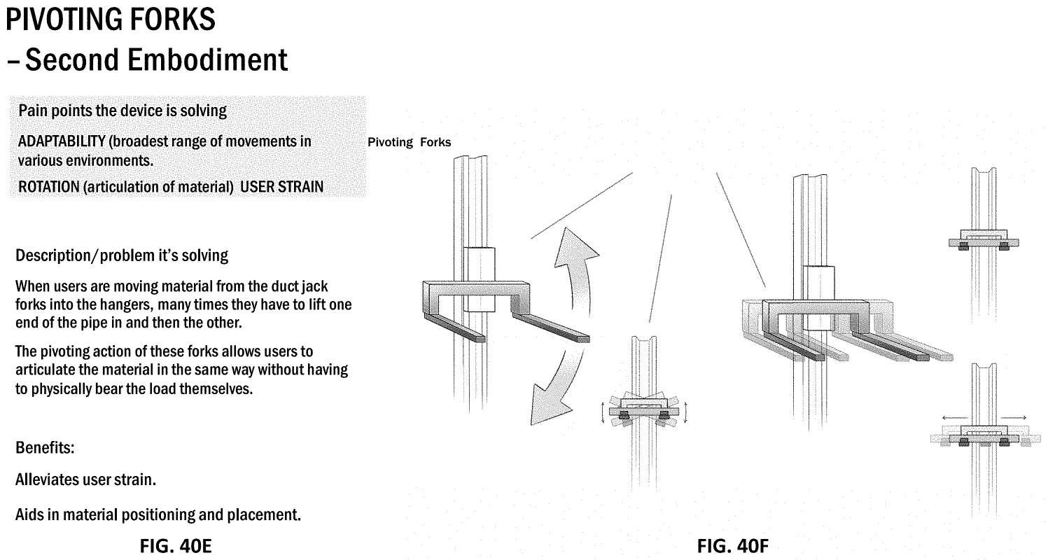

FIGS. 40A-40F illustrate several embodiments of pivoting forks for use with a lift system, allowing a user to pivot a plurality of forks to articulate a material/load without having to physically bear the load themselves. The lifting mechanism may including a connection portion (e.g., a slider) that connects to a support beam and pivoting forks connected to the connection portion. As a result, the lifting mechanism may both translate and pivot so the user may maneuver a pipe into a desired position (e.g., hangers) while the pipe is being supported rigidly from underneath.

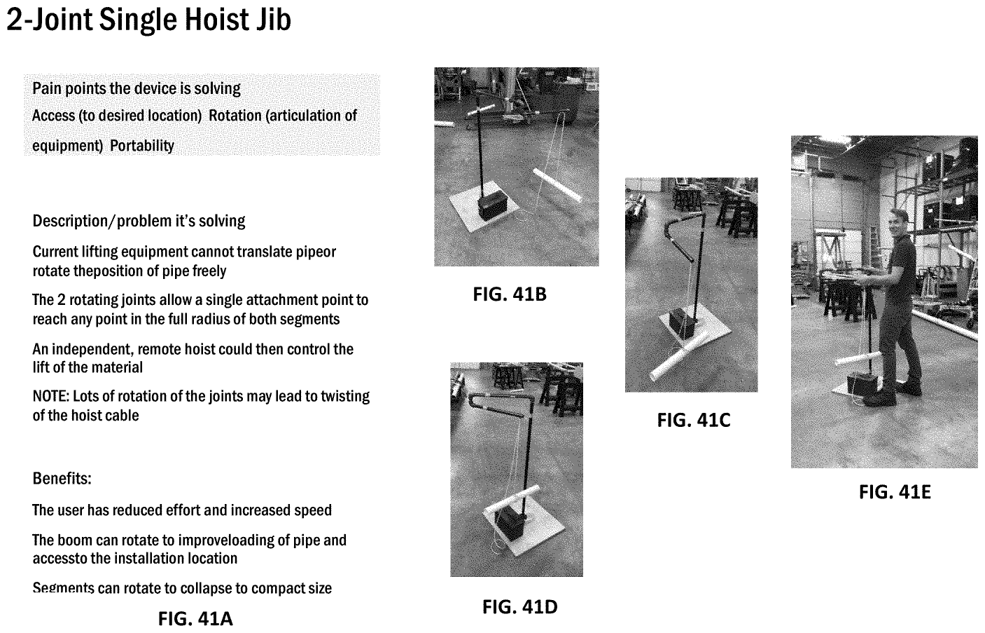

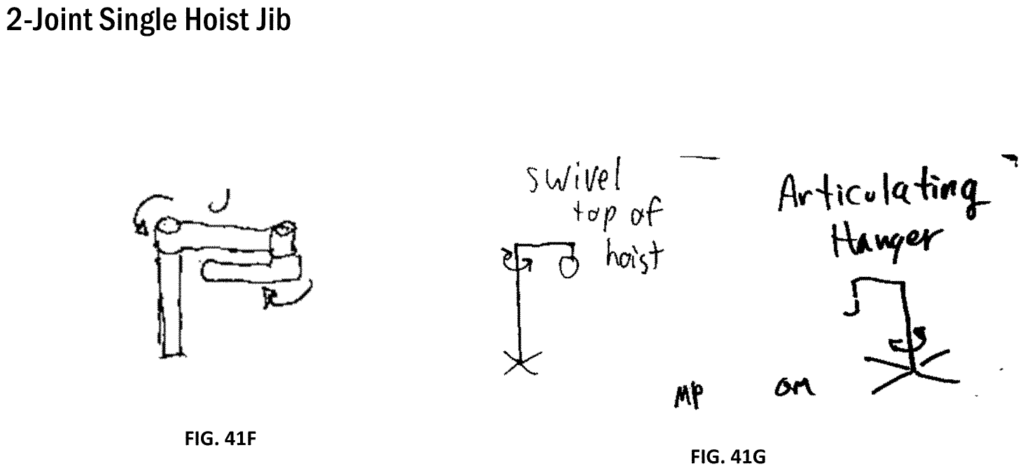

FIGS. 41A-41G illustrate a 2-joint single hoist jib including a plurality of joint segments connected by a single attachment point configured to reach any point within the full radius of both joint segments. In some embodiments, an independent remote hoist could control the hoist jib system, and subsequently a load.

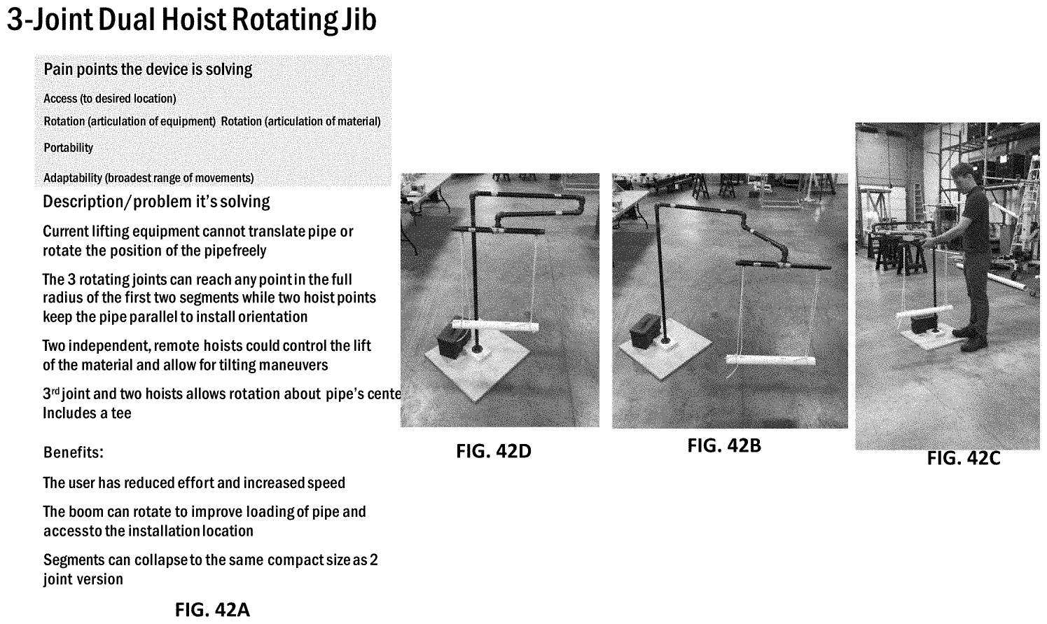

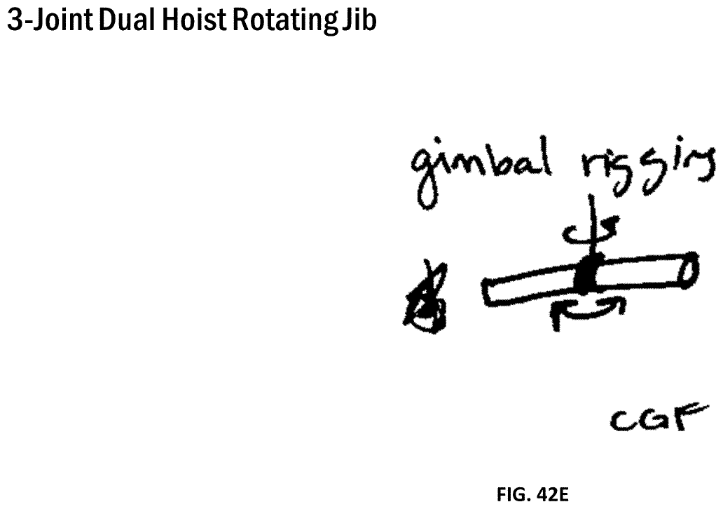

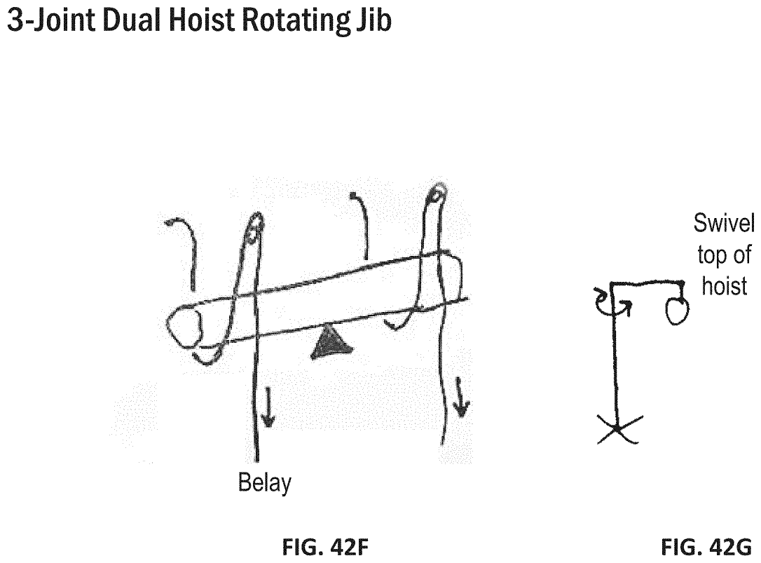

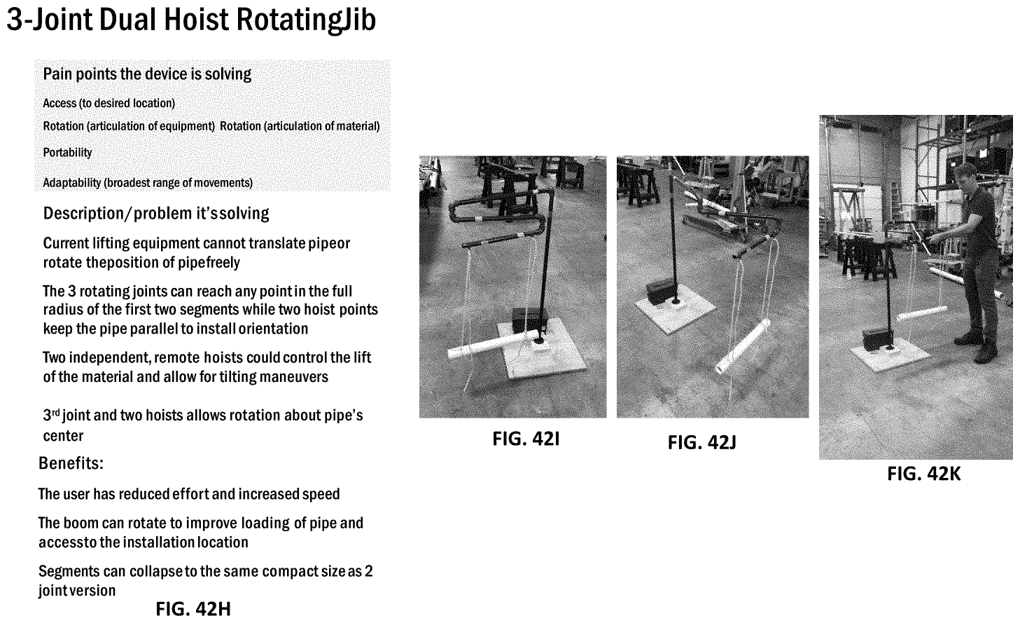

FIGS. 42A-42K illustrate several embodiments of a 3-point dual hoist rotating jib system including a plurality of joint segments having two hoist points to keep a load parallel. In some embodiments, two independent, remote hoists could control the lift of a material and allow for tilting maneuvers. In other embodiments, the third joint and two hoists allow rotation about the material's center.

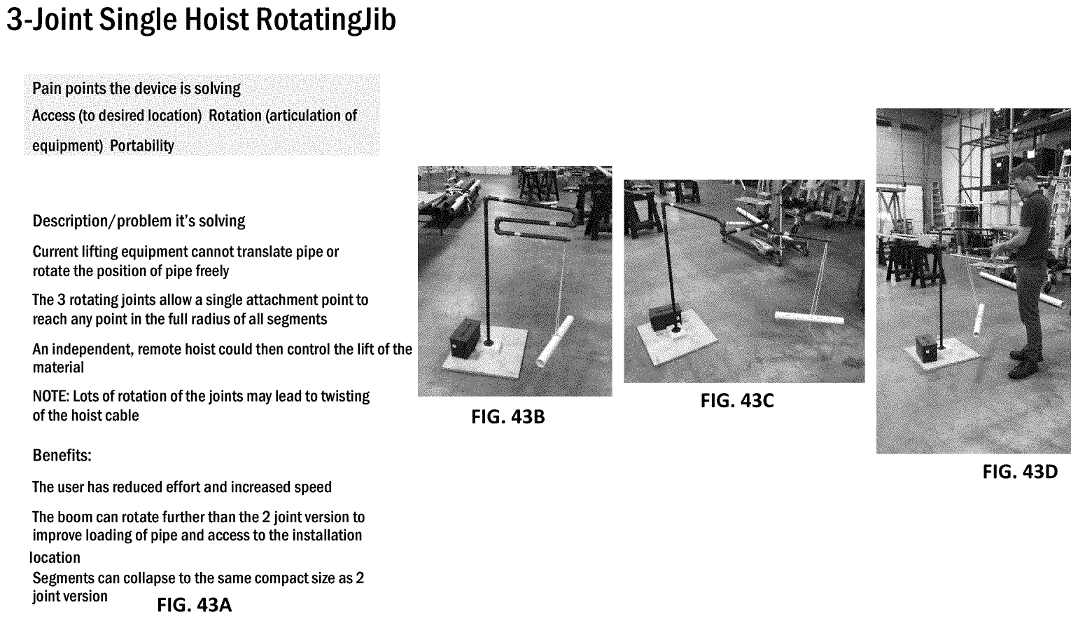

FIGS. 43A-43D illustrate a 3-joint single hoist rotating jib including a plurality of joint segments having a single attachment point configured to reach any point in the full radius of all the plurality of segments. In some embodiments, an independent, remote hoist could control the lift of a load/material.

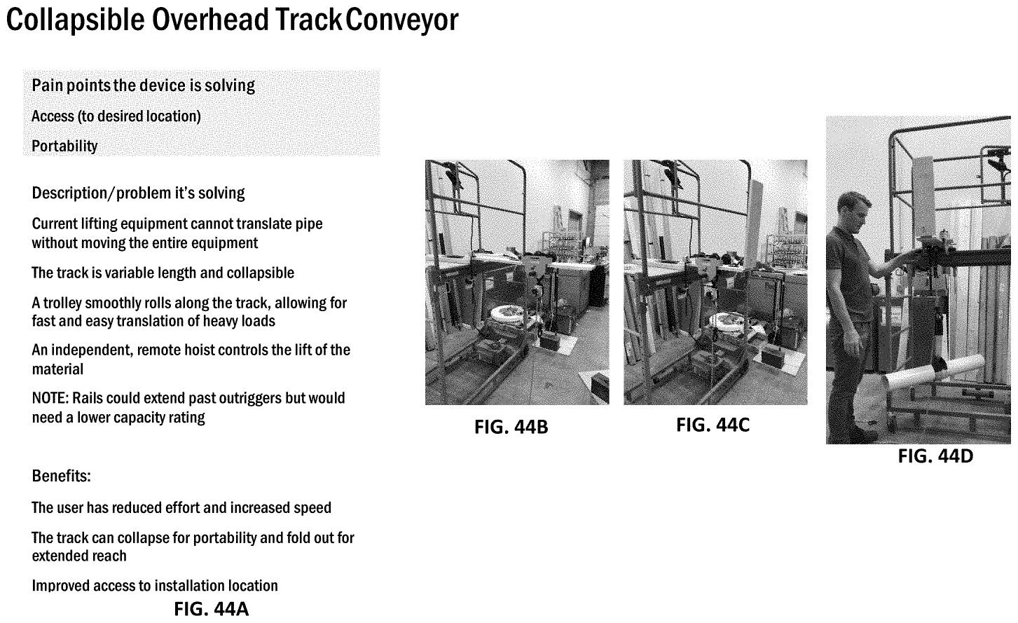

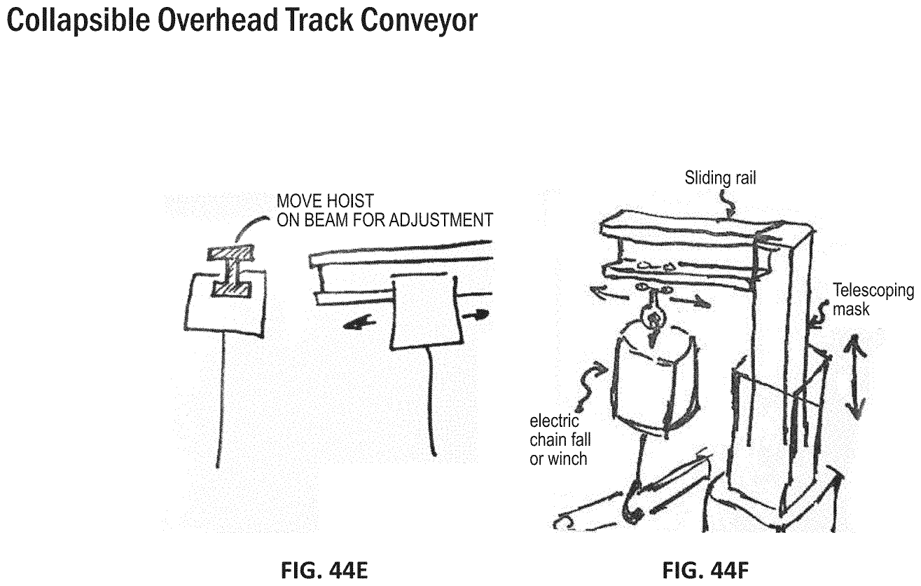

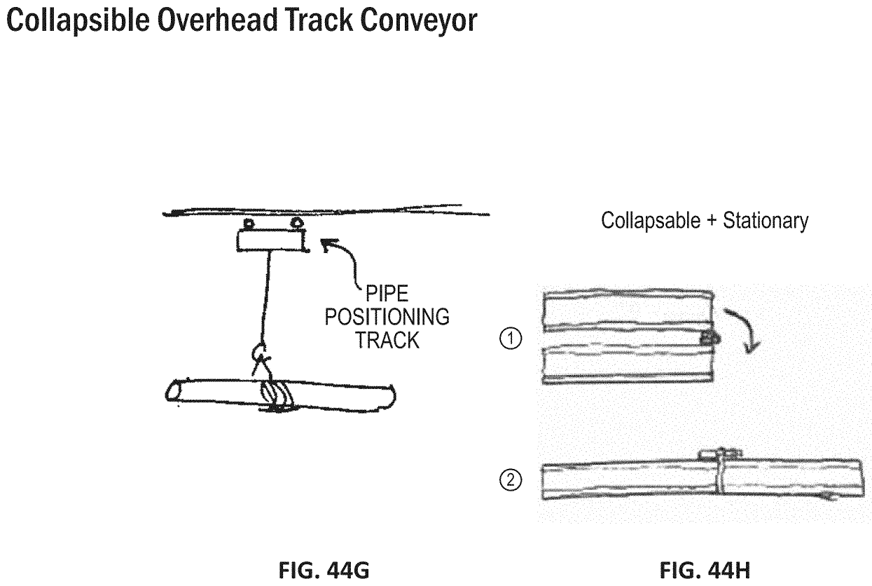

FIGS. 44A-44H illustrate a collapsible overhead track conveyor device including a track, a trolley configured to smoothly roll along the track, and an independent, remote hoist configured to control the lift of a material.

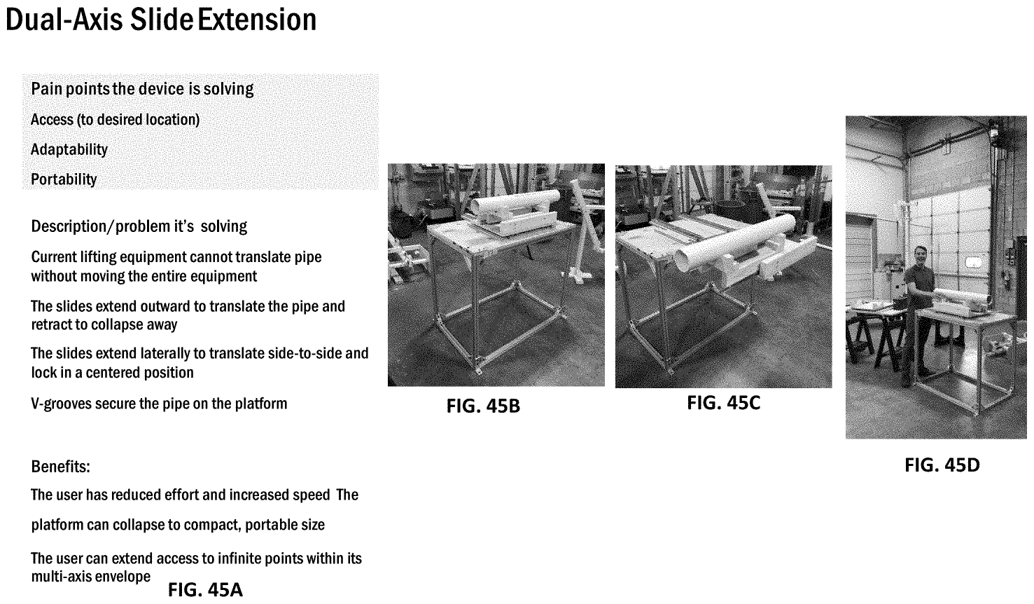

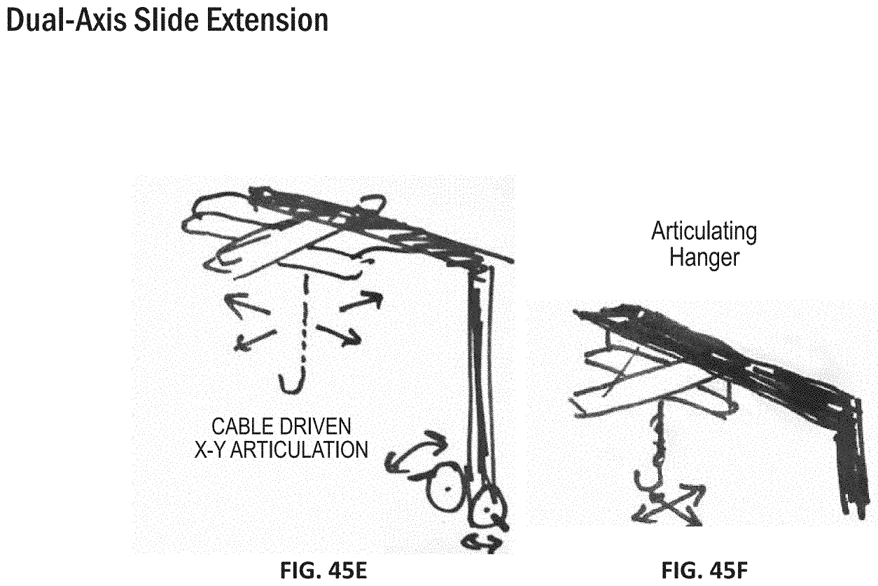

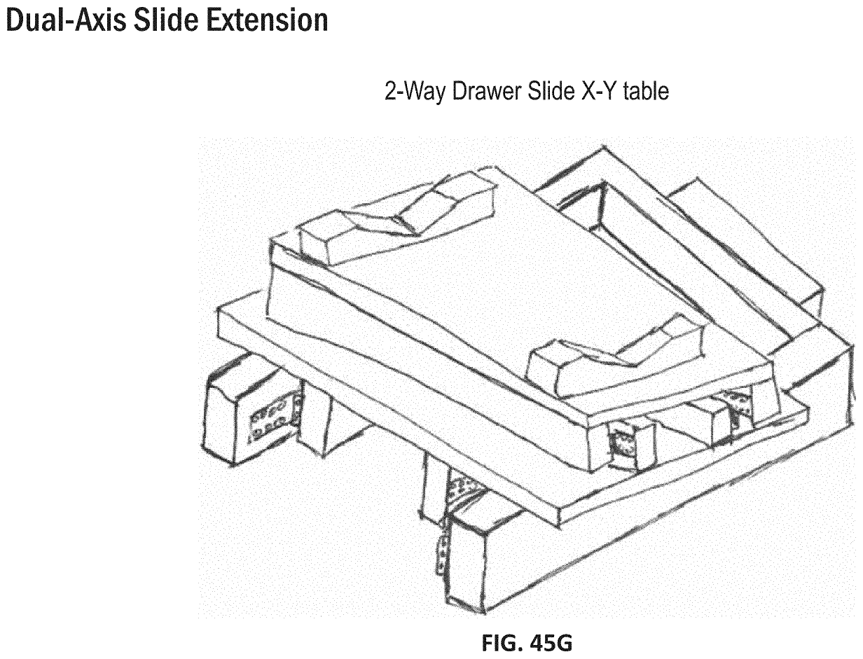

FIGS. 45A-45G illustrate a dual-axis slide extension device including a plurality of slides extending outward to translate a lift material, and a plurality v-grooves supported on the slides to secure the lift material. In some embodiments, the slides can retract and collapse away. In other embodiments, the slides can translate side-to-side and lock in a centered position.

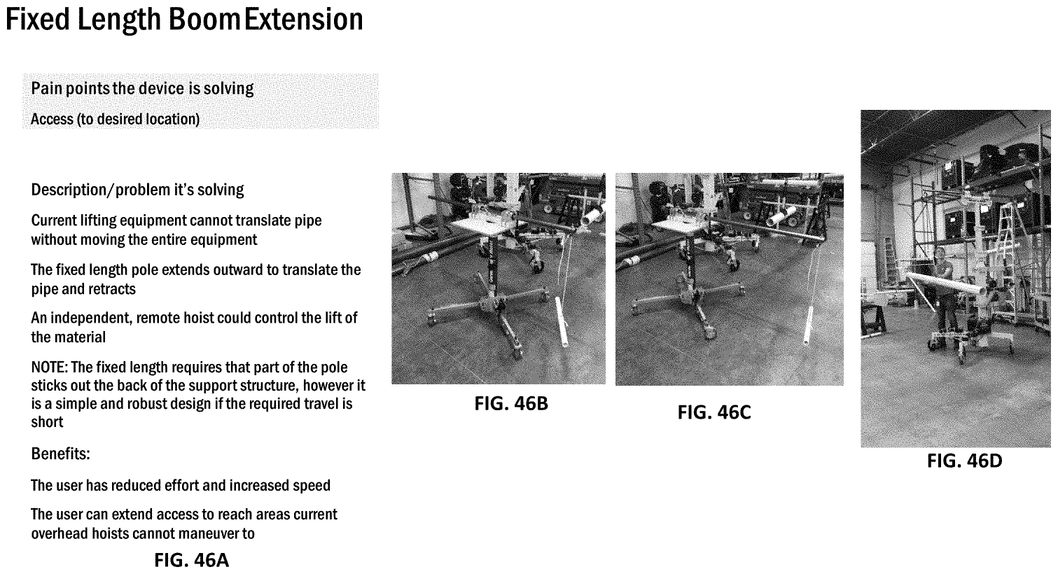

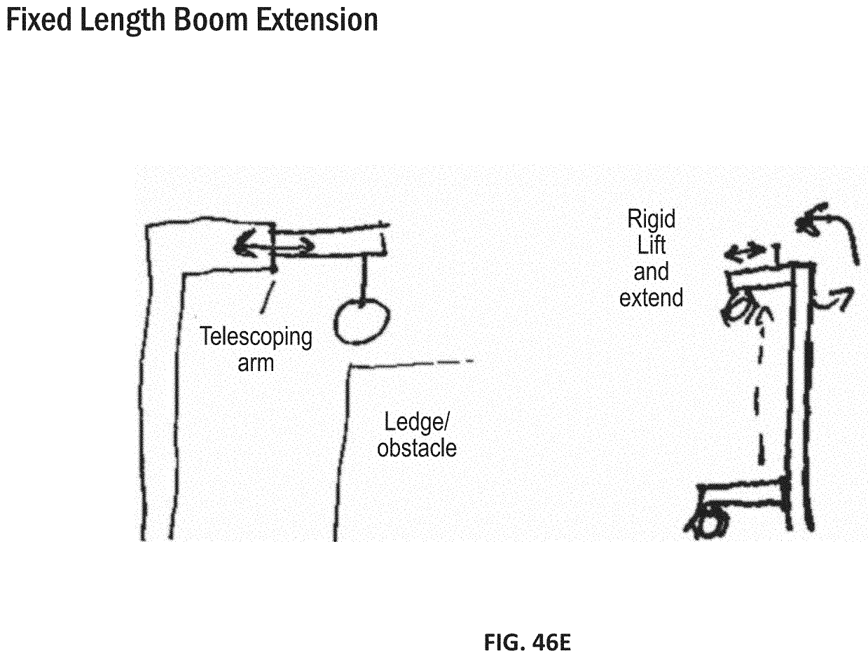

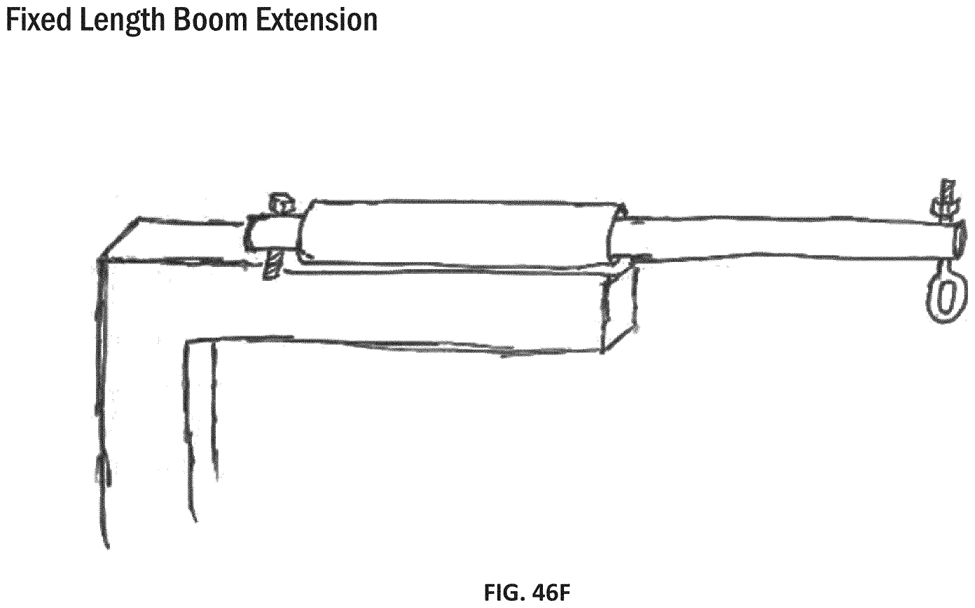

FIGS. 46A-46F illustrate a fixed length boom extension device including a support structure, a pole extending outward from the support structure configured to translate a lift material. In some embodiments, the pole can retract. In other embodiments, an independent, remote hoist could control the lift of the material.

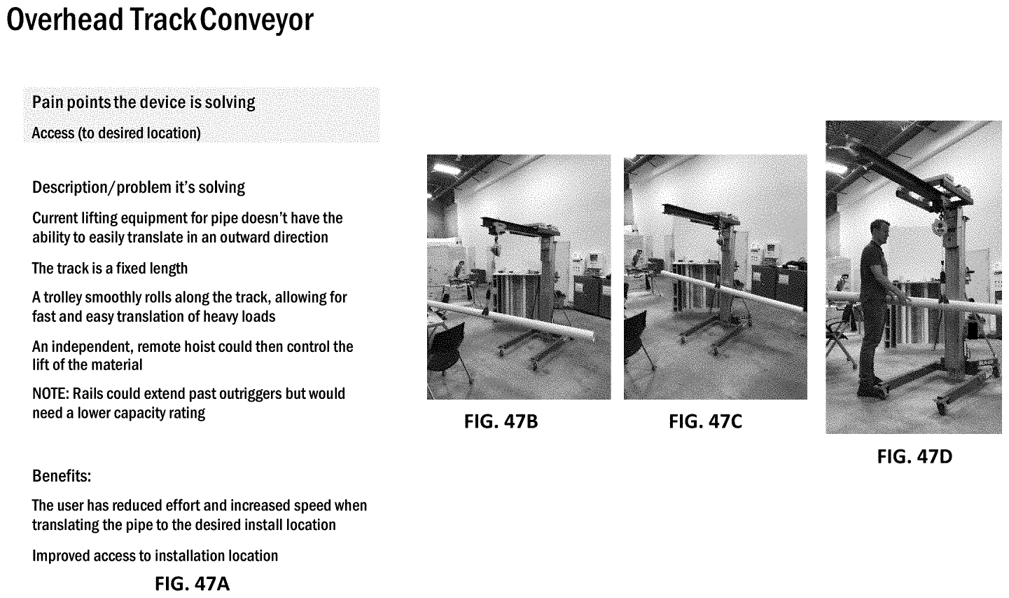

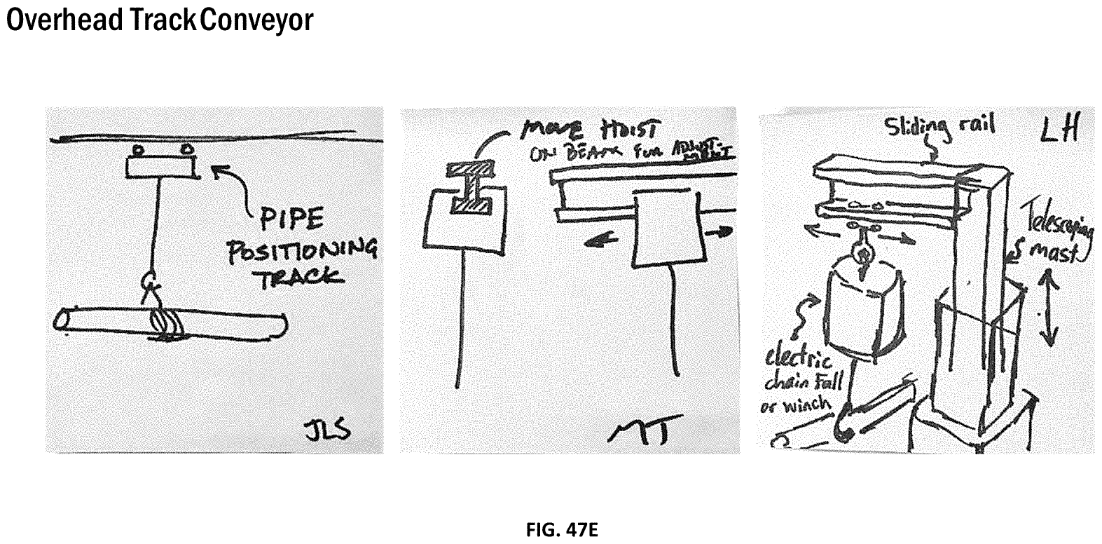

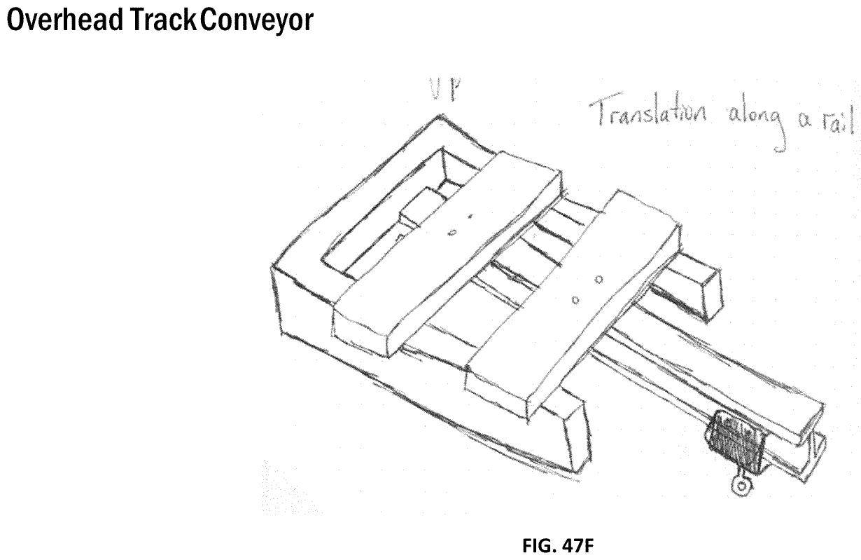

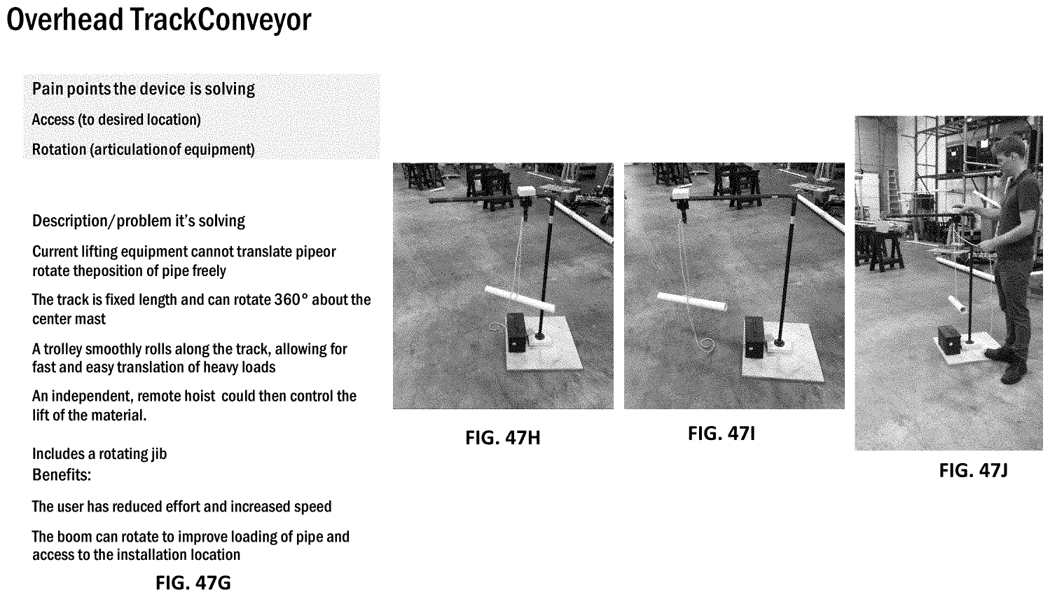

FIGS. 47A-47J illustrate several embodiments of an overhead track conveyor system including a track having a fixed length, a trolley configured to smoothly roll along the track, and an independent, remote hoist for controlling a lift of a lift material. In some embodiments, the track can rotate 360 degrees around a center mast.

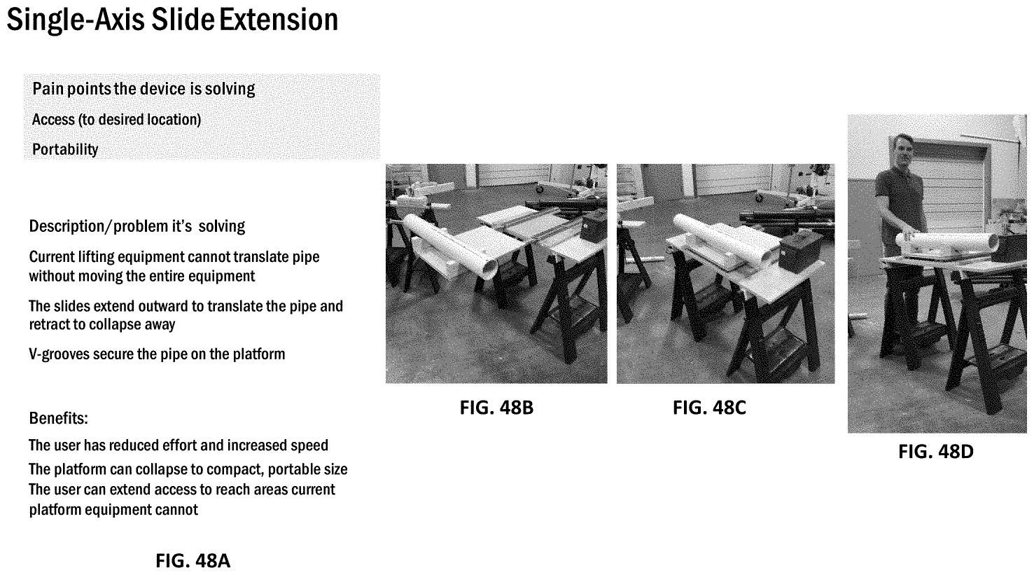

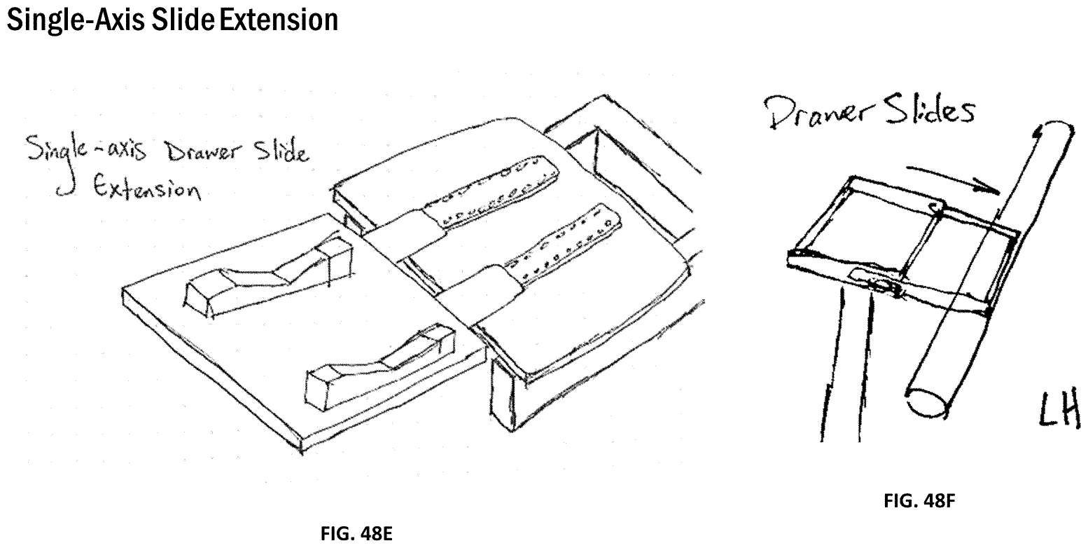

FIGS. 48A-48F illustrate a single-axis slide extension system including a support body having a plurality of tracks, and a platform supported on the tracks for holding a lift material having a plurality of slides configured to translate/retract the platform along the tracks.

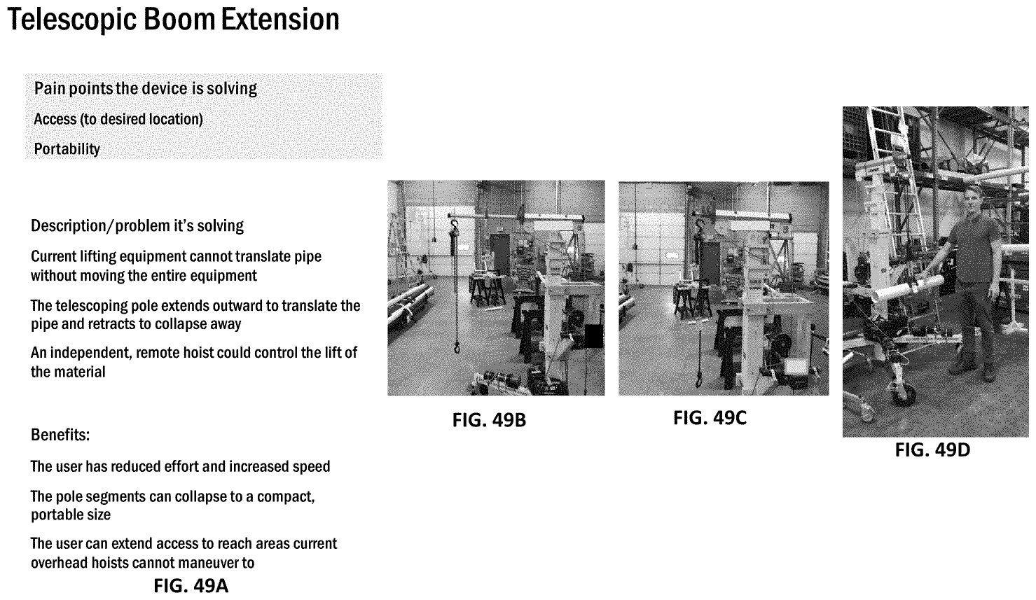

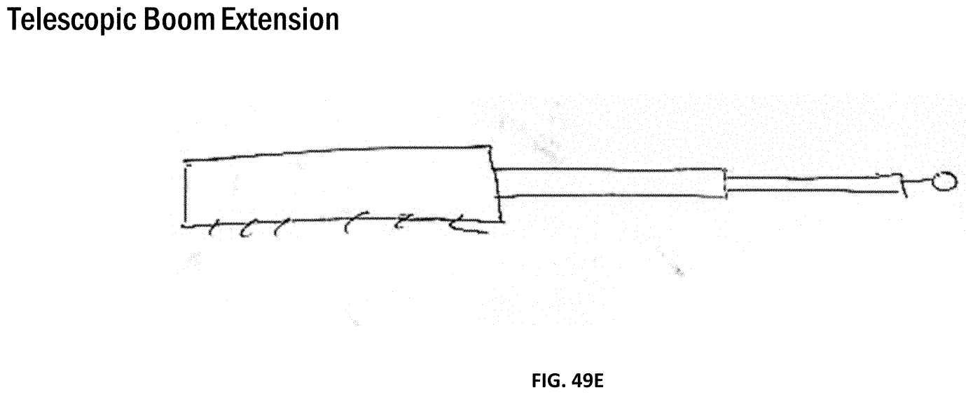

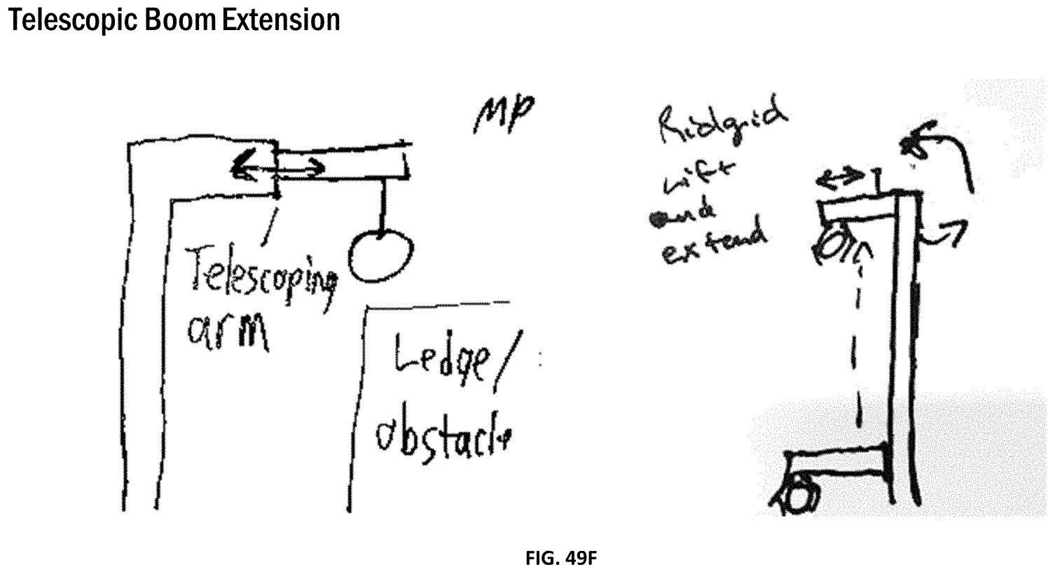

FIGS. 49A-49F illustrate a telescopic boom extension apparatus including an independent, remote hoist having a platform, and a lift device mounted on the platform having a telescoping pole extending outward from the lift device. The telescoping pole is configured to support a lift material and translate the lift material as the pole extends and retracts.

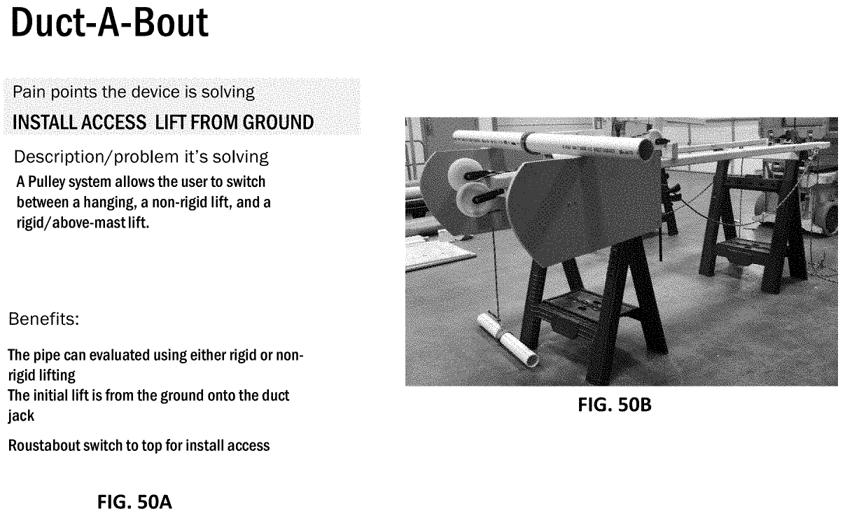

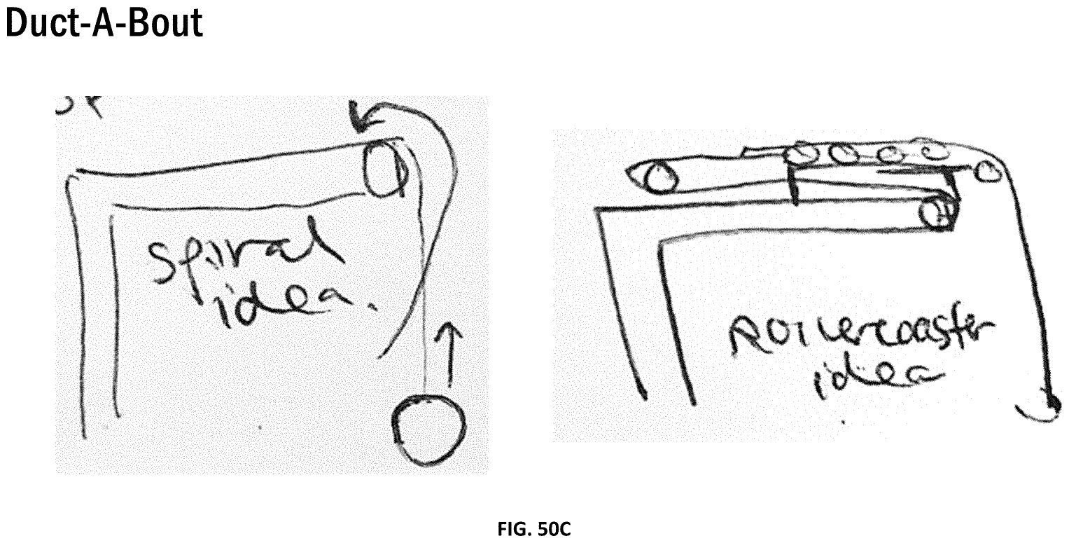

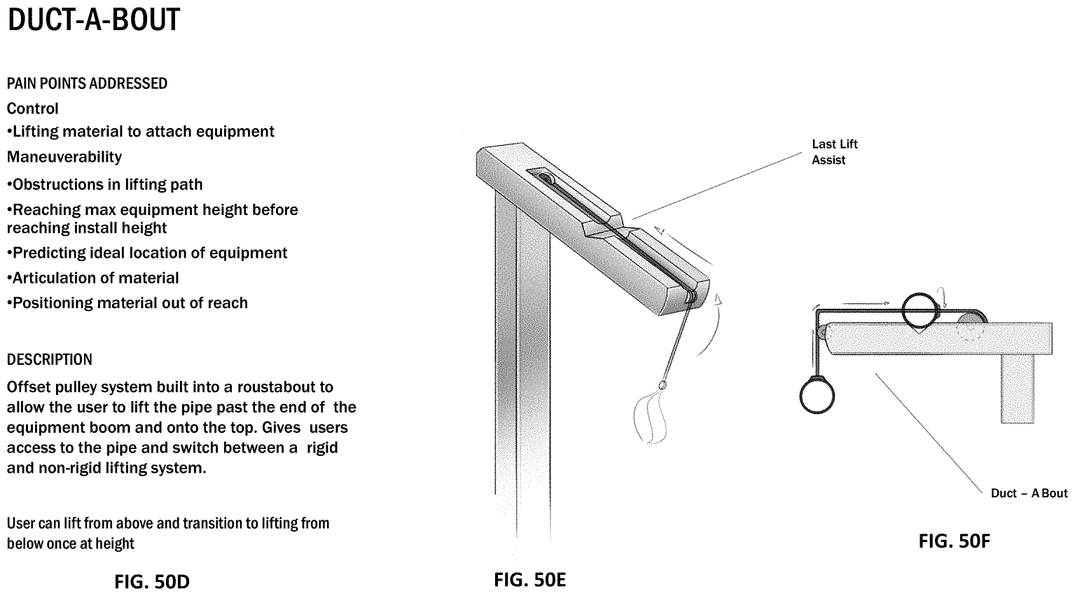

FIGS. 50A-50F illustrate a duct-a-bout device including an offset pulley system built into a roustabout to allow a user to lift a material/load past the end of an equipment boom and onto the top of the roustabout. The duct-a-about allows the user to access the material/load and switch between a rigid and a non-rigid lifting system. In some embodiments, the duct-a-about can include a cradle that constrains the material/load to prevent rotation. The duct-a-bout includes an offset pulley system built into a roustabout to allow the user to lift the pipe past the end of the equipment boom and onto the top of the roustabout. The duct-a-bout allows the user to access the pipe and switch between a rigid and non-rigid lifting system. For example, the user may lift from a top portion of the pipe and transition to lifting from below the pipe when the pipe is at height on top of the duct-a-bout. In another embodiment, the duct-a-bout may include a cradle that constrains the pipe to prevent rotation.

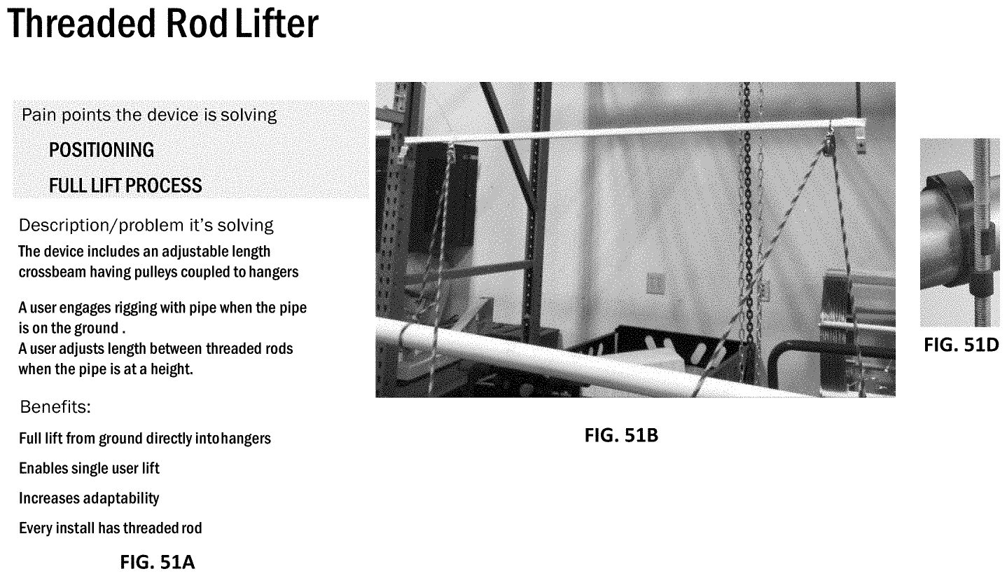

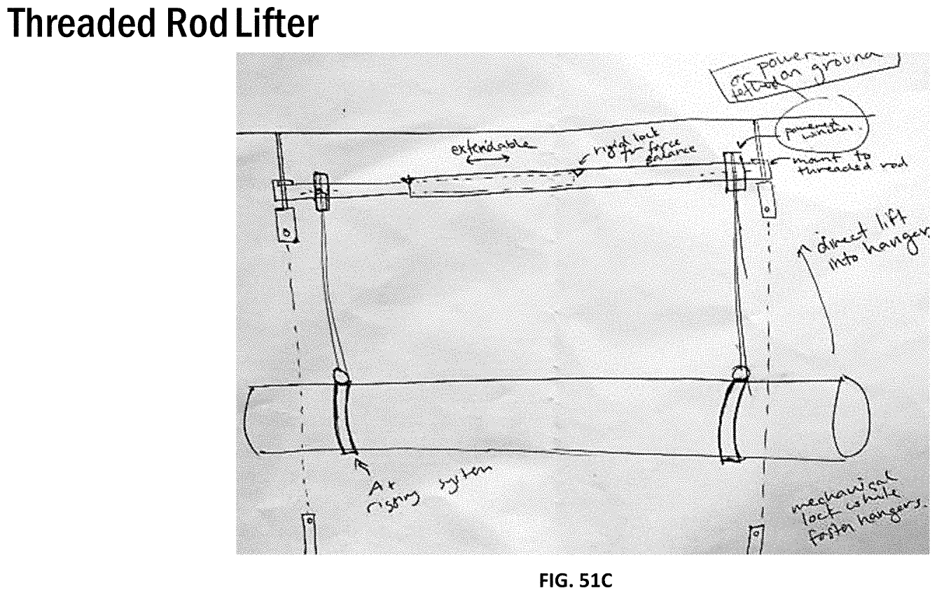

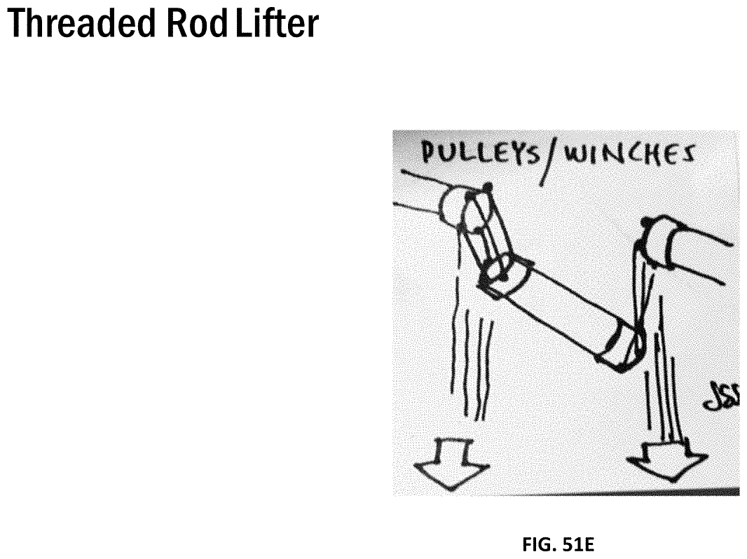

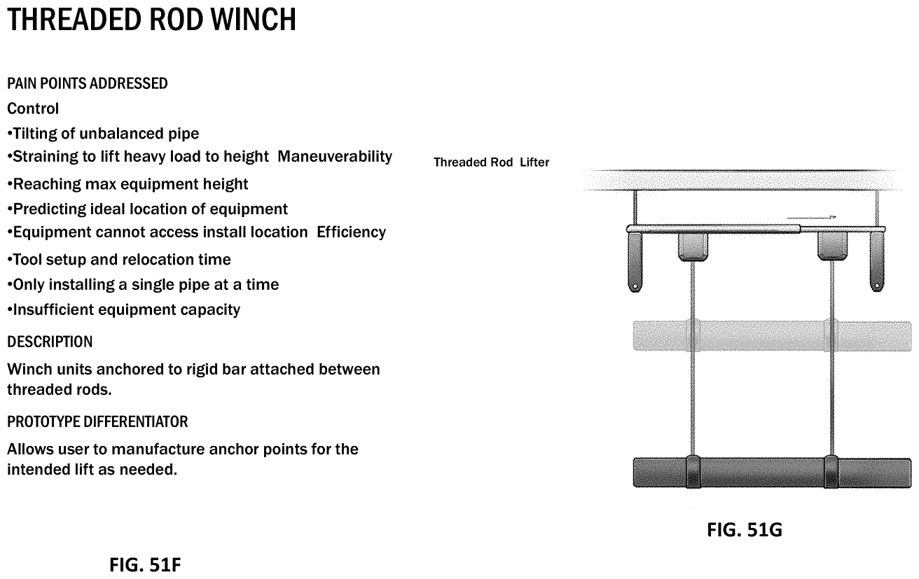

FIGS. 51A-51G illustrate a threaded rod lifter system including a plurality of winch units or hoists that are anchored to a rigid bar attached between threaded rods. The threaded rods allow a user to manufacture anchor points for an intended lift as needed. In some embodiments, an adjustable length crossbeam may be attached to the threaded rods. The crossbeam may include pulleys directly connected to hangers used to lift a lift material. The system may include a plurality of winch units or hoists that are anchored to a rigid bar attached between threaded rods. The threaded rods allows the user to manufacture anchor points for the intended lift as needed. In some embodiments, an adjustable length crossbeam may be attached to the threaded rods. The cross beam may include pulleys directly connected to hangers used to lift the pipe.

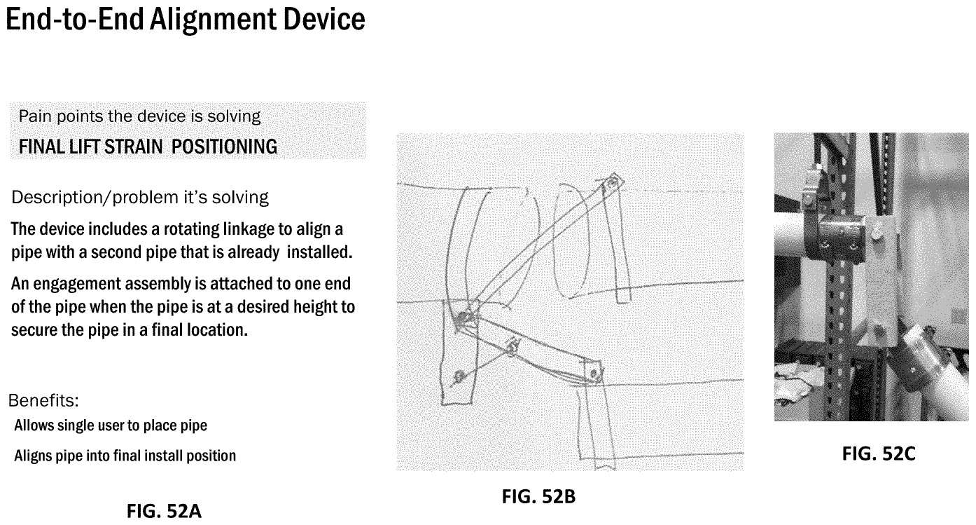

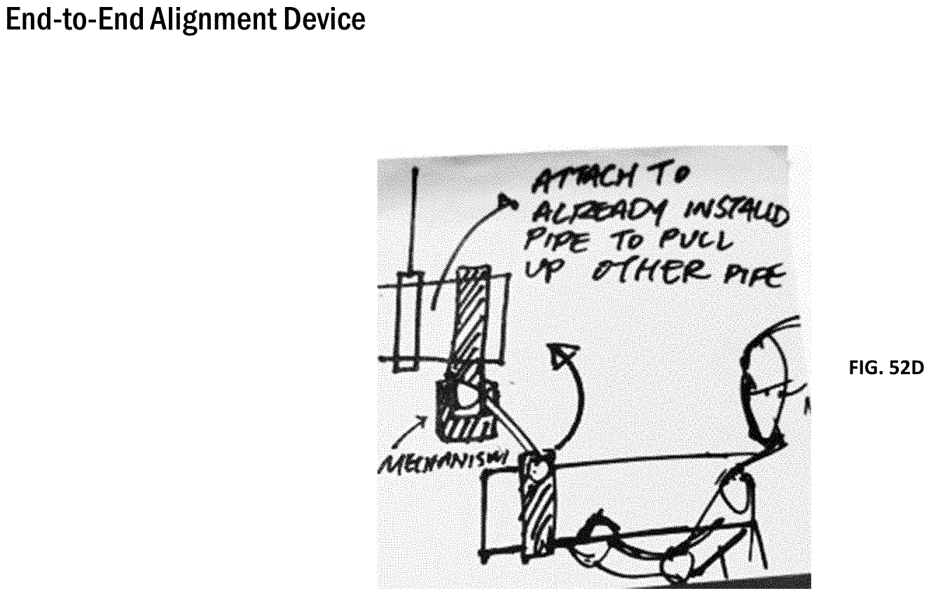

FIGS. 52A-52D illustrate an end-to-end alignment device including a rotating linkage for aligning a first load with a second load that is already being lifted, and an engagement assembly configured to attach to one end of either of the loads at a desired height to aid in securing one of the loads in a final location.

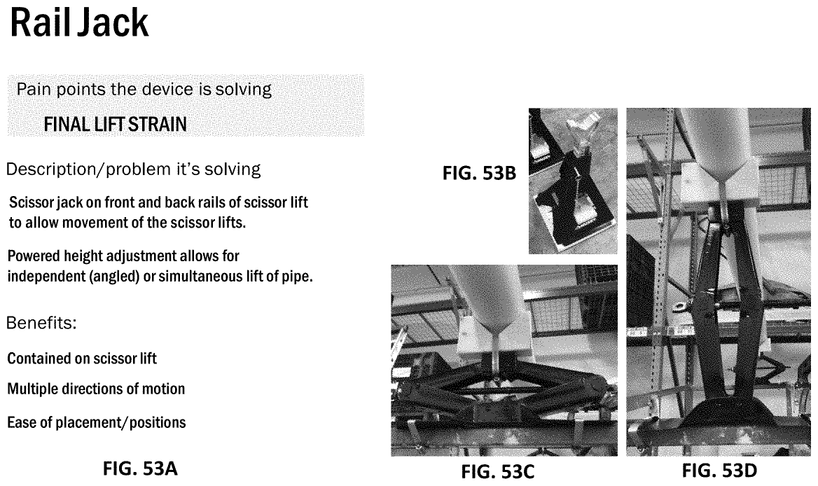

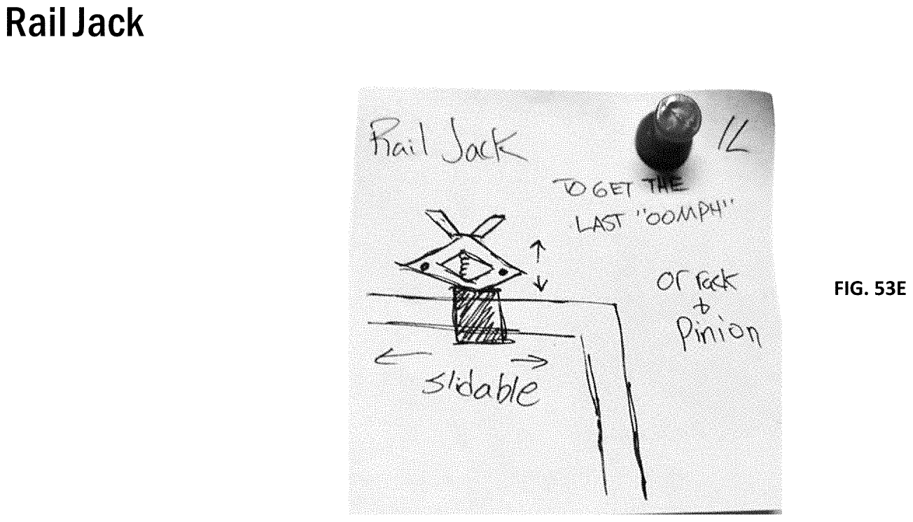

FIGS. 53A-53E illustrate a rail jack device including a scissor jack having a mounting part for holding a load allowing for powered height adjustment independent (angled) or simultaneous lift of a lift material. In some embodiments, the rail jack device can be mounted on a scissor lift.

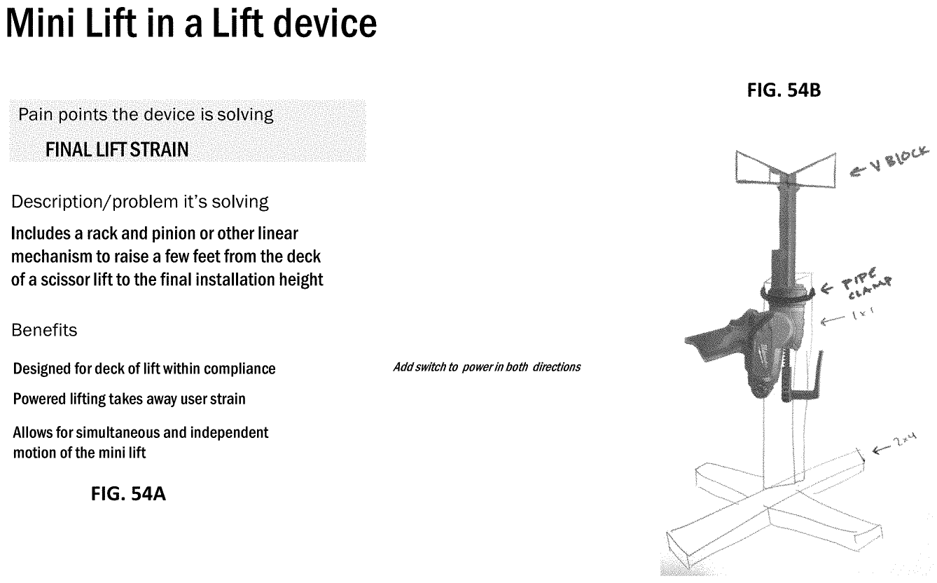

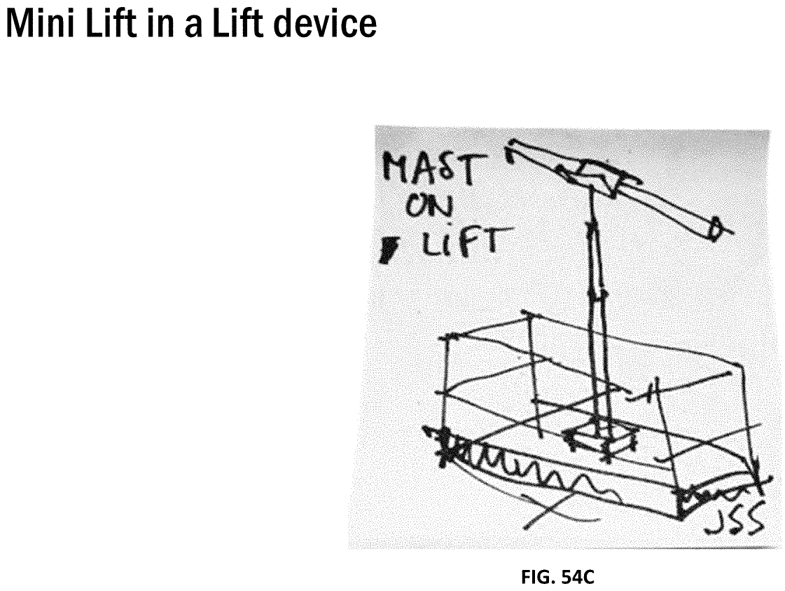

FIGS. 54A-54C illustrate a lift device including a mini lift mounted on the lift device within a lift cab. In some embodiments, the mini lift can be mounted on a scissor lift and include a rack and pinion (or other linear mechanism) configured to lift a load a distance to the final installation height of the load.

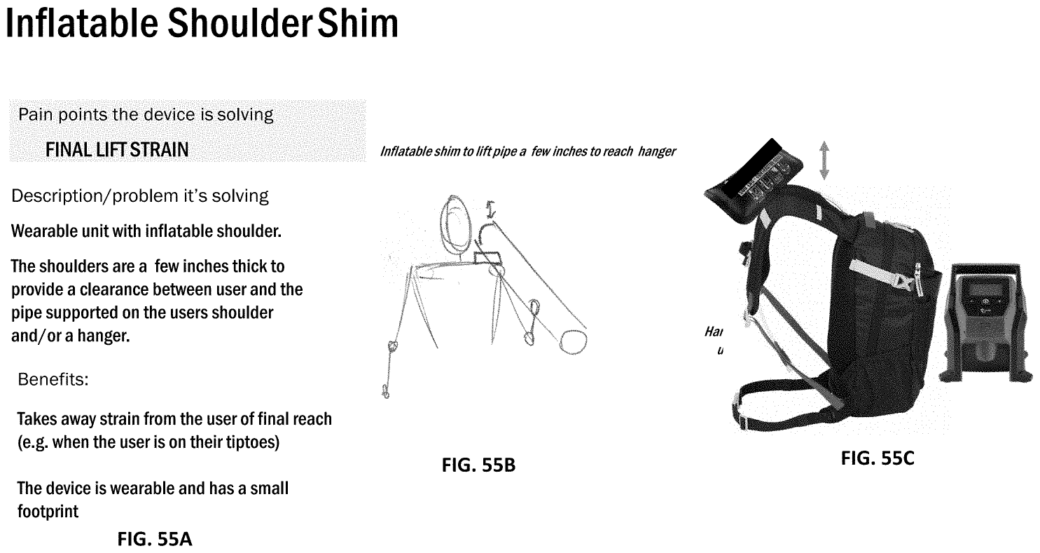

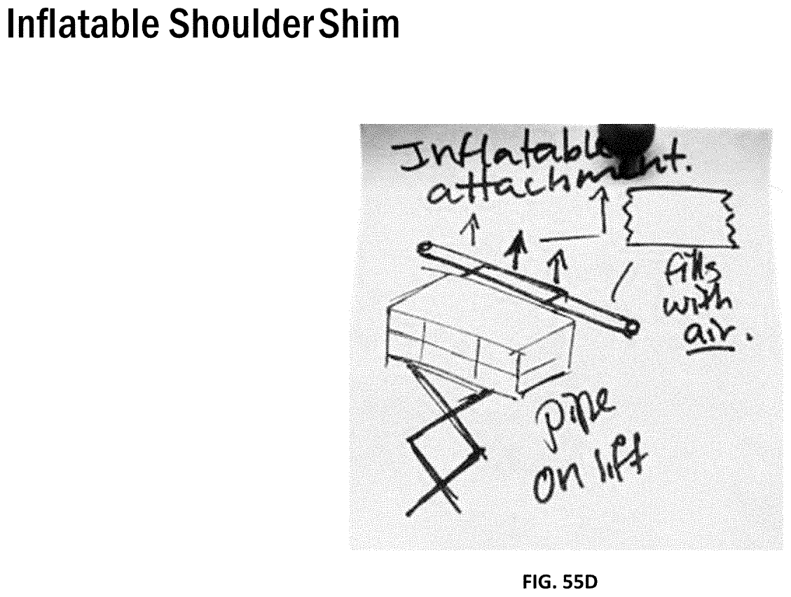

FIGS. 55A-55D illustrate an inflatable shoulder shim device configured to be worn by a user. In some embodiments, the shim device can support a load and inflate with air to help lift the load a distance to a hanger.

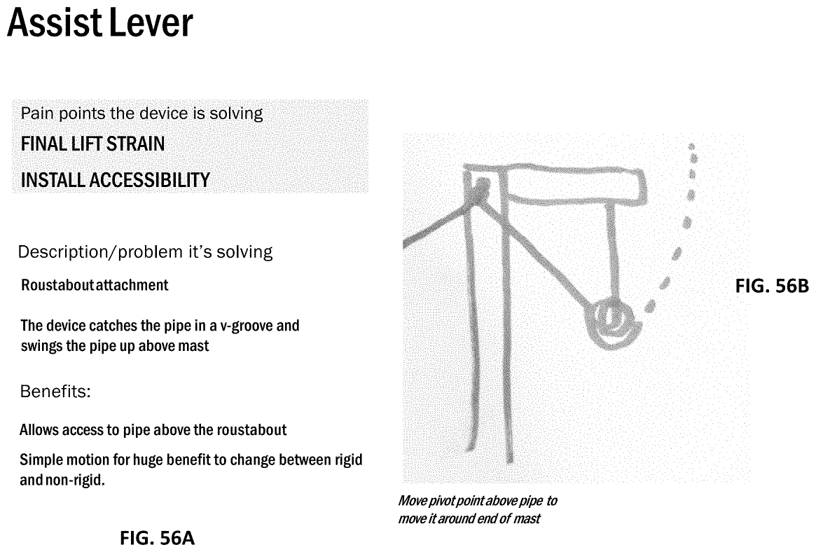

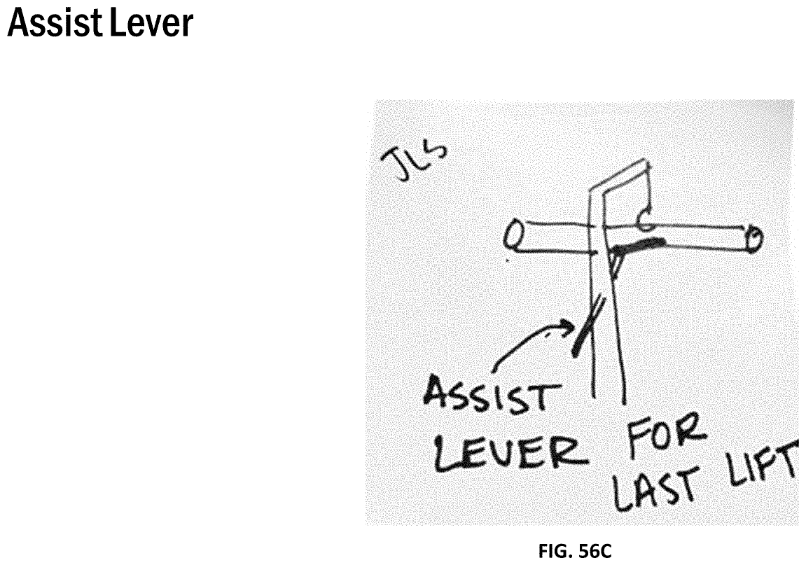

FIGS. 56A-56C illustrate an assist lever device including a roustabout attachment, a v-groove for catching a load, and an assist lever for swinging a load up about a mast of the roustabout.

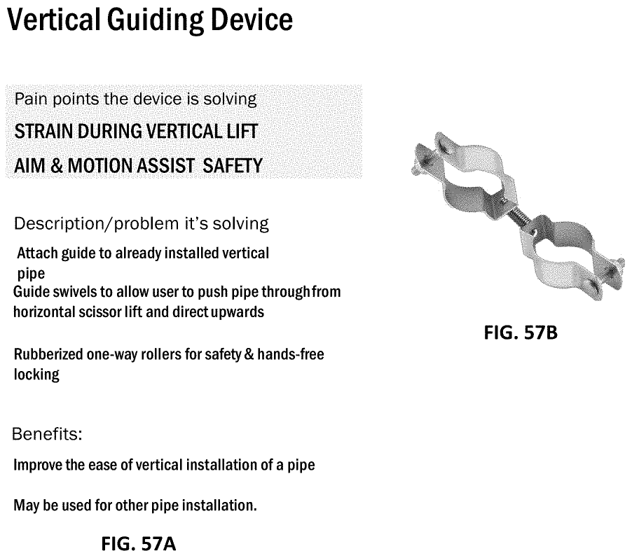

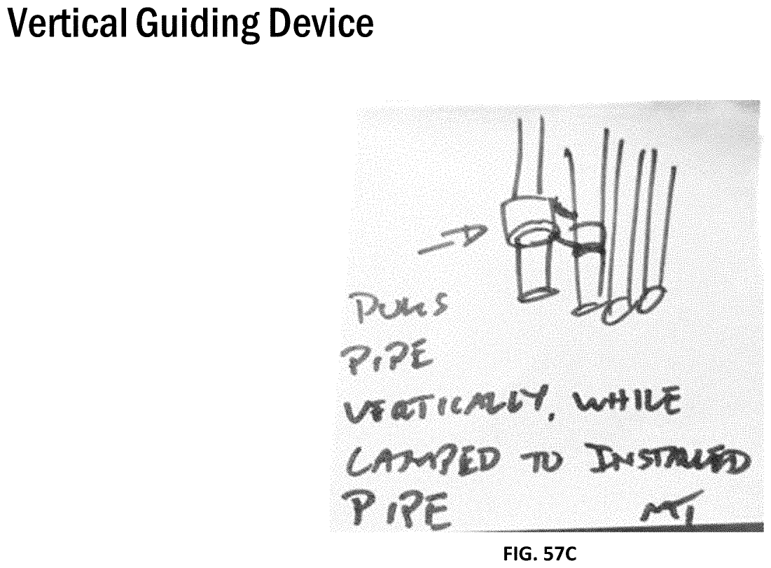

FIGS. 57A-57C illustrate a vertical guiding device configured to attach to an already installed lift material including a plurality of guide swivels to allow a user to push the lift material through from a horizontal scissor lift, and a plurality of rubberized one-way rollers for safety and hands-free locking of the device with the lift material.

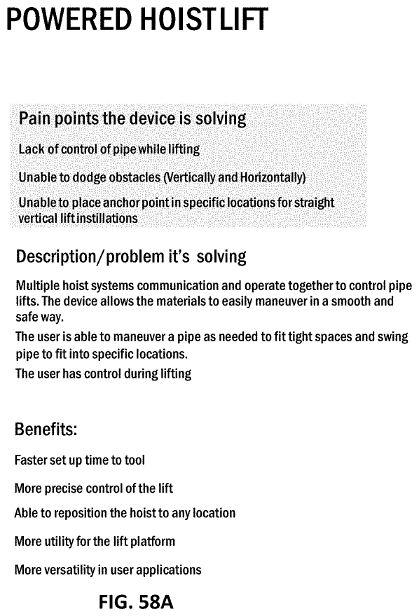

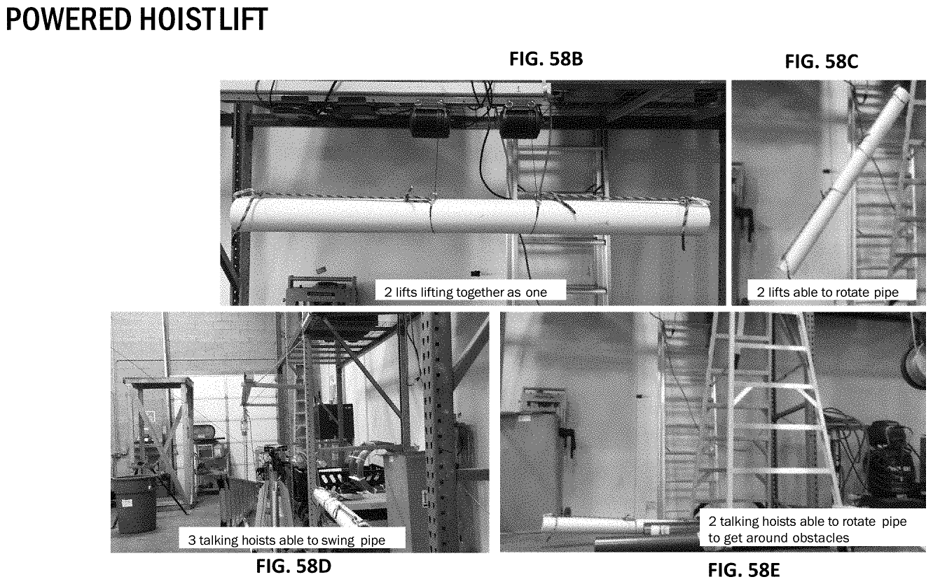

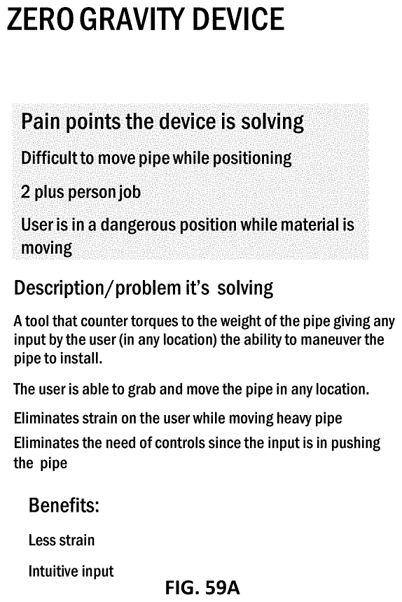

FIGS. 58A-58E illustrate a powered lift hoist system including a plurality of hoist systems all communicating and operating together in order to control a lift. The system allows lift materials to easily maneuver in a smooth and safe fashion. Additionally, the system allows the user to have control during lifting to maneuver the lift to fit tight spaces or swing into specific locations.

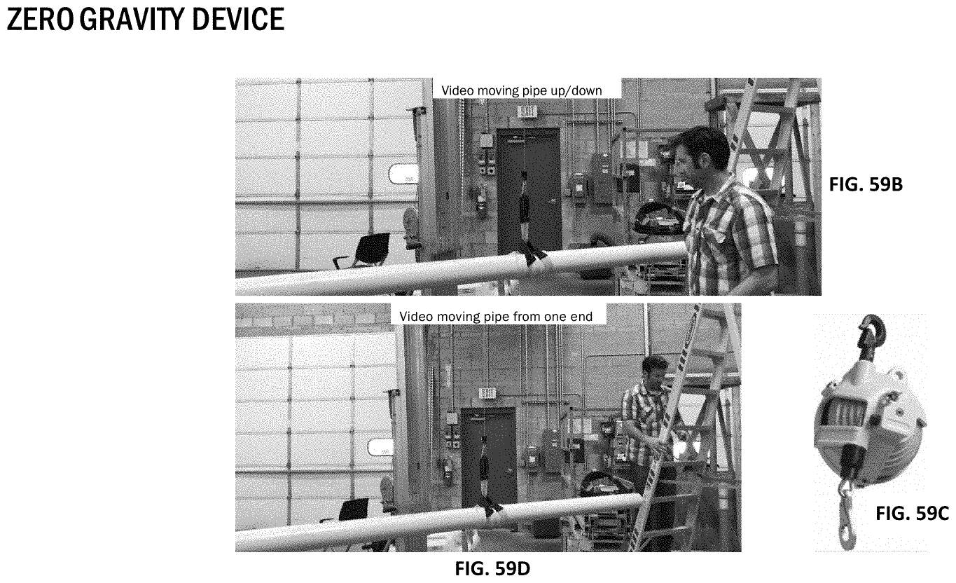

FIGS. 59A-59D illustrate a zero-gravity device including a cable and a securing device that is adjustable to secure a load to the securing device. The zero-gravity device counters the torques applied to the load so a user can move the load from any location. The zero-gravity device significantly reduces the user's input while positioning and placing the load. In some embodiments, the zero-gravity device can be used with a support platform that includes a base with wheels, a vertical support post, a telescopic boom extension extending transversely from the support beam, and a collapsible overhead track conveyor that supports the zero gravity device. The zero gravity hoist may include a cable and a securing device that is adjustable to secure a pipe to the securing device. The zero gravity hoist counters the torques applied to the pipe so the user can move the pipe from any location. The zero gravity hoist significantly reduces user input while positioning and placing the pipe. The zero gravity hoist may be used with a support platform that includes a base with wheels, a vertical support post, a telescopic boom extension extending transversely from the support beam, and a collapsible overhead track conveyor that supports the zero gravity device. The boom can extend and retract to position the pipe supported by the zero gravity hoist in a desired position. In yet another embodiment, the zero gravity hoist may be used with a collapsible overhead track conveyor. The track conveyor allows the user to adjust the length of the track conveyor and collapse the track conveyor. In yet another embodiment, the zero gravity hoist may be used with a fixed length boom extension. The boom includes a fixed length pole supported within a mounting portion. The fixed length pole extends outward from the mounting portion and may translate or retract within the mounting portion to adjust the positioning of the zero gravity hoist. In yet another embodiment, the zero gravity hoist may be used with a telescopic boom extension that may expand and retract to adjust the positioning of the zero gravity hoist.

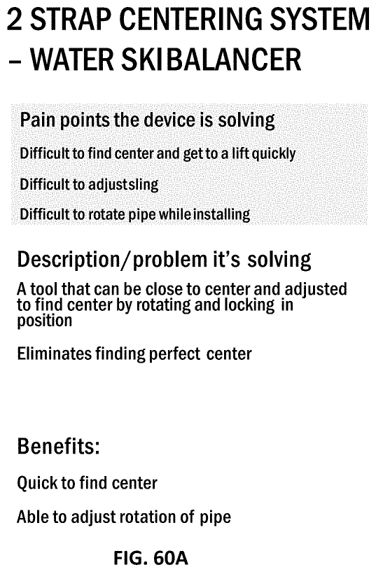

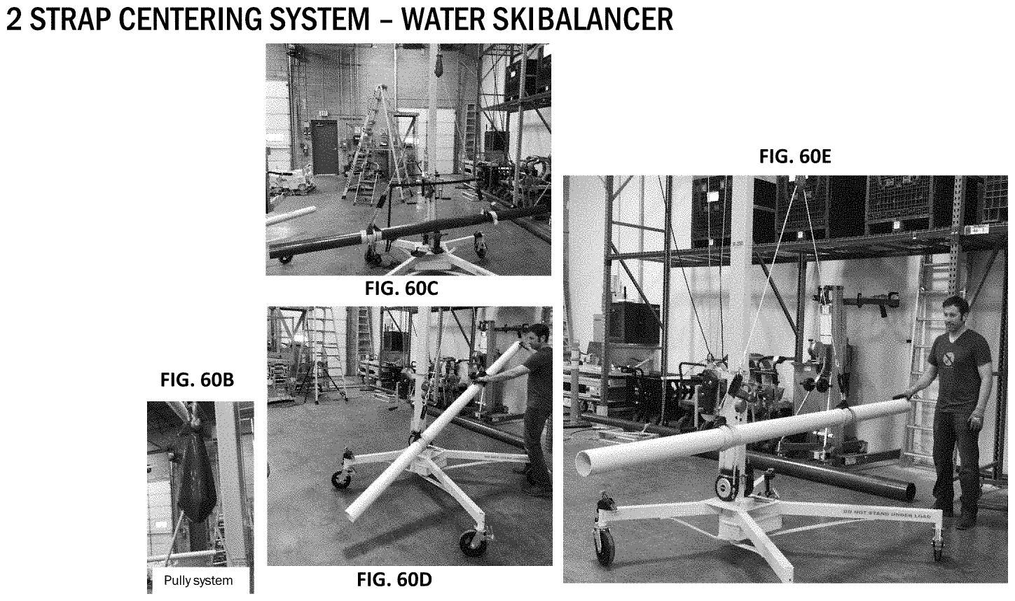

FIGS. 60A-60E illustrate a 2-strap centering system including two straps surrounding a lift material configured to be adjustable along the length of the lift material in order to find the center of the lift material to ensure a level lift. The straps can be rotated and locked into position when they find the center.

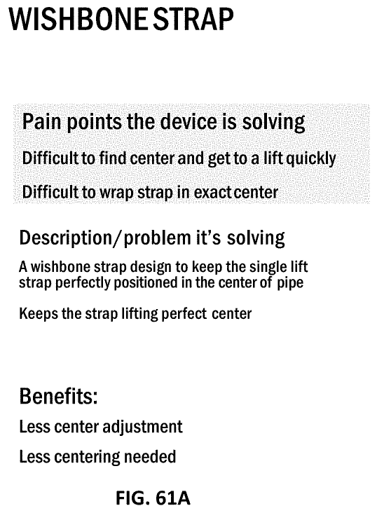

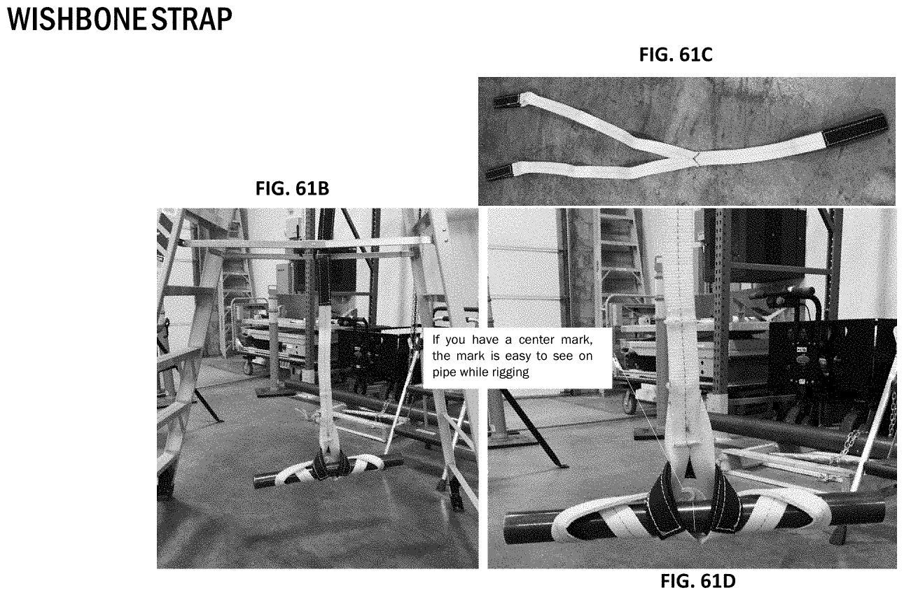

FIGS. 61A-61D illustrate a wishbone strap device including a main strap having a plurality of secondary straps extending from the main strap configured to surround the center of a lift material.

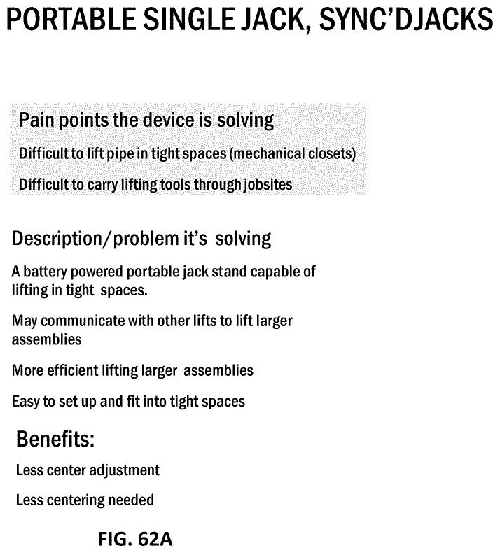

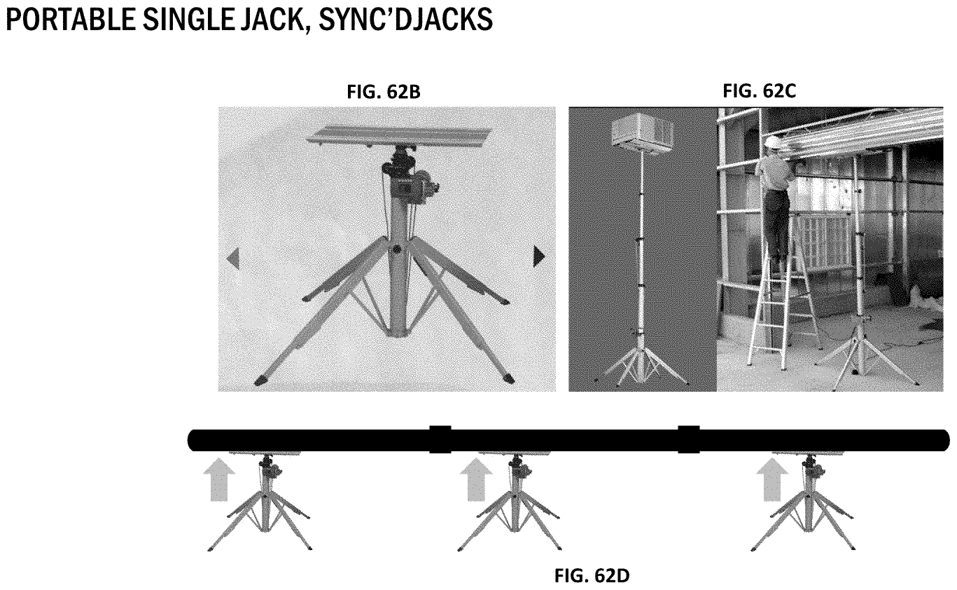

FIGS. 62A-62D illustrate a portable single, synchronized jack system including a plurality of battery powered portable jack stands all communicating together to coordinate a combined lift. The jack system is advantageous because it allows a heavy lift to be performed in tight spaces. The lifting mechanism may be a powered duct jack or multiple powered duct jacks that work in unison. For example, the lifting mechanism may be a battery powered portable jack stand capable of lifting in tight spaces. The jack stands may communicate with other lifts to lift larger assemblies. The jack(s) include a platform that can extend and retract outward and laterally to lift a pipe. In one embodiment, the platform may include a conveyor roller v-groove to assist in the movement of the pipe. In some embodiments, the support surface may further include slides that extend both outward and laterally. As a result, the user may translate the pipe on the support surface in any direction.

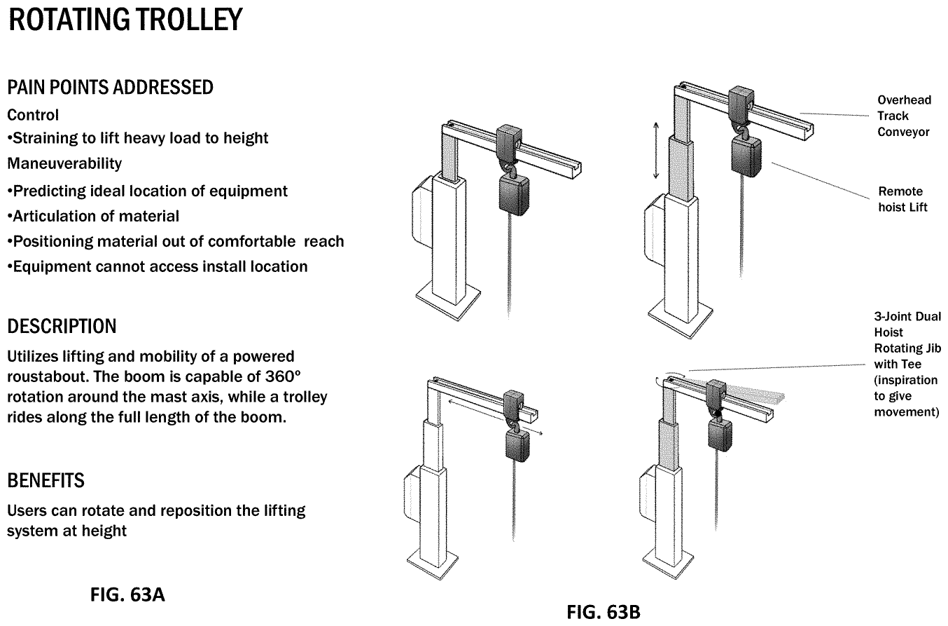

FIGS. 63A-63B illustrate a rotating trolley for use with a remote hoist system. The remote hoist system includes a boom having a trolley, an overhead conveyor, and a 3-joint dual hoist rotating jib. The trolley is capable of rotating 360 degrees around a mast axis to a desired position.

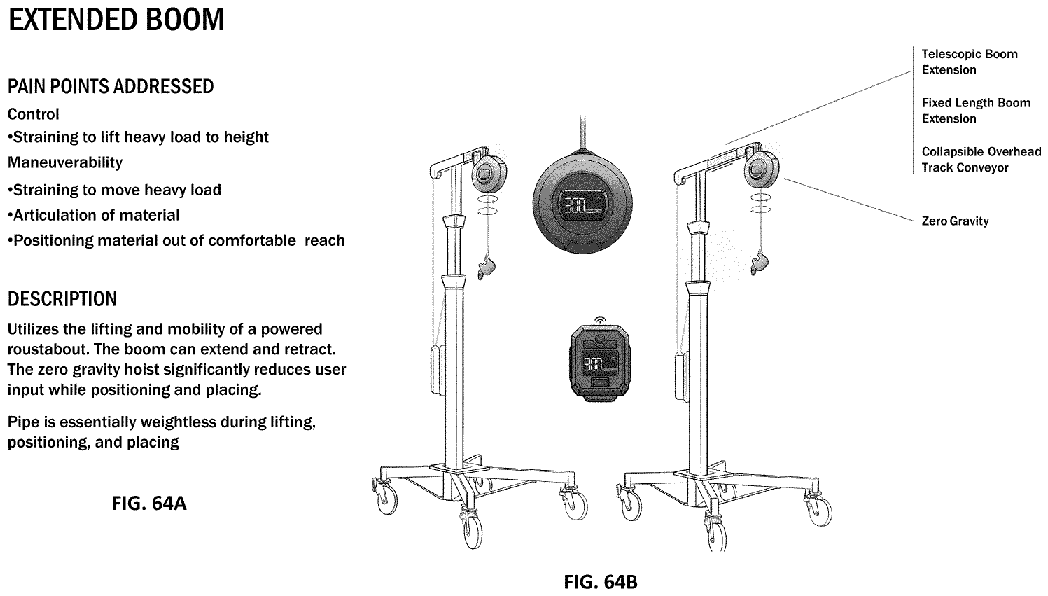

FIGS. 64A-64B illustrate an extendable boom system to be used with a powered roustabout. The boom can extend and retract while simultaneously supporting a load.

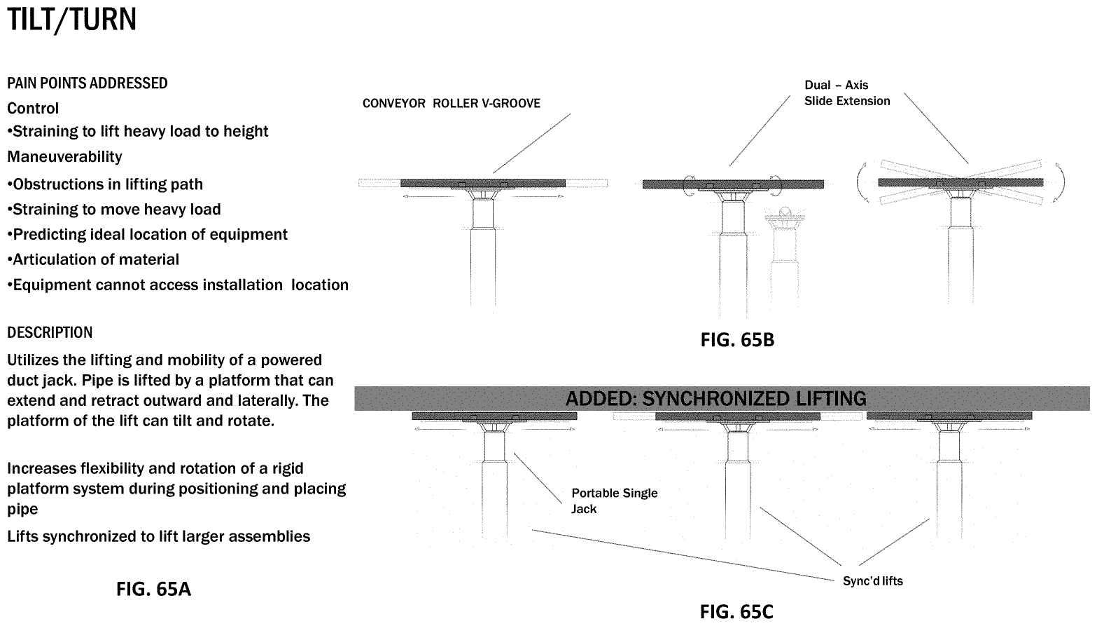

FIGS. 65A-65C illustrate a tilt/turn system utilizing a powered duct jack. The tilt/turn system can include a platform for supporting a lift material that can lift, tilt and/or rotate the lift material.

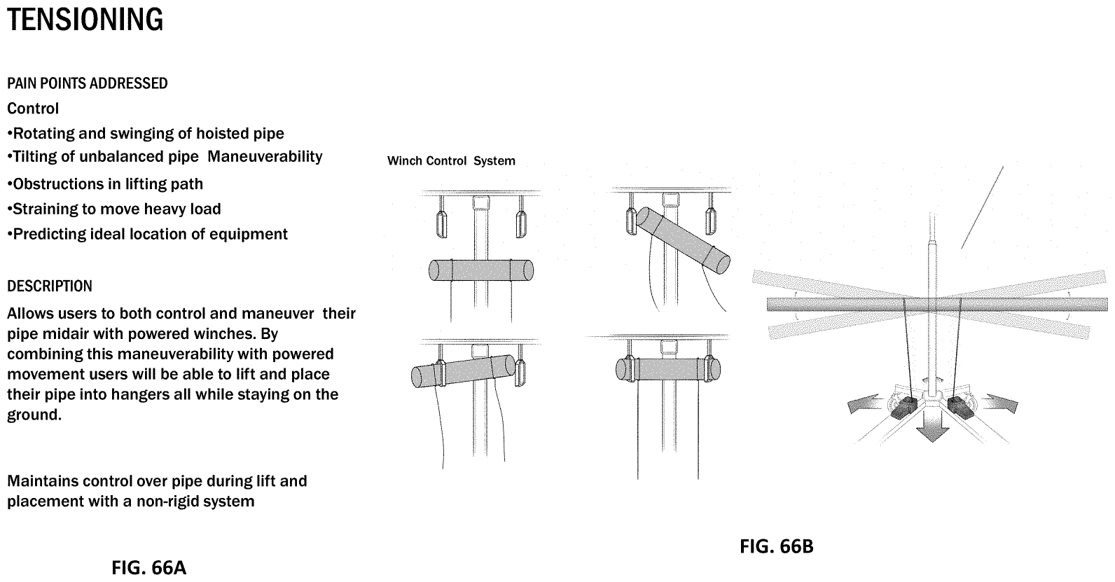

FIGS. 66A-66B illustrate a tensioning system utilizing a winch control system. The tensioning system allows the user to control and maneuver a lift material mid-air with powered winches while maintaining constant tension between the lift material and the control system. The winch control system allows users to both control and maneuver a pipe with powered winches. More specifically, the system uses counter-tension from the ground in order to control the pipe during the lift. Because the downwards tension is actively controlled (e.g., powered), the user can not only prevent unwanted movement but they can also adjust the tilt of the pipe with the push of a button.

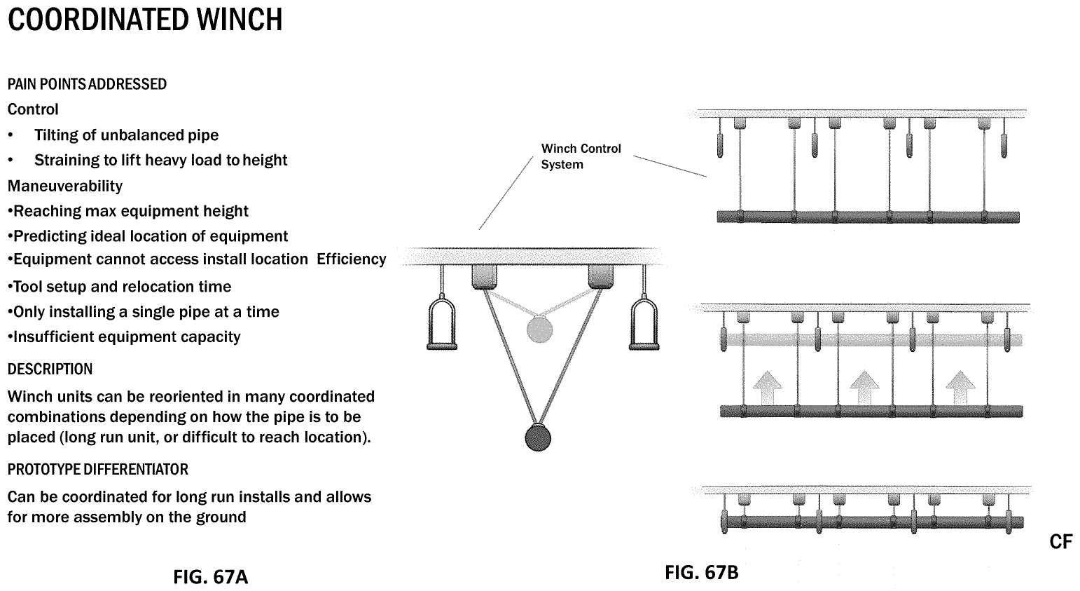

FIGS. 67A-67B illustrate a coordinated winch system utilizing a winch control system. The coordinated winch system allows multiple winch units to be oriented in various combinations depending on a lift material's placement (long run unit, or difficult to reach location).

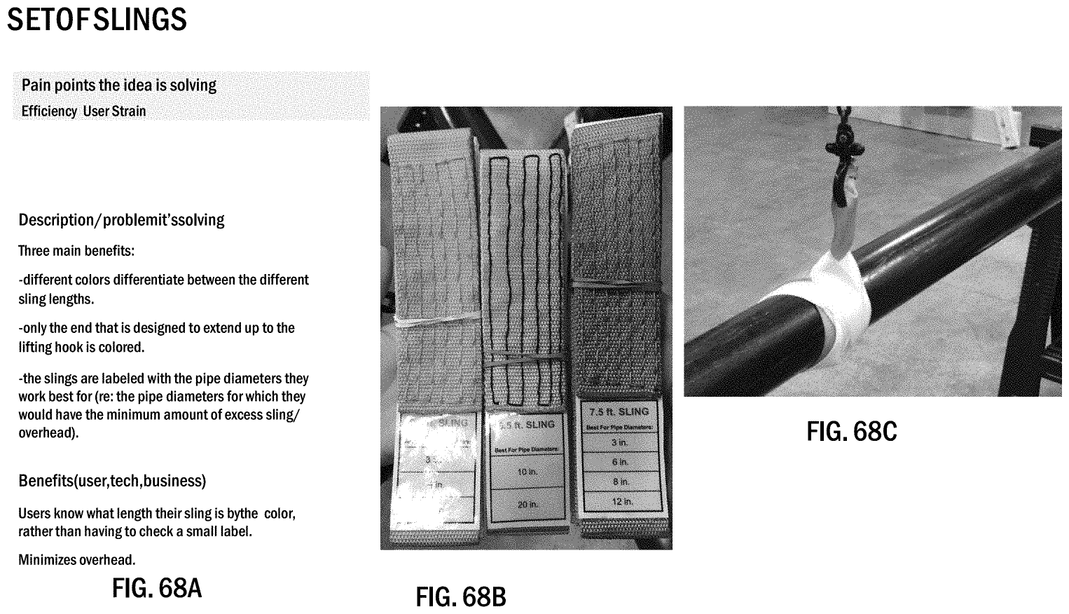

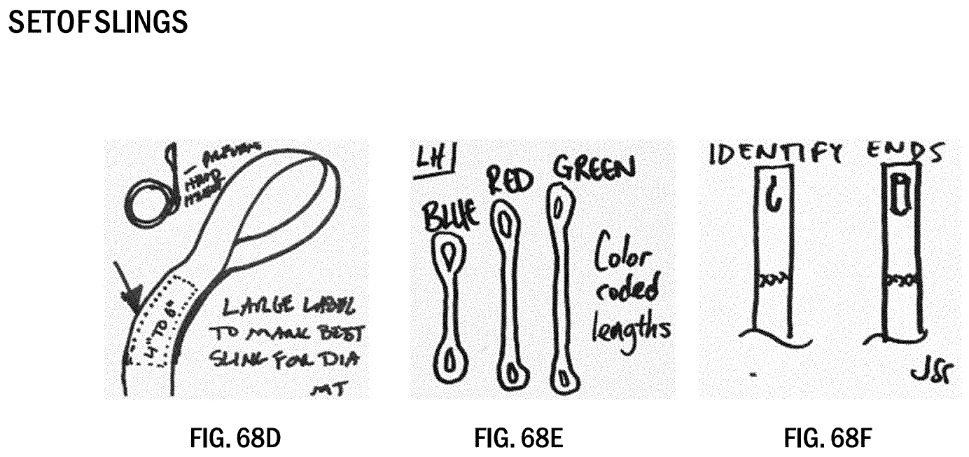

FIGS. 68A-68F illustrate a set of slings. Each sling may include a securing region that is wrapped around a desired material (e.g., a pipe) and two loop regions positioned at each end of the sling. When the sling is secured to the pipe, one loop region extends upward from the pipe and may be attached to a lifting hook to lift the pipe. The loop region that extends upward from the pipe may be various colors (e.g., red, green, blue) to indicate the respective length of each sling (e.g., each color corresponds to a length). As a result, when a user is able to determine the length each sling by the color of the sling, rather than having to check a small label. Additionally, the slings may include a label that denotes the pipe diameters with which each sling works best. For example, the label on each sling indicates with which pipe diameters each sling should be used to minimize the amount of excess sling/overhead during operation

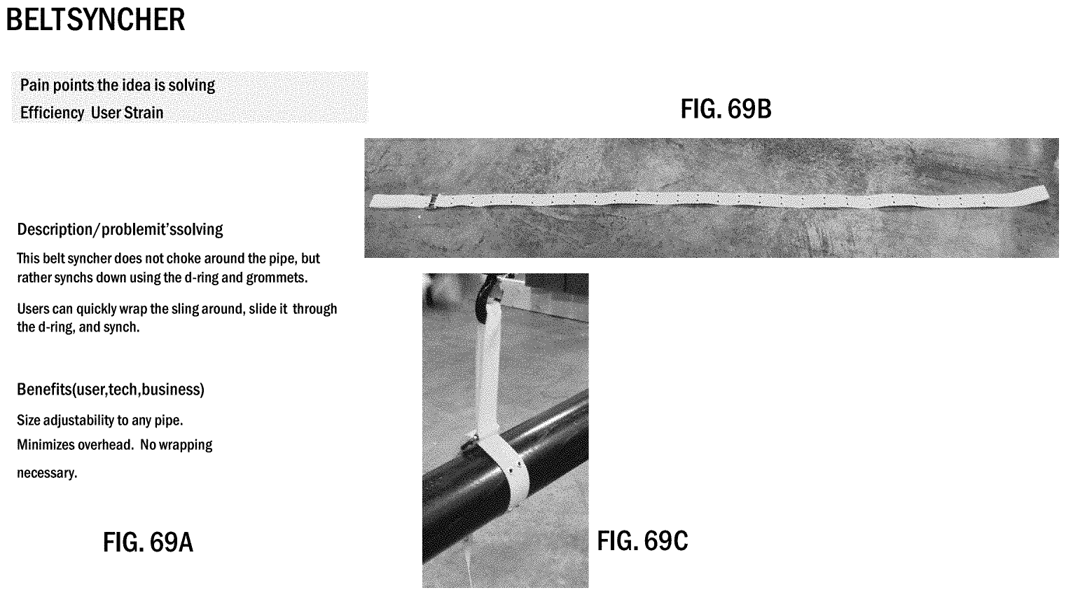

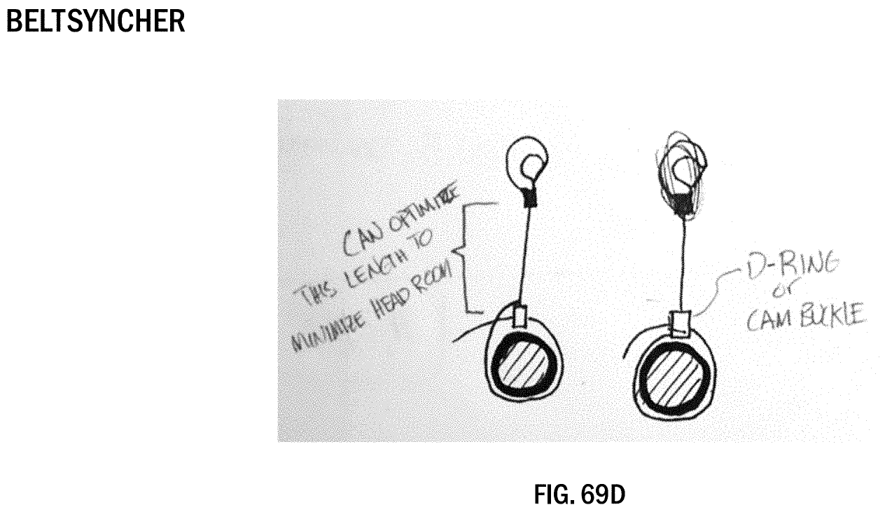

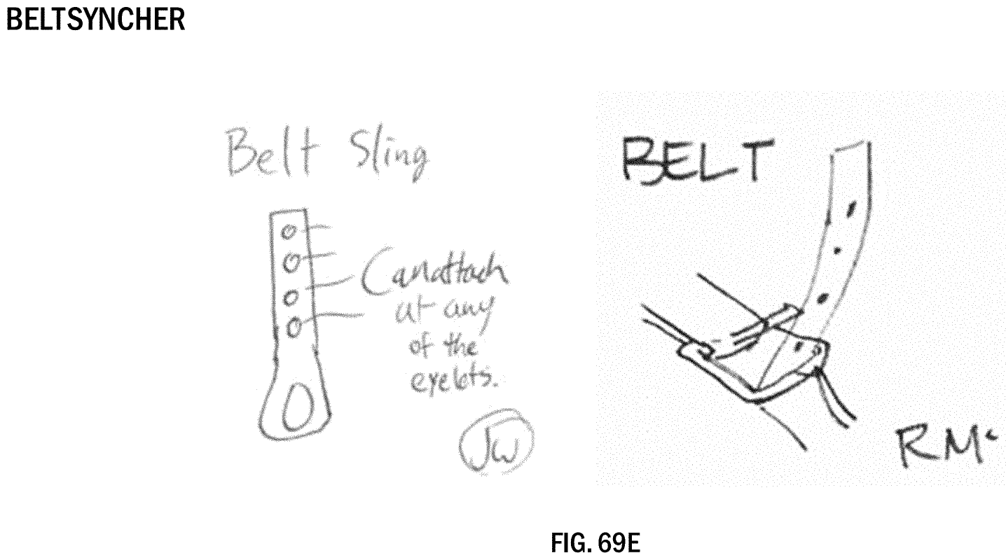

FIGS. 69A-69E illustrate a belt syncher including a sling having two loop regions positioned at each end of the sling, a D-ring or cam buckle, and a plurality of grommets positioned at different locations on the sling. The belt syncher does not choke around the pipe, but rather synchs down using the D-ring and grommets. As a result, the user can quickly wrap the sling around any size pipe, slide the sling through the D-ring, and synch the pipe using the D-ring and grommets. This allows the user to minimize the overhead of the sling during lifting.

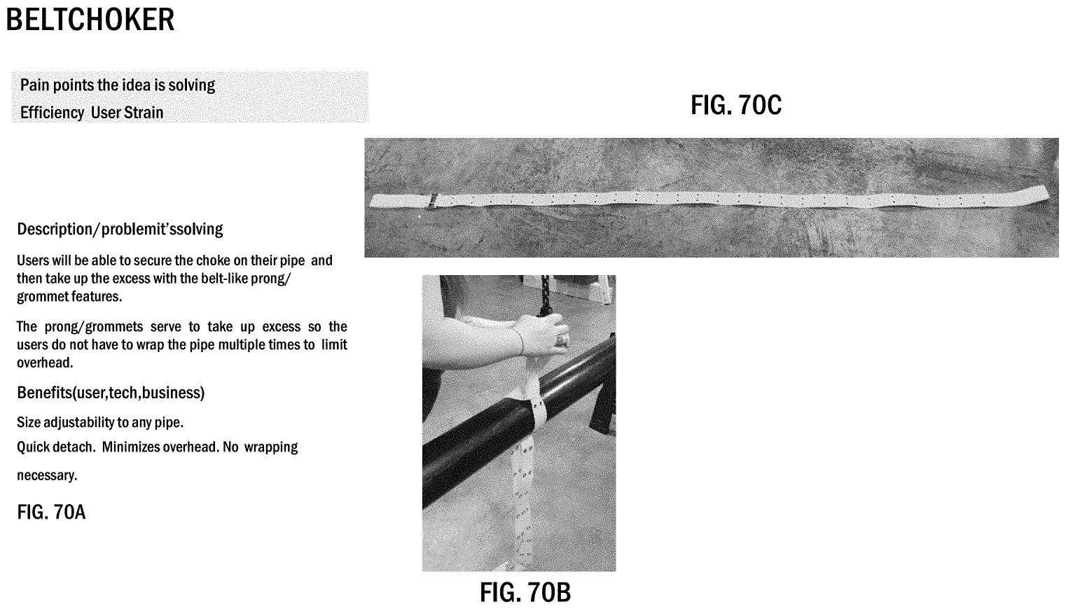

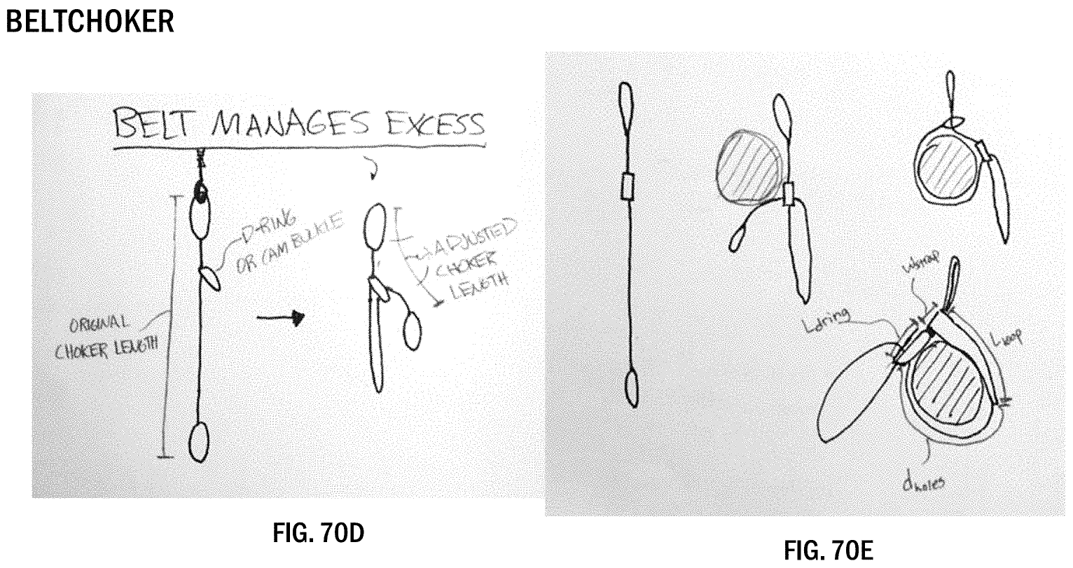

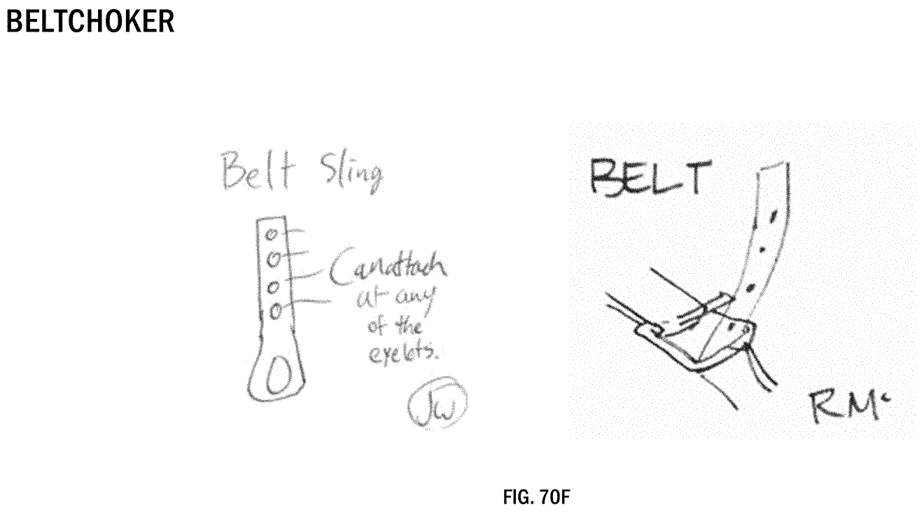

FIGS. 70A-70F illustrate a belt choker including a sling having two loop regions positioned at each end of the sling, a D-ring or cam buckle, and a plurality of grommets positioned at different locations on the sling. The user may insert one end of sling through the D-ring or cam buckle and adjust the length of the choker to conform with the diameter of the pipe being lifted. The grommets allow the user to take up an excess portion of the sling to limit the overhead of the sling. As a result, the user can quickly secure the sling to any size pipe without having to wrap the sling around the pipe to limit the overhead of the sling.

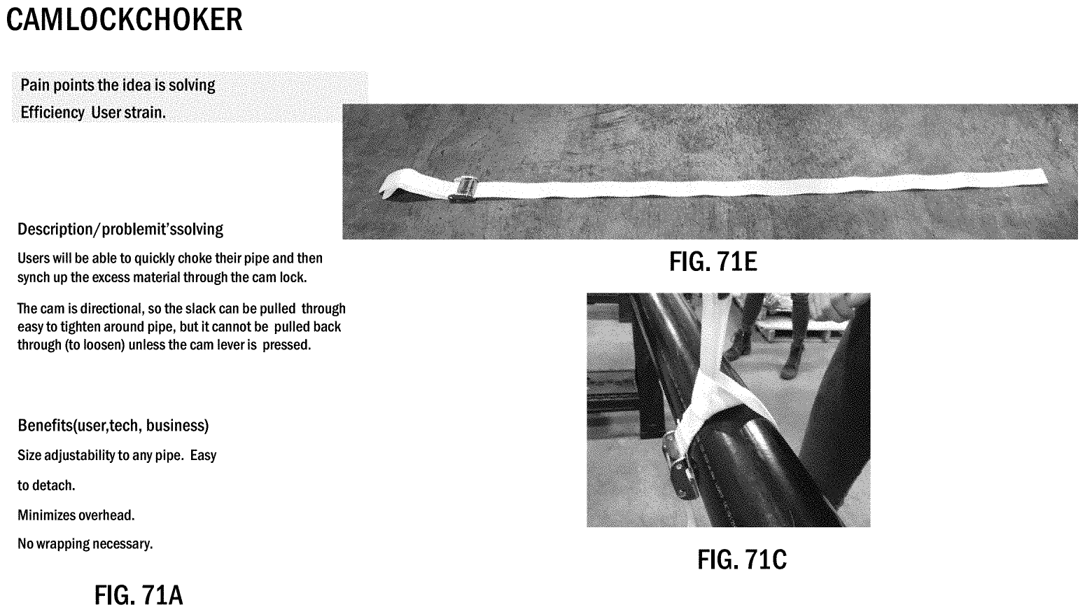

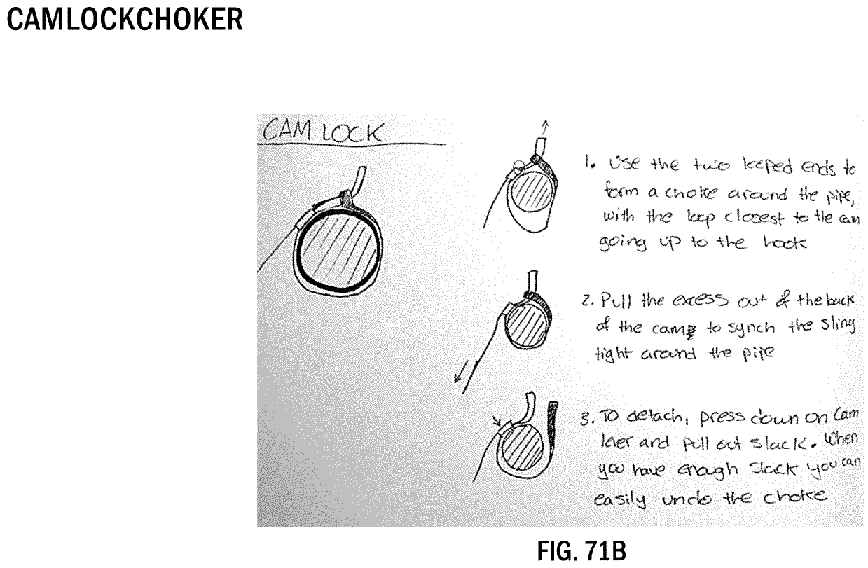

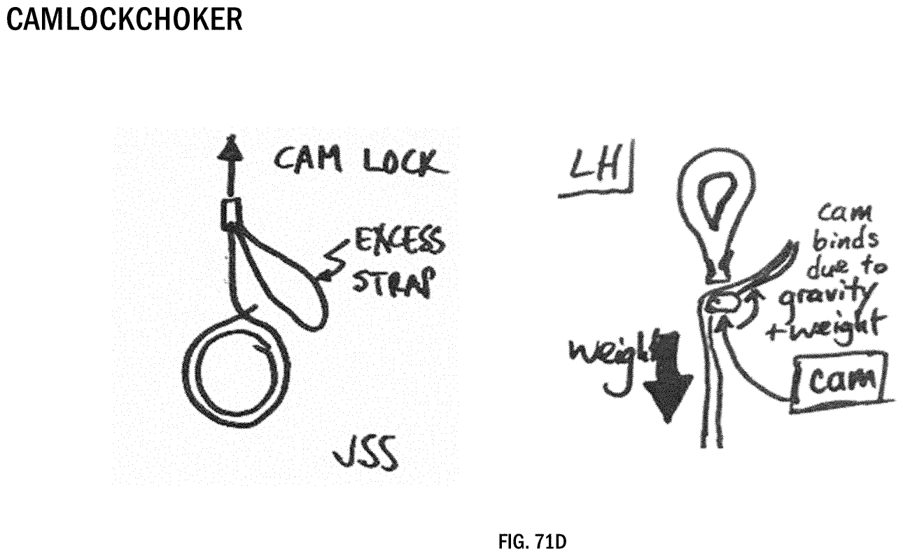

FIGS. 71A-71E illustrate a cam lock choker device including a sling having two loop regions positioned at each end of the sling and a cam lock attached to the sling. In the illustrated embodiment, the cam lock is directional, so the slack of the sling can be pulled through the cam lock easily to tighten the sling around pipe. However, the sling cannot be pulled back through (e.g., to loosen) the cam lock unless a cam lever is pressed. As a result, the user is able to quickly choke any size pipe and then synch up the excess material of the sling through the cam lock.

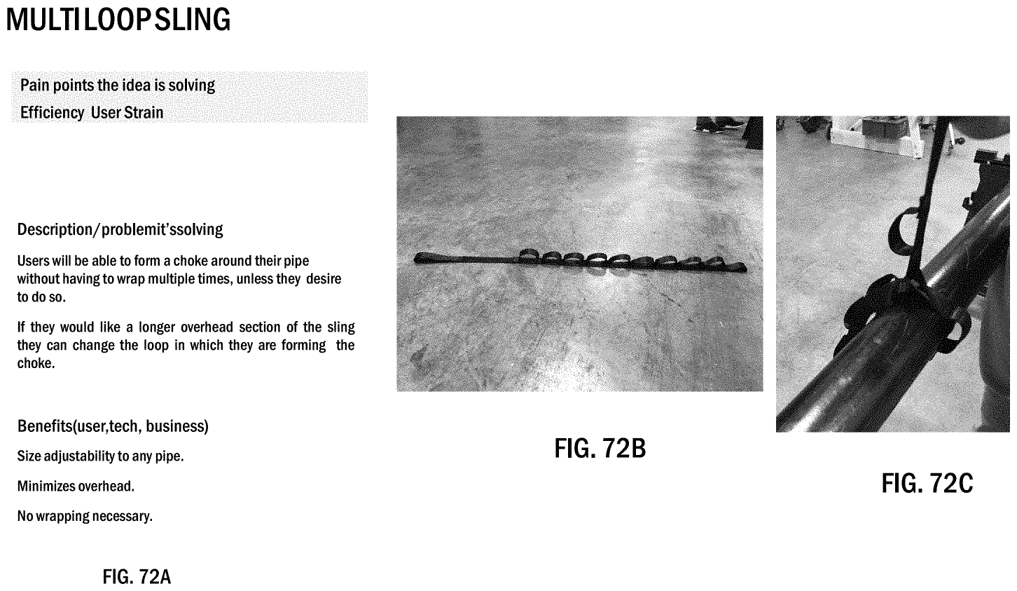

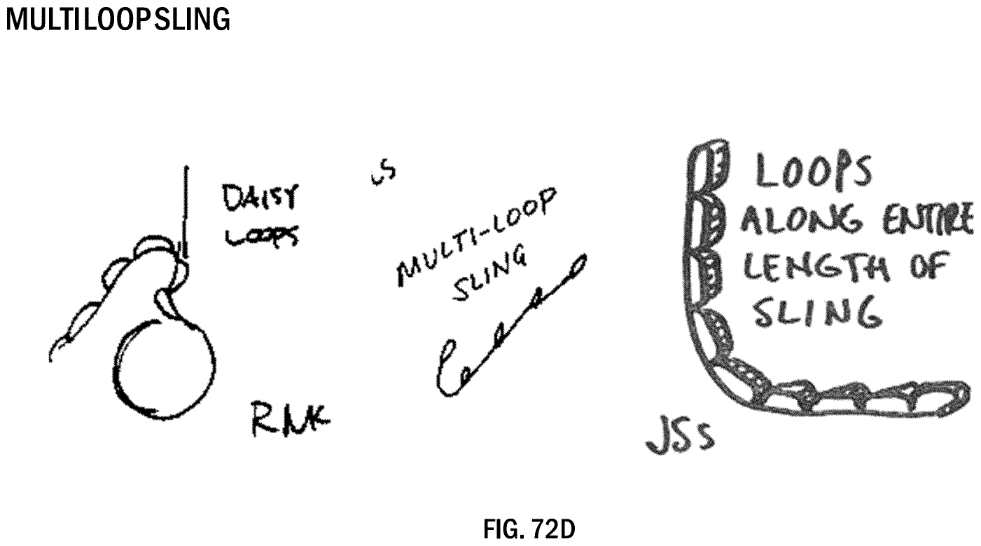

FIGS. 72A-72D illustrate a multi-loop sling including a sling having two loop regions positioned at each end of the sling and a plurality of loops formed along the length of the sling. One end of the sling may be inserted through one of the plurality of loops to choke a pipe being lifted. As a result, the user is able to form a choke around any size pipe without having to wrap the sling around the pipe multiple times. Additionally, the user may adjust the overhead section of the sling by changing the loop through which the one of end of the sling is inserted.

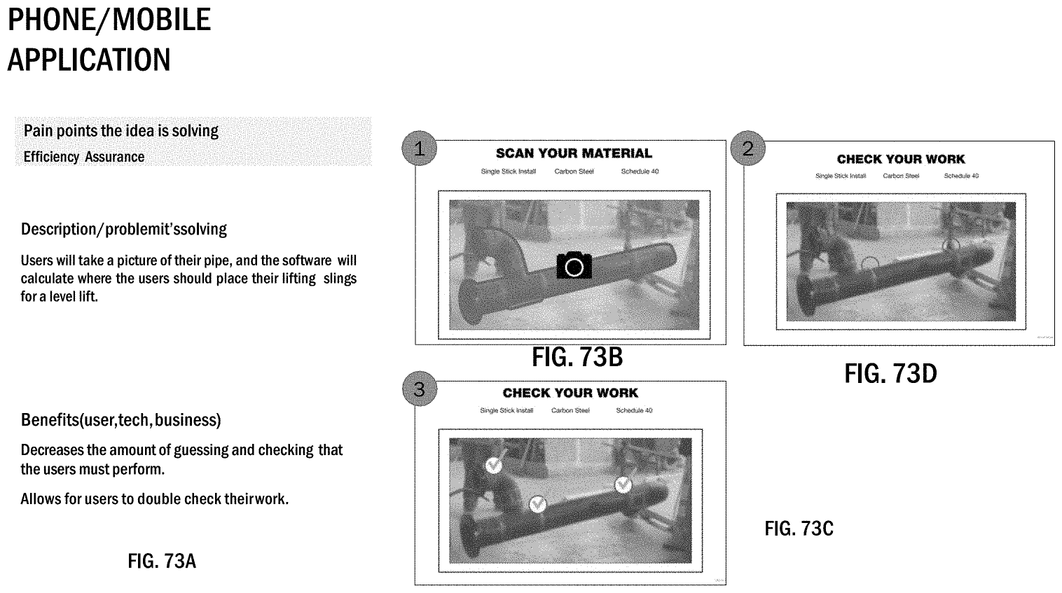

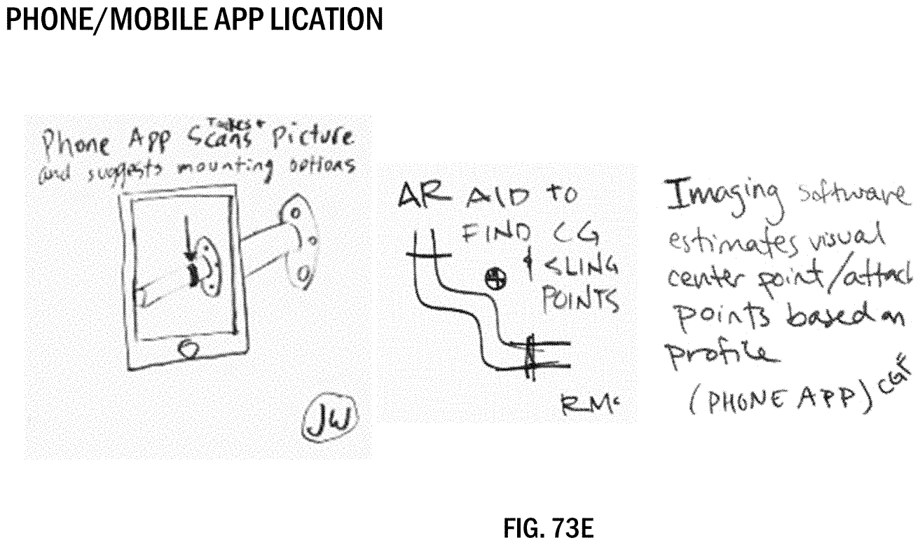

FIGS. 73A-73E illustrate a mobile application utilizing a mobile device to determine optimal lifting location(s) on a material/load being lifted. The mobile application may be used with a mobile device to determine the optimal lifting location(s) on a pipe being lifted. In the illustrated embodiment, the user may take a picture of the pipe on a mobile device and the mobile application calculates attachment position(s) on the pipe that the users should place a lifting sling(s) to perform a level lift. For example, mobile application may estimate the visual center point of the pipe and attachment position(s) of the lifting sling(s) based on the profile of the pipe. As a result, the mobile application decreases the amount of time required to perform a level lift and allows the user to double check the attachment position(s) of the lifting sling(s).

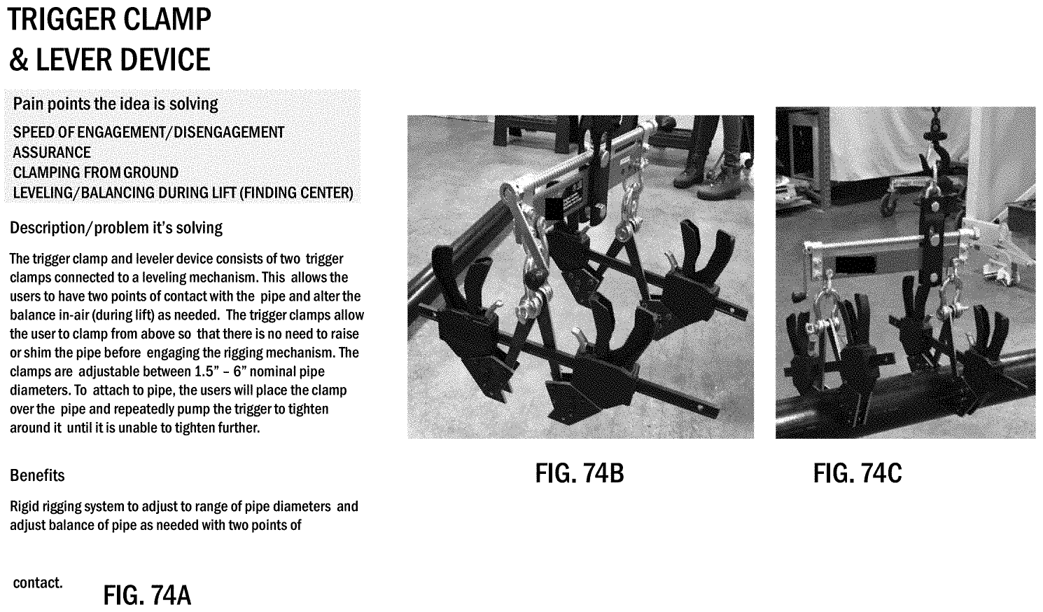

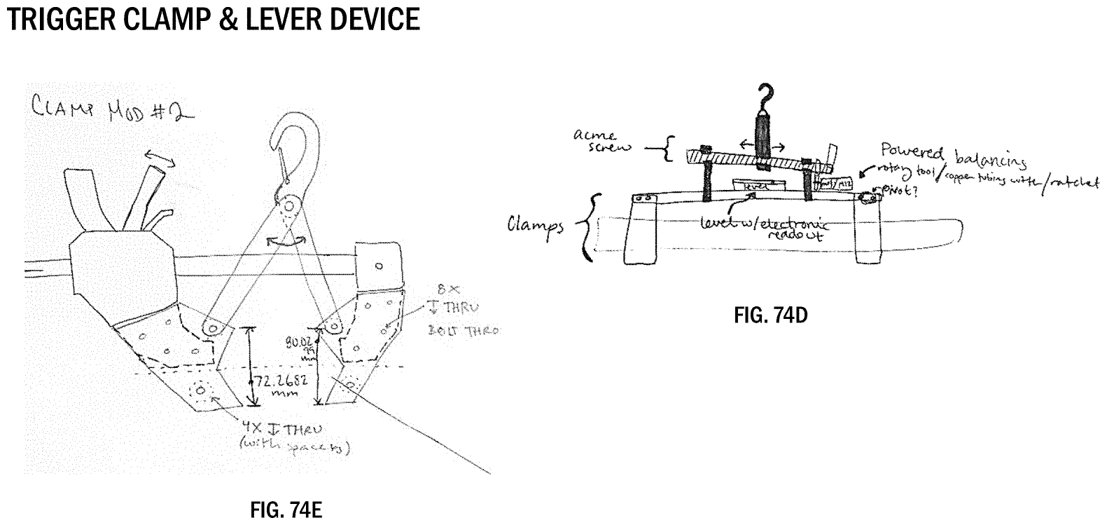

FIGS. 74A-74E illustrate a trigger clamp and leveler device including a plurality of trigger clamps connected to a leveling mechanism. The trigger clamp and leveler device may include two trigger clamps connected to a leveling mechanism. As a result, the device includes two points of contact with a pipe when the user lifts the pipe and allows the user to alter the balance of the pipe in-air (e.g., during lift) as needed. The trigger clamps allow the user to clamp the pipe from above so the pipe does not need to be raised or shimmed before the device engages with the pipe to perform a lift. In the illustrated embodiment, the clamps are adjustable to allow pipes with nominal pipe diameters between 1.5 inches to 6 inches to be lifted. To attach a pipe to the device, the user may place the two trigger clamps over the pipe and repeatedly pump a trigger of the clamps to tighten the clamp around the pipe. In some embodiments the leveler may include an acme screw coupled to a handle to allow the user to adjust the height of one end of the pipe (e.g., raise or lower) to level the pipe in-air. In other embodiments, a power tool and a level with an electric readout may be coupled to the leveler to allow the leveler to automatically level the pipe in-air.

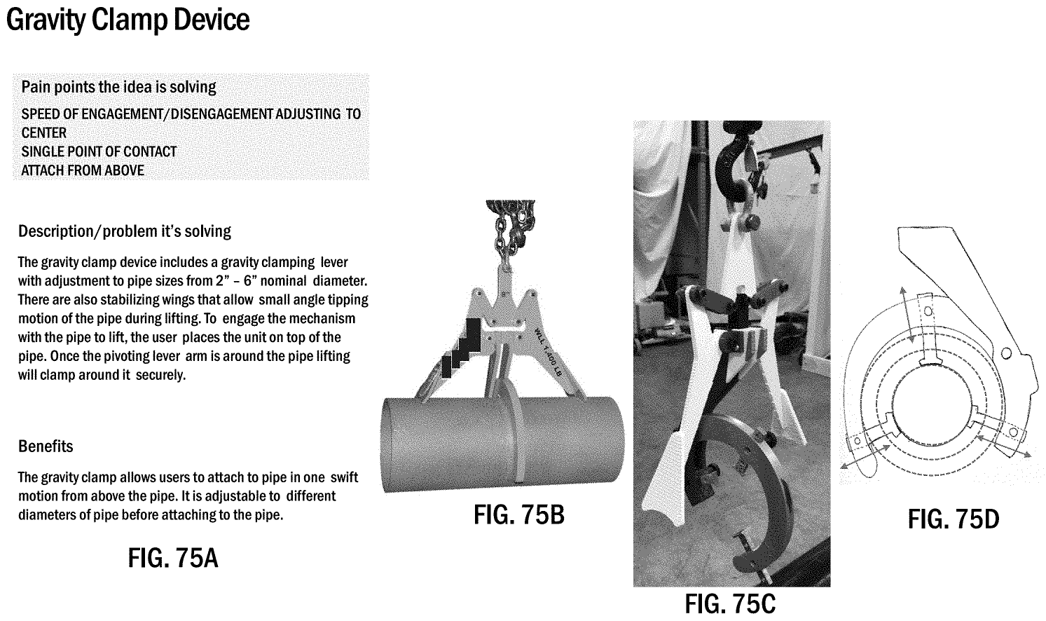

FIGS. 75A-75D illustrate a gravity clamp device including a pivoting lever arm that may be adjusted to lift a lift material (e.g., a pipe) with a nominal diameter between 2 and 6 inches. The gravity clamp device may include a pivoting lever arm that may be adjusted to lift pipes with a nominal diameter between 2 and 6 inches. The device further includes stabilizing wings that allow a small angle tipping motion of the pipe during lifting. The pivoting lever arm is adjustable to different diameters of pipe before attaching to the pipe. During operation of the device, the user may place the unit on top of the pipe and the pivoting lever arm will clamp around the pipe to securely lift the pipe in one swift motion.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

What is claimed is:

1. A lifting and securing device configured to support material and aid in moving the material to a desired height and location.
